(19) United States
(12) Patent Application Publication
(10) Pub. No.: US 2004/0049743 A1
(43) Pub. Date: Mar. 11, 2004

(54) Universal digital mobile device

(76) Inventor: Glenn Rolus Bogward, Munich (DE)

Correspondence Address: BAKER & DANIELS, 205 W. JEFFERSON BOULEVARD, SUITE 250, SOUTH BEND, IN, 46601, US

(21) Appl. No.: 10/240,503

(22) PCT Filed: Apr. 2, 2001
(86) PCT No.: PCT/EP01/03738

(30) Foreign Application Priority Data
Mar. 31, 2000 (DE) 100 16 117.0

(51) Int. Cl. G06F 17/00

(52) U.S. Cl. 715/531

(57) ABSTRACT

A universal digital mobile device for executing programs, comprising a display device for displaying text data and/or image data, and an input device with a pressure-sensitive or proximity-sensitive input area, is disclosed, the pressure-sensitive or proximity-sensitive input area having one functional zone or a plurality of functional zones depending on the execution of at least one program.

Computer technology is entering more and more areas of life, in particular in the form of Internet technology. Whereas in earlier times the use of data processing devices was customary and widespread only for specific activities, for example for text processing, for carrying out technical/scientific design and calculation activities or for commercial accounting activities, the use of data processing devices is becoming increasingly ubiquitous in everyday life: in particular since the start of the phenomenal growth phase of the Internet from approximately 1995 onwards, interaction via the Internet using suitable data processing devices is being applied to more and more areas of life, particularly in business (“e-commerce”) and the field of public administration (“e-government”). It is increasingly customary today to perform, for example, the ordering of goods and/or services or transactions in the field of public administration, for example the submission of tax declarations, online via the Internet. At present, operations of this type are usually carried out using fixed data processing devices of the “personal computer” type. Where mobility is a factor, portable devices, for example what are referred to as “notebook” computers or “palmtop” computers, are used.

On the other hand, mobile telephone services have become significantly more important, not least due to falling tariffs. Mobile telephones (“mobiles”) are highly specialized data processing devices which, by means of a permanently predefined firmware, are exclusively aimed at permitting the user to perform mobile telephone services in as uncomplicated a way as possible. Recently, there has also been increased use of concepts in which mobile telephones are provided with functionalities which go beyond pure telephone services: firstly the “Short Message Service” (SMS) permits short messages of, for example, up to 160 characters to be exchanged using mobile telephones. On the other hand what are referred to as WAP mobile telephones, which are set up for the “cableless application protocol” permit the Internet, or Internet-like services, to be used, even if in a functionally restricted way.

“Palmtop” computers are digital mobile devices which correspond in size approximately to a mobile telephone but are not designed for making telephone calls but rather, for example, for storing and displaying personal diary data, telephone lists, etc. There is frequently no provision of an input keyboard on these devices but instead, for example, an input pen device is used for inputting small amounts of text in the form of handwriting. For this reason, palmtop computers are rather unsuitable for processing operations in which relatively large amounts of information have to be displayed simultaneously on a display or input into the device, for example the reception and dispatch of e-mail messages.

A further category of mobile digital devices which have recently appeared are what are referred to as “electronic books”. Such an “electronic book” is known for example from PCT/EP98/06008. This type of device typically has at least one display device with a relatively large surface area, by means of which relatively large quantities of text can also be conveniently read.

However, the current situation appears unsatisfactory overall: the complete functionality of Internet services can at present only be exploited with fixed PCs and with high-power notebooks. These devices are generally provided with very universal operating systems, for example, Linux MAC-OS or WINDOWS which, however, technically unskilled users regularly overload. On the other hand, customary mobile telephones are characterized by a highly function-oriented operator interface which is freed of unnecessary complexity; however, they lack the necessary universality. In particular, even in the case of WAP-capable mobile telephones, the screens are much too small for relatively complex tasks, for example, to be able to carry out text processing.

For this reason, there is an increased need to provide a digital mobile device which, on the one hand, is also suitable for technically unskilled users, thanks to a reduction in complexity in comparison with a conventional PC, but whose usefulness is not restricted by the drastic functional restrictions of mobile telephones, palmtops or digital books.

The object of the invention is therefore to provide a universal digital mobile device which can be embodied, for example, in the size of a typical book and is suitable for performing a wide variety of tasks in order thus to combine in itself the functionality of a multiplicity of devices such as a mobile telephone, digital book, palm pilot, notebook and/or Internet notepad, and thus avoid the need to carry around a multiplicity of devices, and be able to carry out respective functions in as ergonomic and user-friendly a way as possible.

An object of the invention is also that the abundant application possibilities obtained by combining a multiplicity of device functions should be simplified by means of a technical operator control facility in such a way that the user, as a non-expert, can operate the device easily and in a clearly organized fashion.

This object is achieved according to the invention by means of a universal digital mobile device such as can be found in the independent claims. Advantageous developments can be found in each of the subclaims.

The subject-matters of the independent patent claims each have independent inventive contents.

The invention is explained in more detail below with reference to exemplary embodiments which are introduced purely by way of example:

FIG. 1 shows a schematic perspective view of a digital mobile device according to the invention in three different use situations: FIG. 1A shows the inputting of a pointer position by moving the tip of a finger on a touch-sensitive surface in the manner of a “slide pad”. FIG. 1B shows the inputting of characters by means of a keyboard. FIG. 1C shows inputting of written characters by means of a pressure pen on a pressure-sensitive surface.

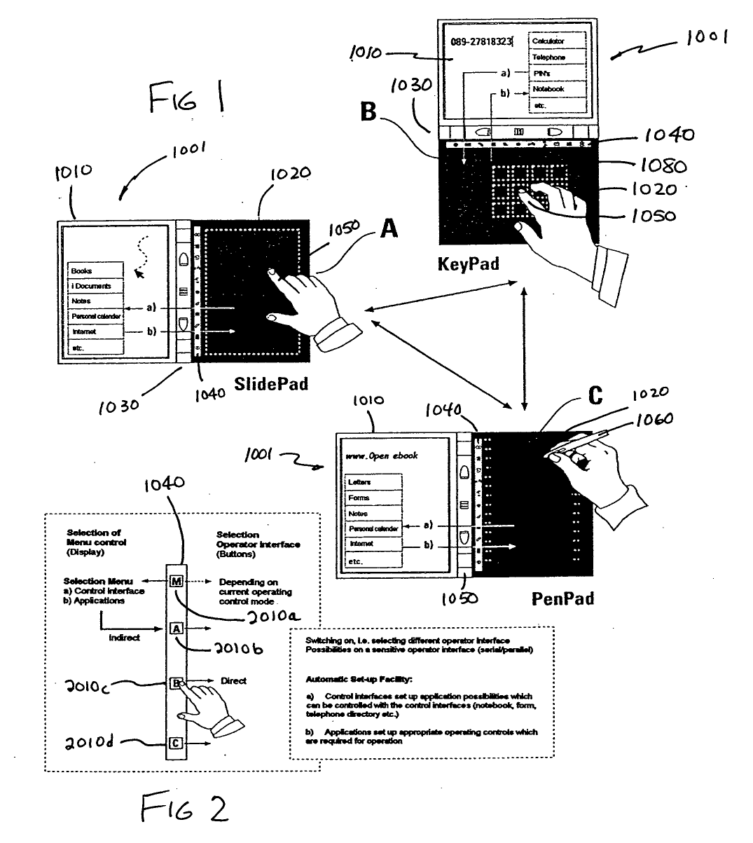

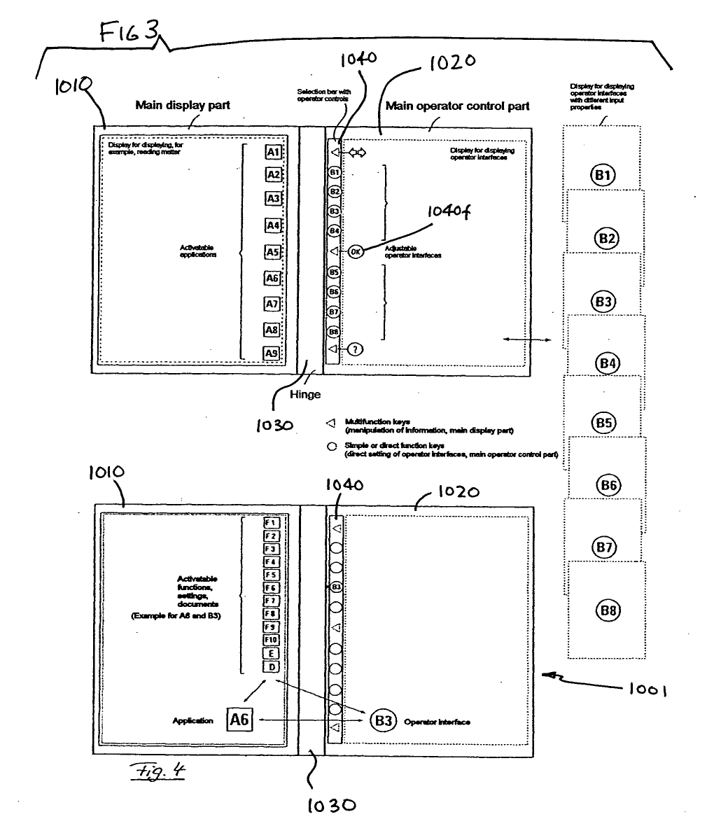

FIG. 2 shows an interface selection bar, provided in the digital mobile device according to the invention from FIG. 1, with operator controls.

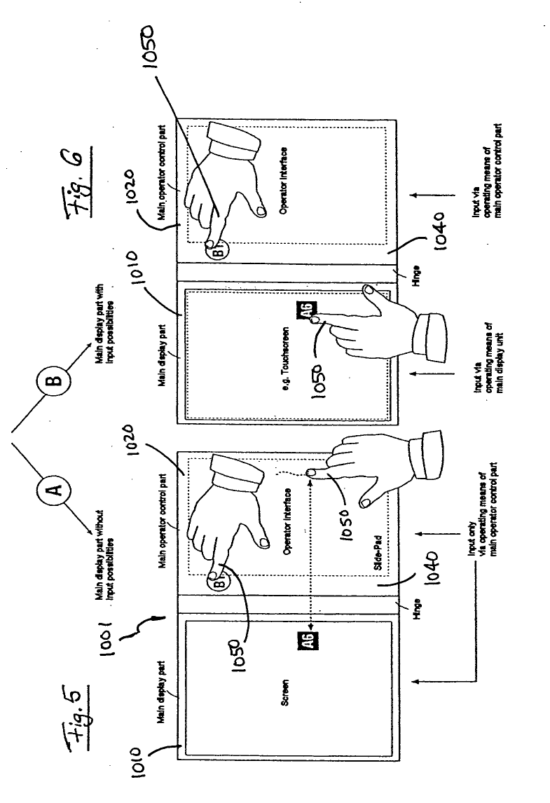

FIG. 3 shows a plan view of a digital mobile device according to the invention from FIG. 1 in the folded-open state.

FIG. 4 shows a plan view of a digital mobile device according to the invention from FIG. 1 in the folded-open state.

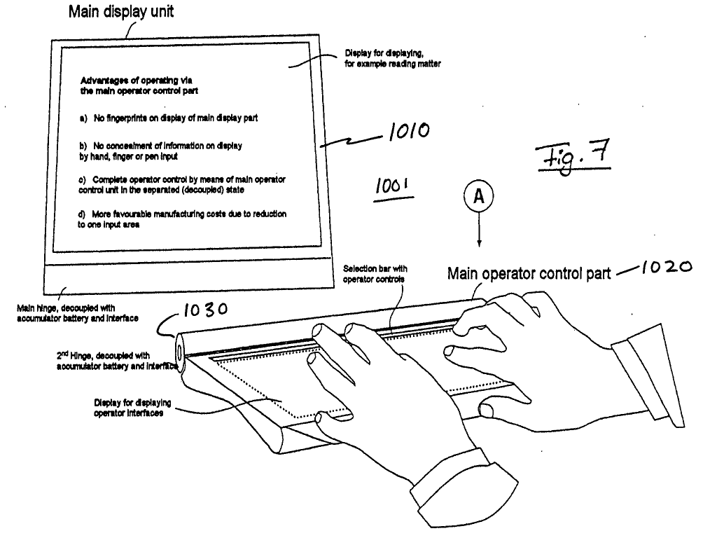

FIG. 5 shows a first variant of the digital mobile device according to the invention, shown in FIG. 1, in the folded-open state, specifically a digital mobile device according to the invention with a main display part without input possibility and a main operator control part.

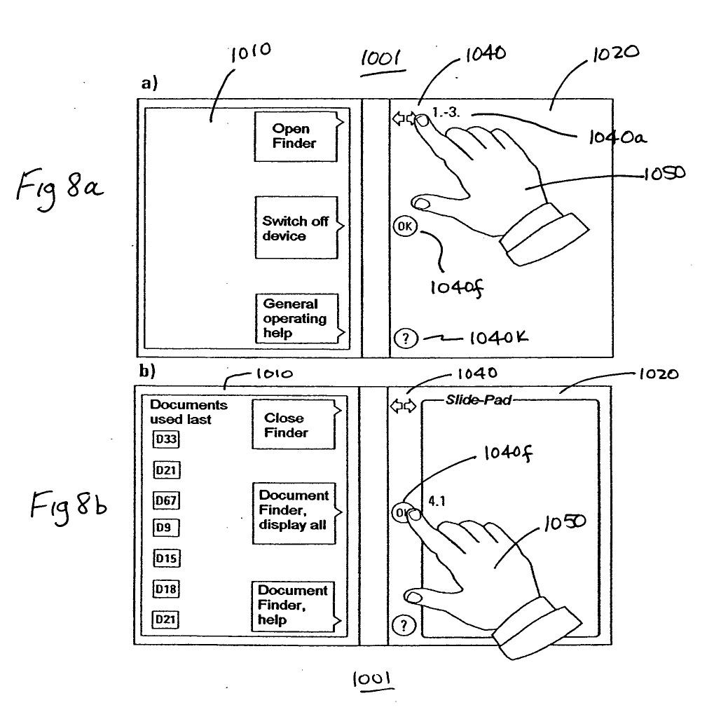

FIG. 6 shows a second variant of the digital mobile device according to the invention, shown in FIG. 1, in the folded-open state, specifically a digital mobile device according to the invention with a main display part with an input possibility provided, for example, by a touch-sensitive screen (“touchscreen”), and a main operator control part.

FIG. 7 shows a digital mobile device according to the invention in accordance with FIG. 5 or FIG. 6, in which the main display part and the main operator control part are separate.

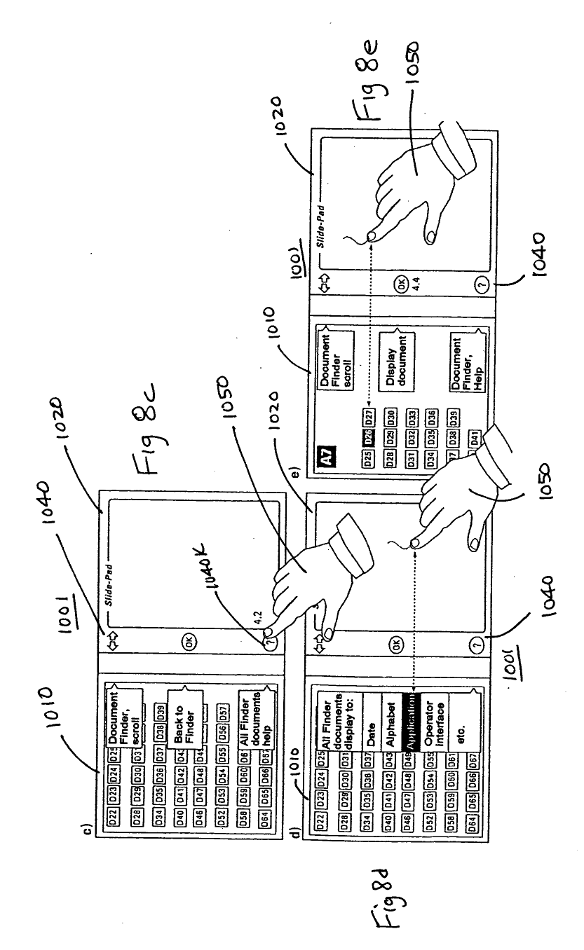

FIG. 8 shows, in the partial FIGS. 8A to 8E, a functional example of the use of operator controls contained in the menu bar according to FIG. 3, as multifunction keys in the basic mode.

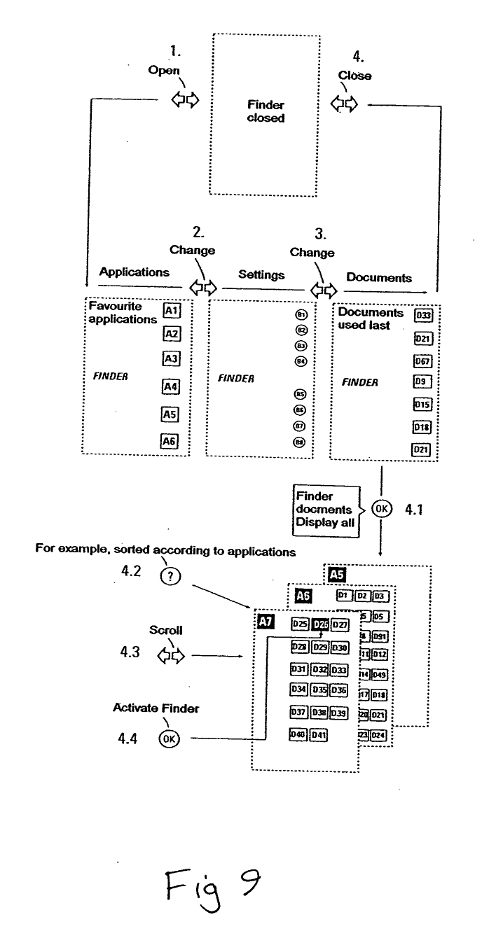

FIG. 9 shows a schematic view of the functional arrangement of the multifunction key in the basic mode.

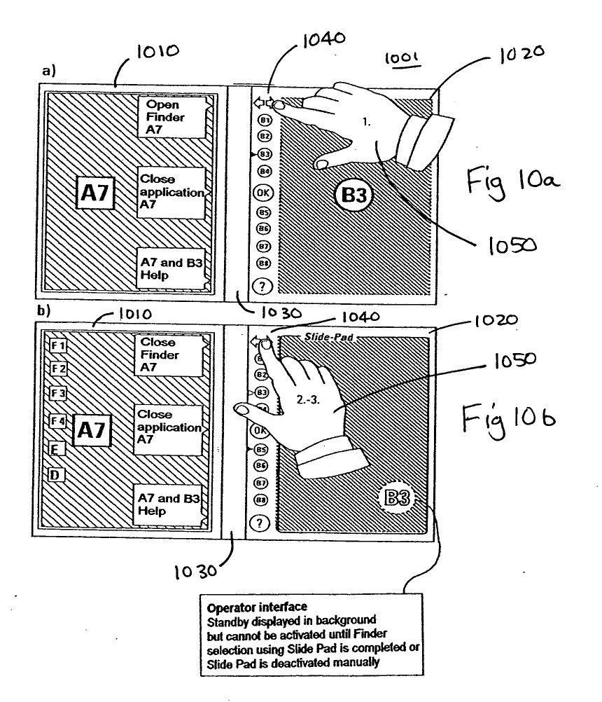

FIG. 10 shows a functional example of operator controls contained in the interface selection bar shown in FIG. 3, as multifunction keys and setting keys in the setting mode.

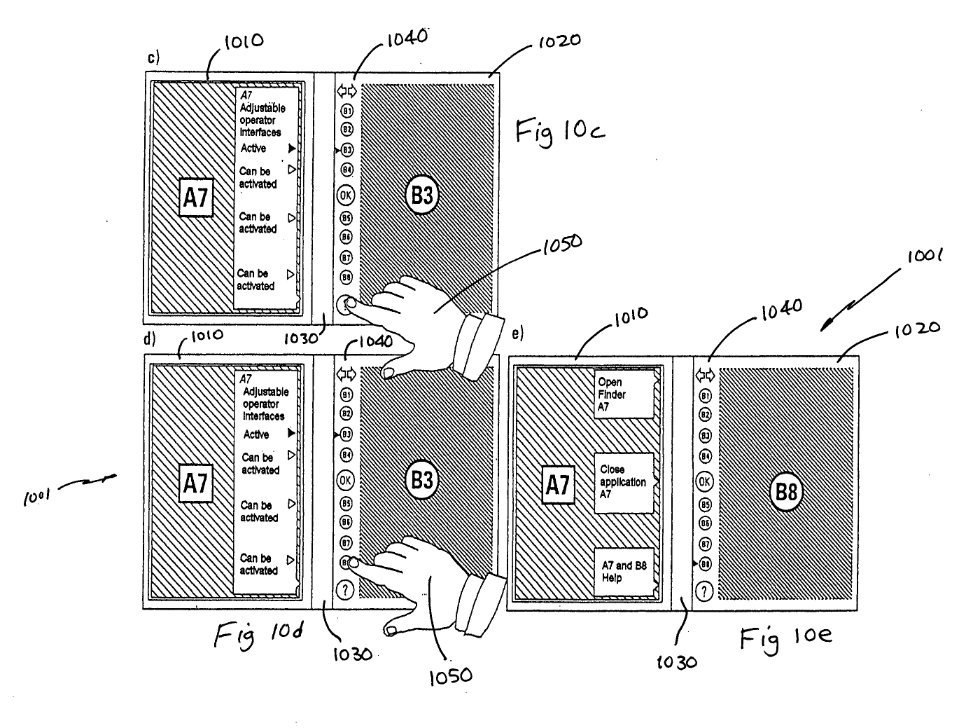

FIG. 11 shows a schematic view of the functional arrangement of the multifunction keys in the application mode.

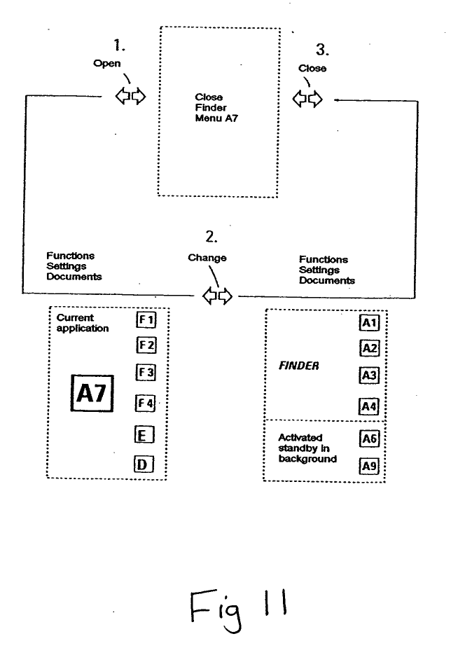

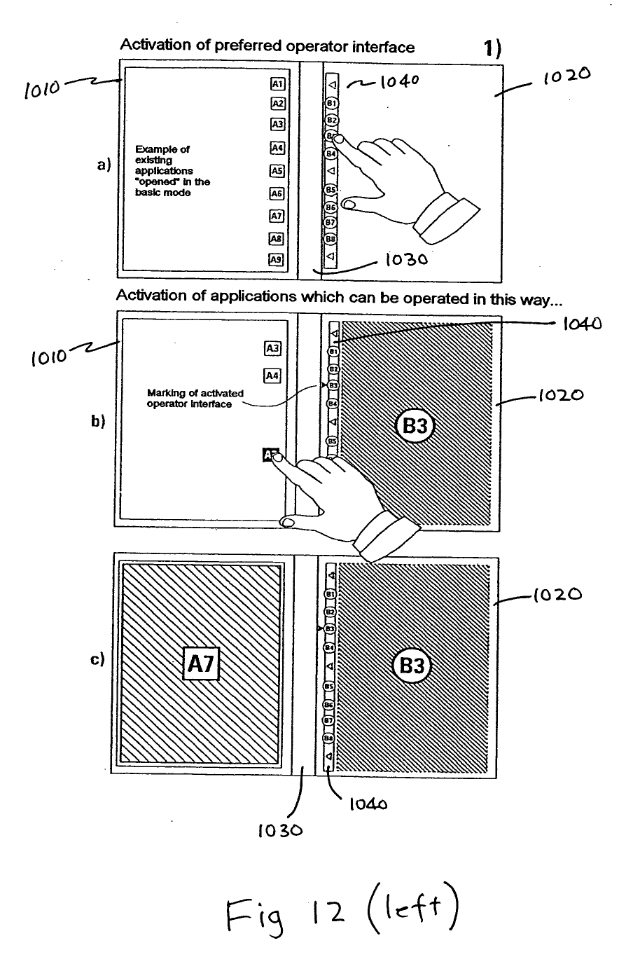

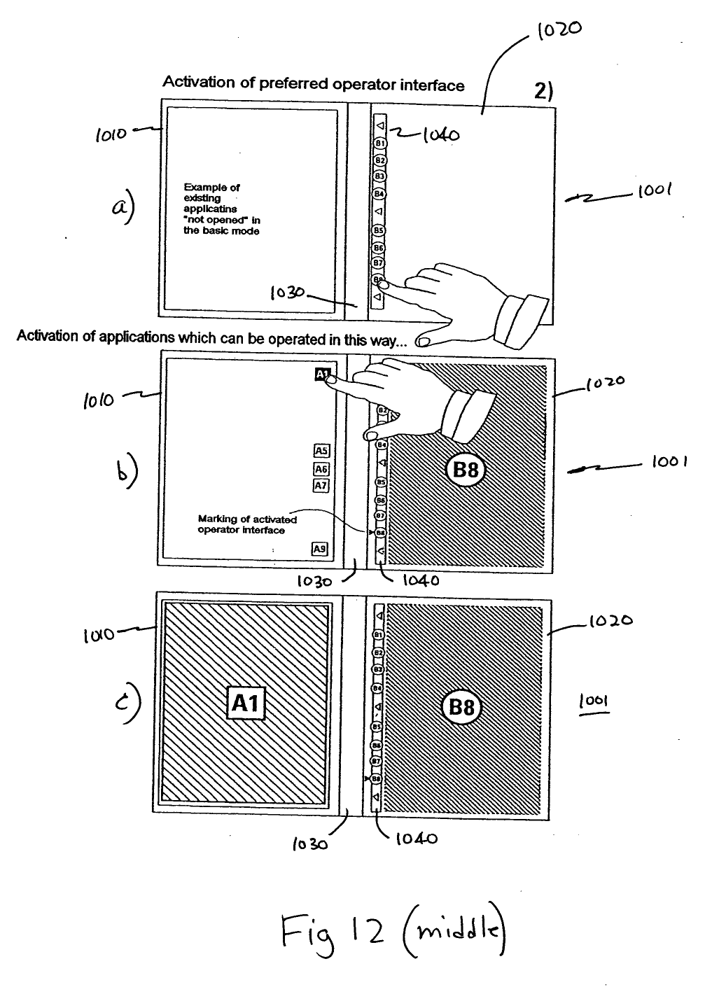

FIG. 12 shows the principle of the selection of an application or of a document by setting up the operator interface.

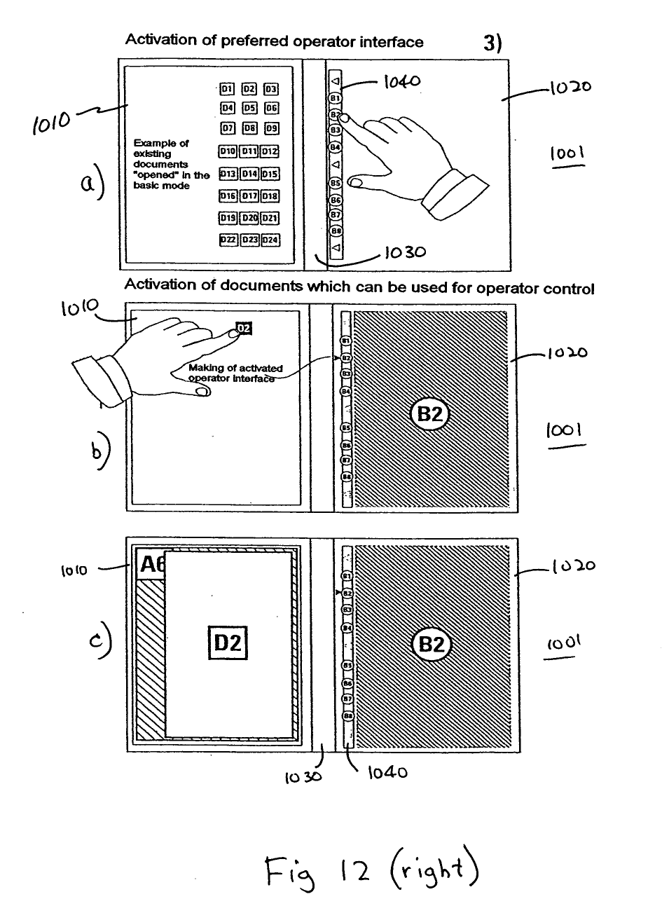

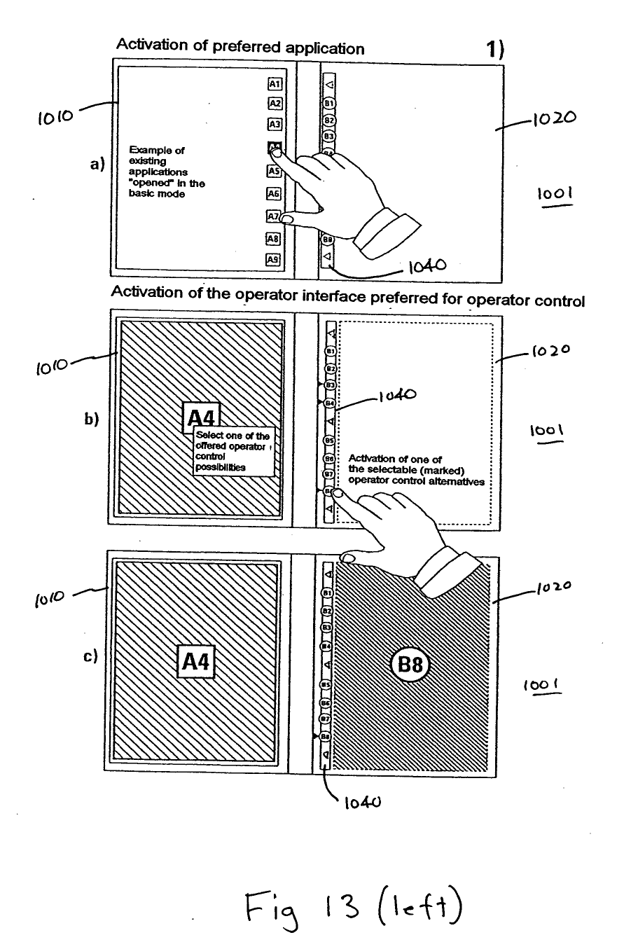

FIG. 13 is a schematic view of the principle of the selection of an operator interface by actuating an application or a document.

FIG. 14 shows a perspective view of a digital mobile device according to the invention in a modular design with a hand-grip part arranged on the gripping edge.

FIG. 15 shows a perspective view of a book spine part without a hand-grip part and without a housing part.

FIG. 16 shows the mechanical interaction of a hand-grip part with a book back part.

FIG. 17 shows a cross-sectional view through the digital mobile device according to the invention (illustrated in FIG. 14) with a modular design.

FIG. 18 shows a two-leaf digital mobile device according to the invention with a display part and a touch pad of equal size, as a book cover, in the folded-open state.

FIG. 19 shows a perspective view of the lower edge of the mobile device according to the invention illustrated in FIG. 18.

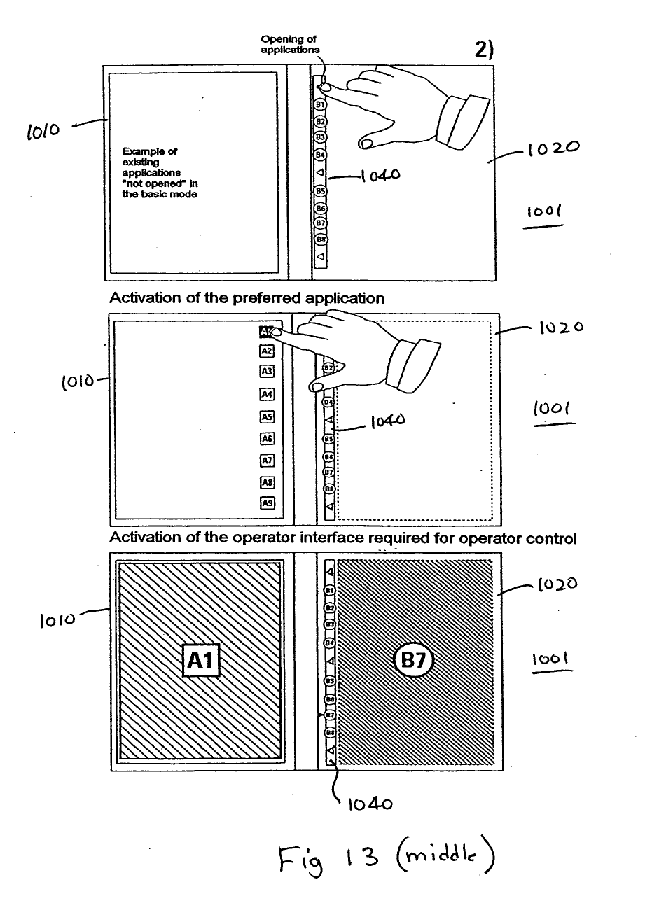

FIG. 20 shows a schematic detailed view of an operator display of a digital mobile device according to the invention from FIG. 18.

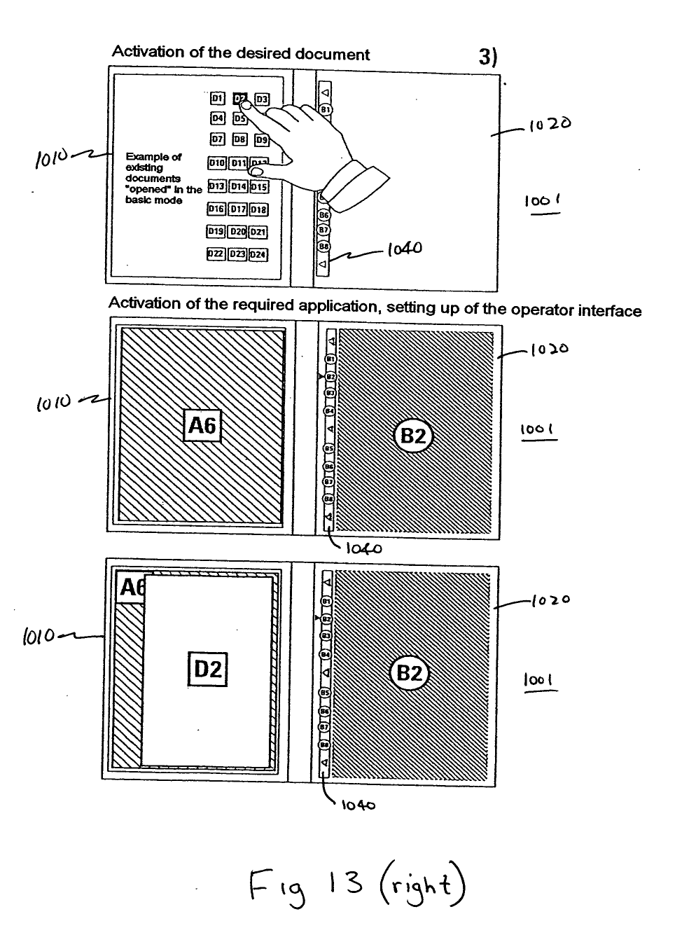

FIG. 21 shows a cross-sectional view of the digital mobile device according to the invention from FIG. 18 in a flexible embodiment, for example, with a polymer screen.

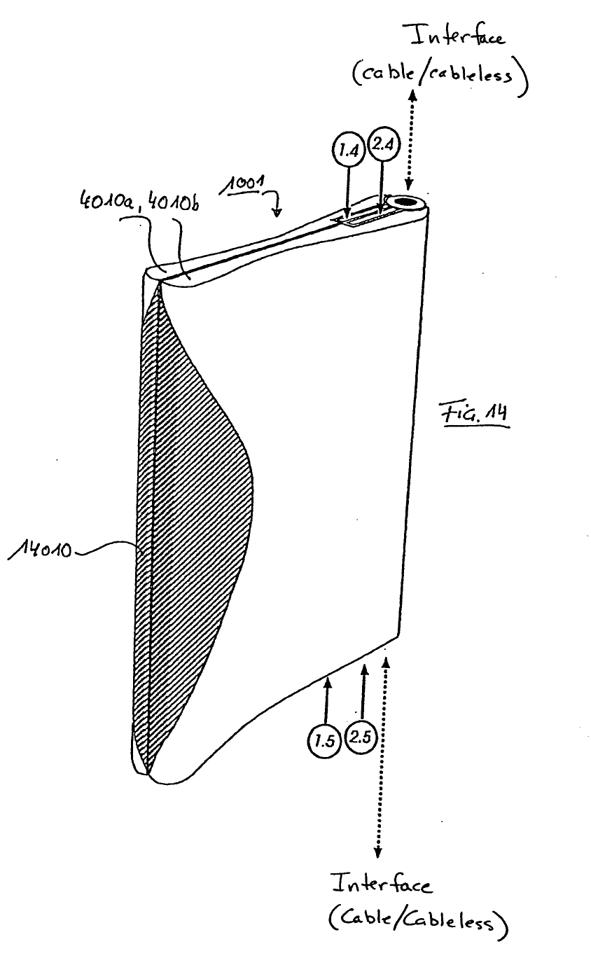

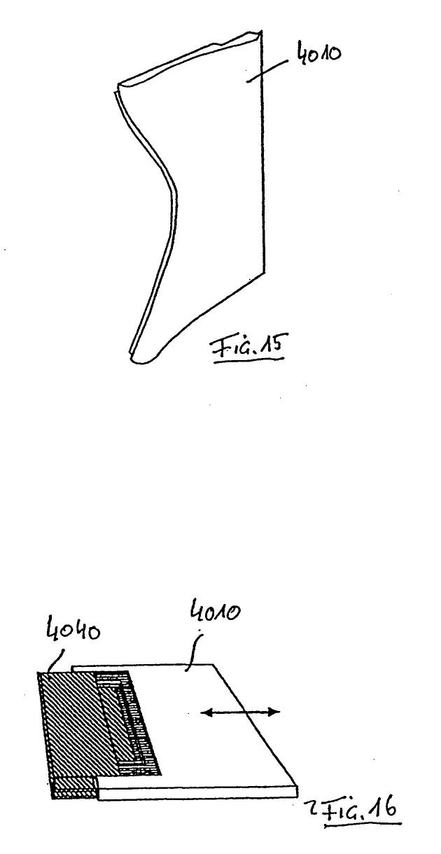

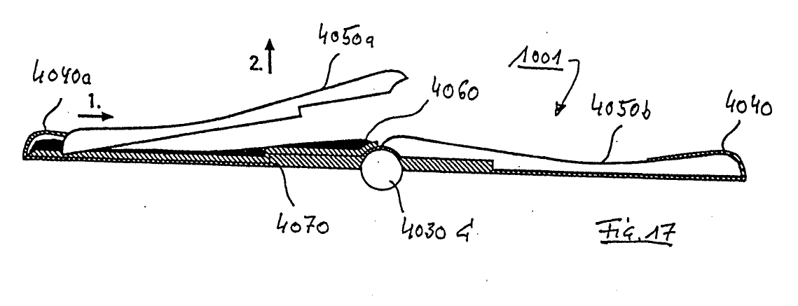

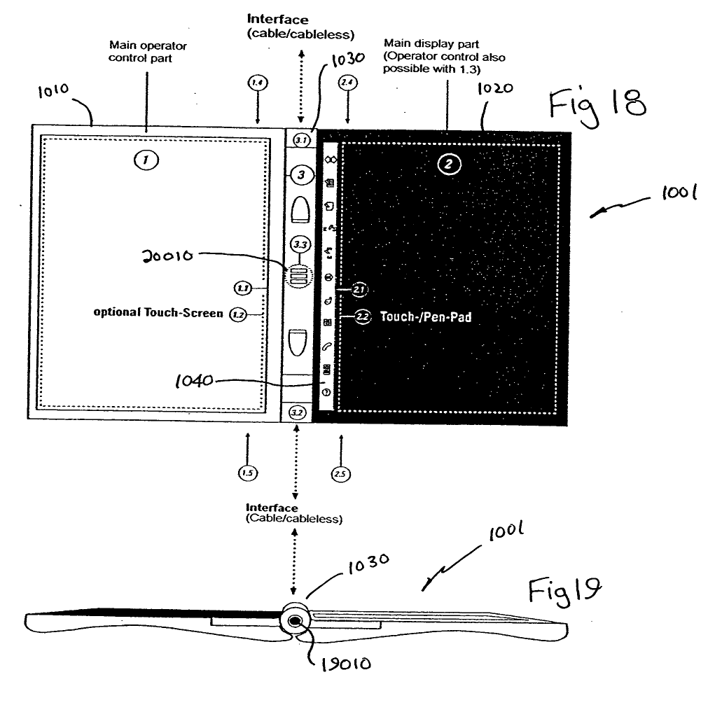

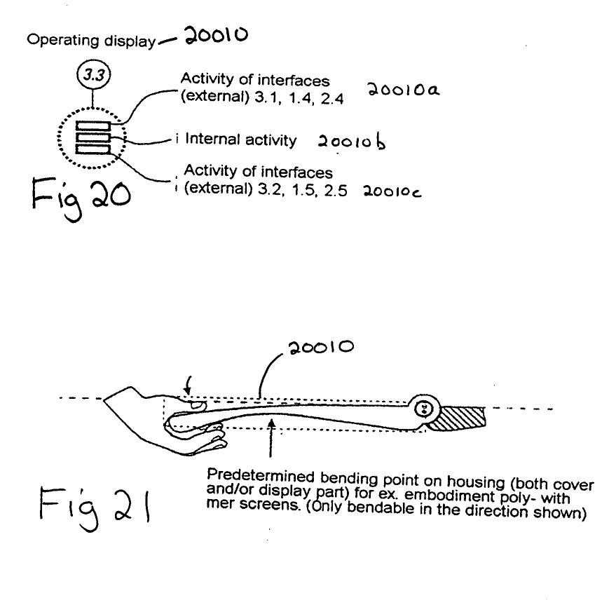

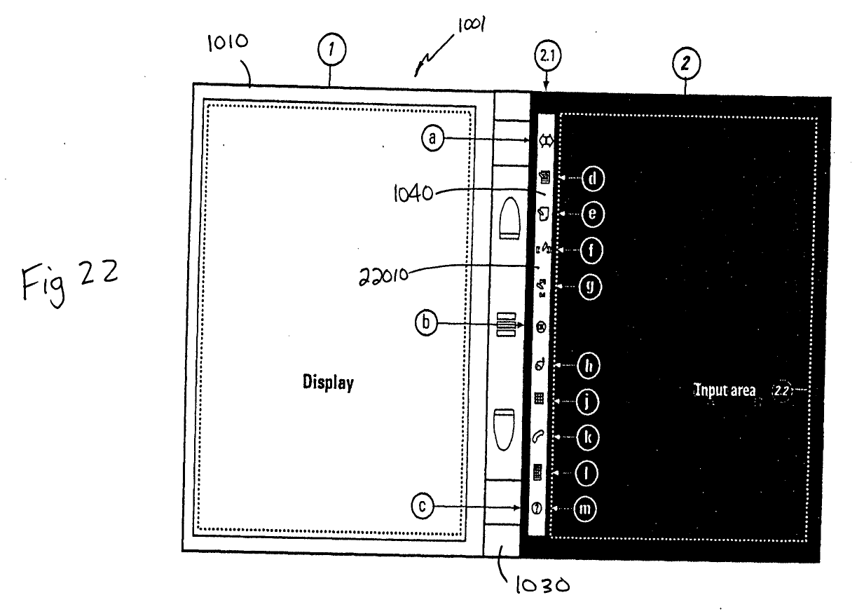

FIG. 22 shows a perspective view of a two-leaf digital mobile device according to the invention in the paper clip integrated into the side edge it operator control part in the folded-open state.

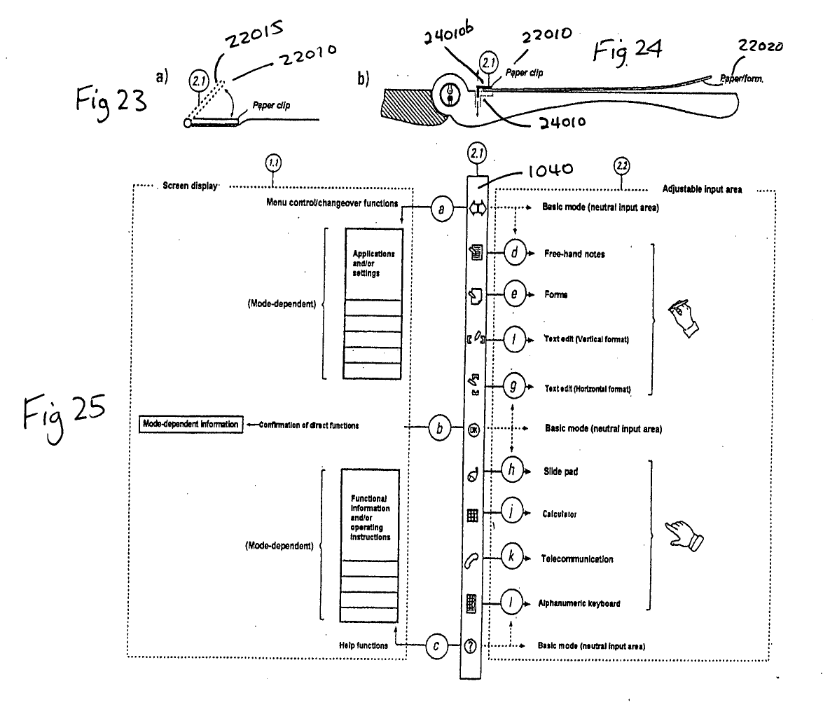

FIG. 23 is a schematic view of the function of the paper clip in the digital mobile device from FIG. 22.

FIG. 24 is a schematic, cross-sectional view of the digital mobile device from FIG. 22 with a paper clip in another embodiment and with a sheet of paper clipped into position.

FIG. 25 shows a functional arrangement of the operator controls provided in the interface selection bar, with a setting momentary-contact switch for setting up the input area from FIG. 22 and with multifunction keys for manipulating information shown on the display.

FIG. 26 shows a perspective view of a two-leaf digital mobile device according to the invention with an auxiliary display, integrated in the side edge of the operator control part, for variable functional symbols.

FIG. 27A is a schematic view of the method of operation of operator controls, provided in the interface selection bar, in a digital mobile device according to the invention in accordance with FIG. 26 in a device for right-handed people.

FIG. 27B shows the arrangement from FIG. 27A with a setting for left-handed people after the display unit has been turned (upside down).

FIG. 28 is a schematic view of the changing assignment of the operator controls of the interface selection bar given successive activations of the changeover function.

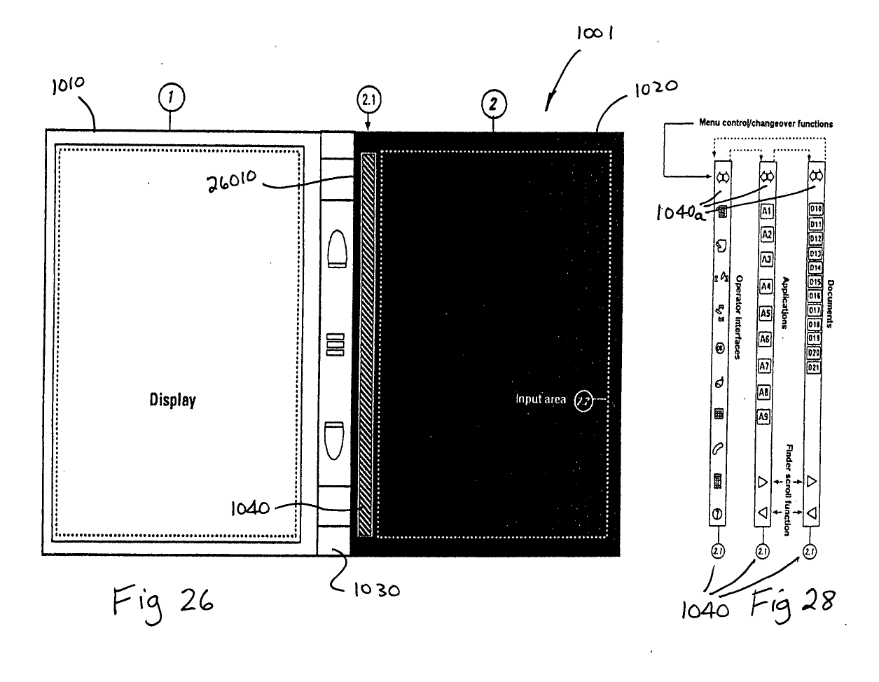

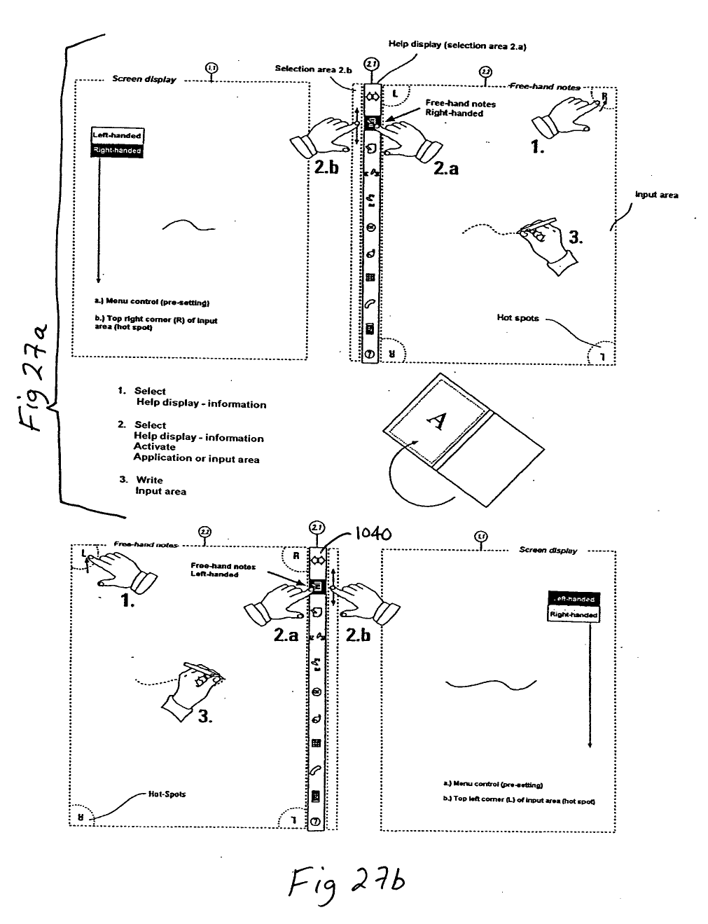

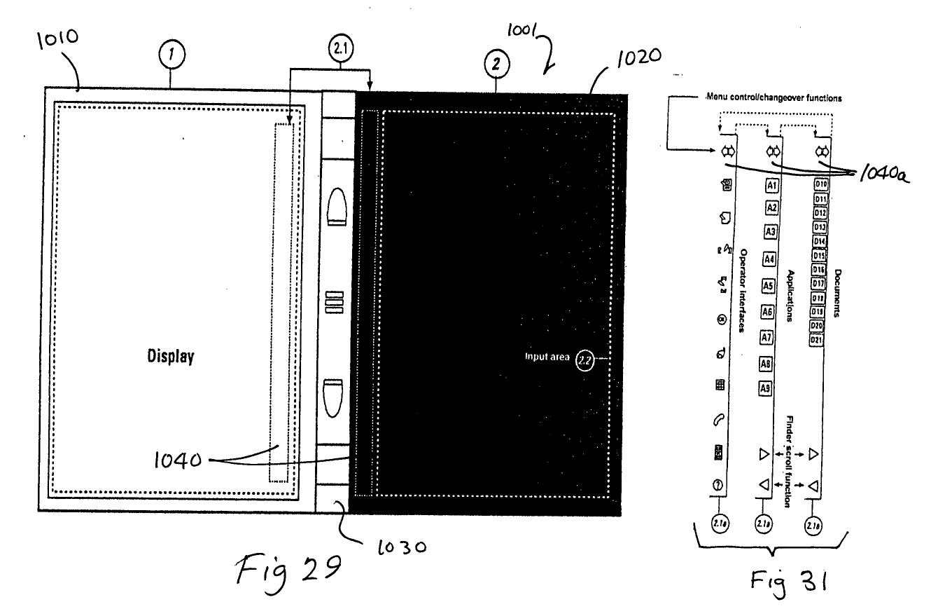

FIG. 29 shows a perspective view of a two-leaf digital mobile device according to the invention with a functional symbol display in the main display part and an operator control possibility in the operator control part or in the main display part in the folded-open state.

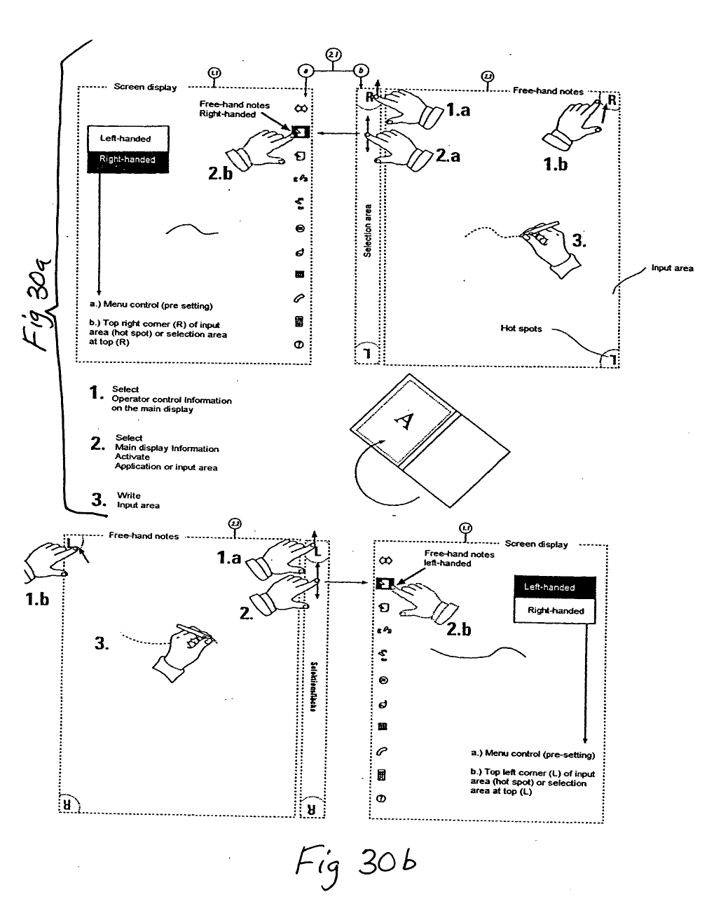

FIG. 30A is a schematic view of the method of operation of operator controls which are provided in the interface selection bar, in a digital mobile device according to the invention in accordance with FIG. 29 with a setting for right-handed people.

FIG. 30B shows the arrangement from FIG. 29A with a setting for left-handed people after the display unit has been turned (upside down).

FIG. 31 is a schematic view of the changing assignment of the operator controls of the interface selection bar given successive activations of the changeover function.

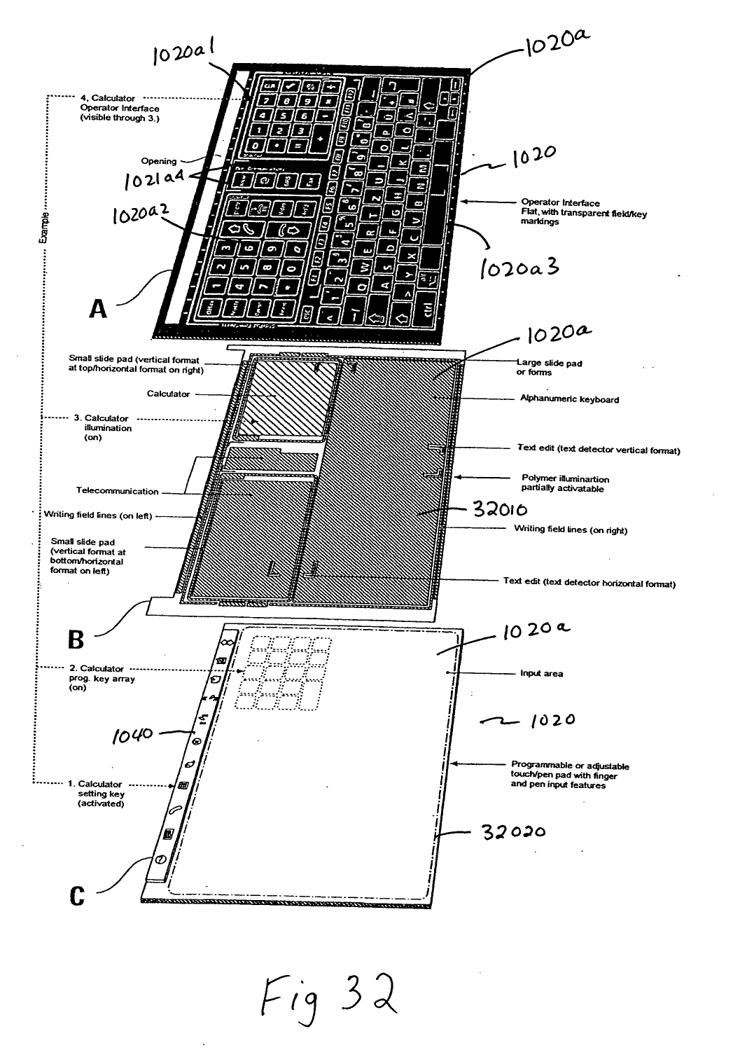

FIG. 32 is a schematic view of a design of the input area of the main operator control part.

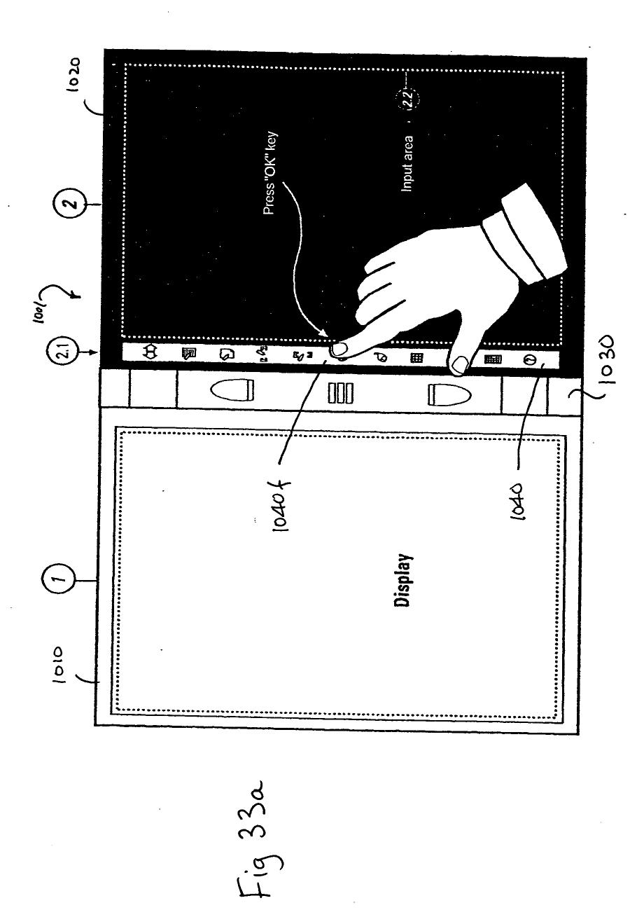

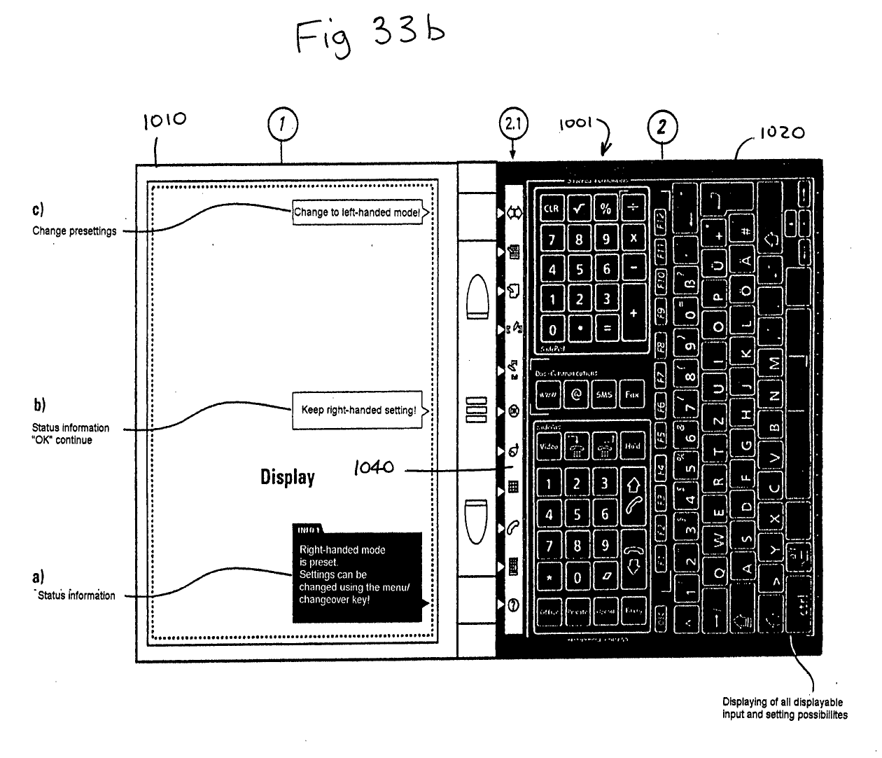

FIG. 33 shows various sequence phases when a digital mobile device according to the invention is switched on. FIG. 33A shows the switch-on operation by activating an operator control in the interface selection bar. FIG. 33B shows the digital mobile device according to the invention in a setting and self-test phase. FIG. 33C shows the digital mobile device according to the invention in a subsequent standby state.

FIG. 34 shows a perspective view of a two-leaf digital mobile device according to the invention in the folded-open state for use of the keyboard in the transverse format.

FIG. 35 is a schematic view of a use of the digital mobile device according to the invention from FIG. 34 for operating text processing software, and a deactivation lock which is to be actuated simultaneously in order to activate the keys, using a thumb.

FIG. 36 shows a two-leaf digital mobile device according to the invention in the folded-open state in a mode for use as a communication device, in particular mobile telephone.

FIG. 37 is a schematic view of a use of the digital mobile device illustrated in FIG. 36, with a plug-in mobile module as a communication device, for example for communication by means of telephone services, e-mail or videophone services.

FIG. 38 shows a perspective view of a two-leaf digital mobile device according to the invention in the folded-open state in an operating mode as an accessory for various applications, for inputting numbers into a marked field or for calculation applications.

FIG. 39 shows the digital mobile device according to the invention in FIG. 38 in a schematic view of an application in a computing program.

FIG. 40 shows a perspective view of a two-leaf digital mobile device according to the invention with a large touch-sensitive sliding surface (“slide pad”) for actuating and activating information in the main display part.

FIG. 41 shows various adaptation alternatives of the digital mobile device according to the invention illustrated in FIG. 40 in terms of use with a vertical format or transverse format and for use for left-handed and right-handed people.

FIG. 41A shows the adaptation for applications in which the main display part and/or the main operator control part are in the transverse format. FIG. 41B shows an adaptation of the digital mobile device according to the invention in which the main display part and/or the main operator control part are used in the vertical format for right-handed people. FIG. 41C shows the adaptation from FIG. 41B, but for left-handed people.

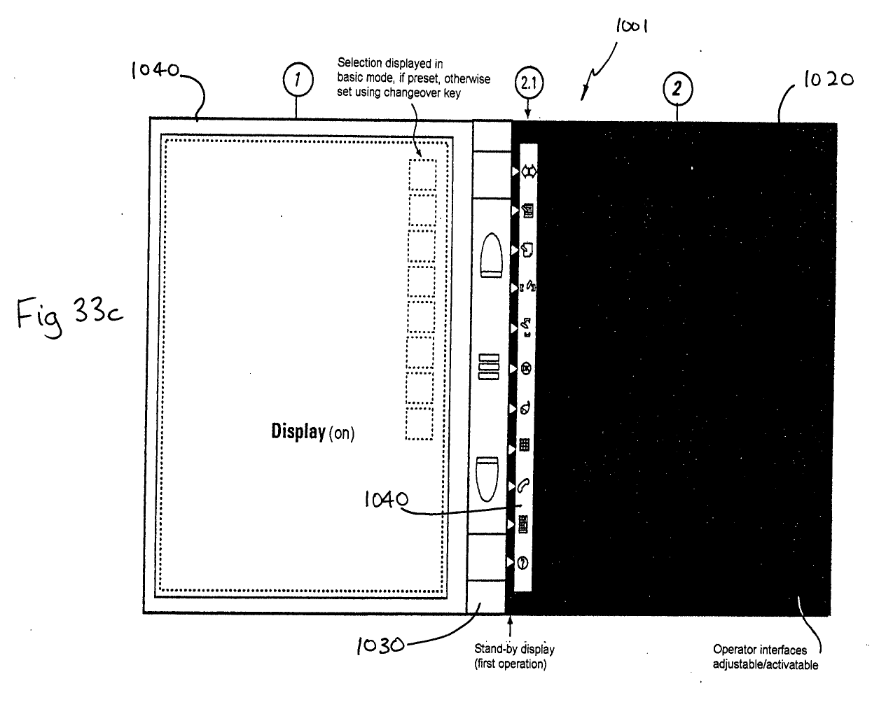

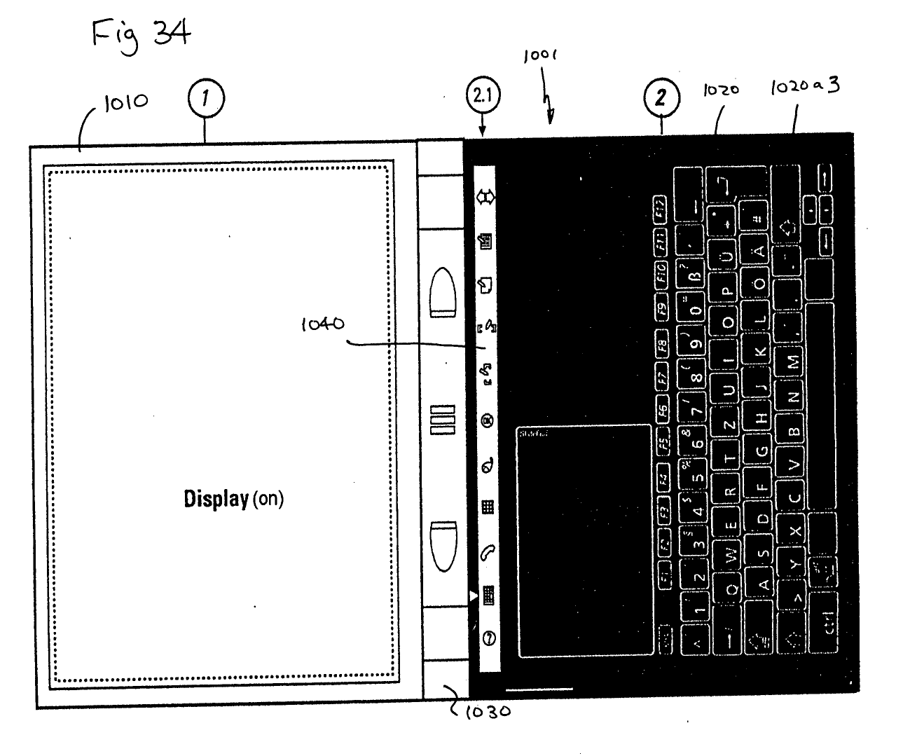

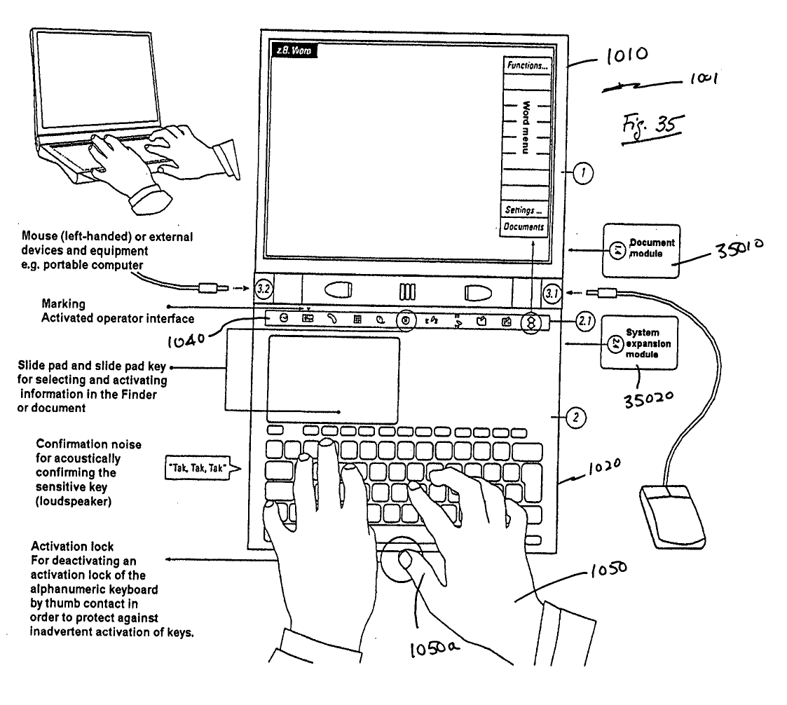

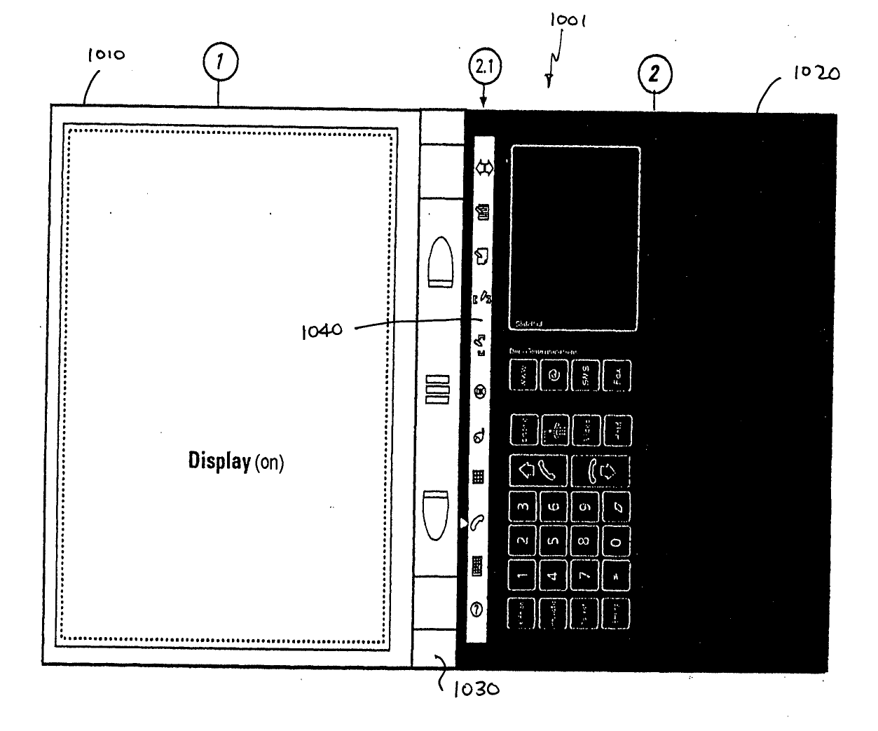

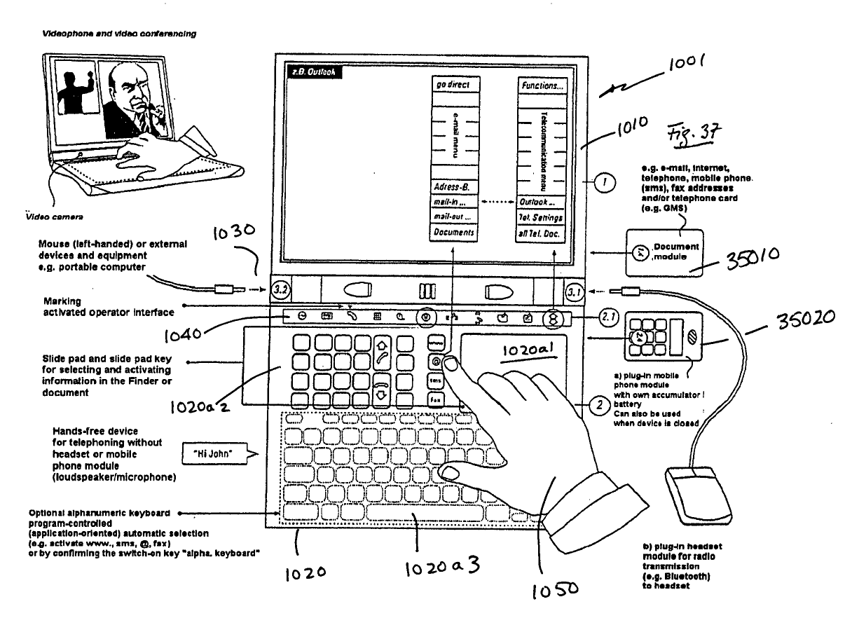

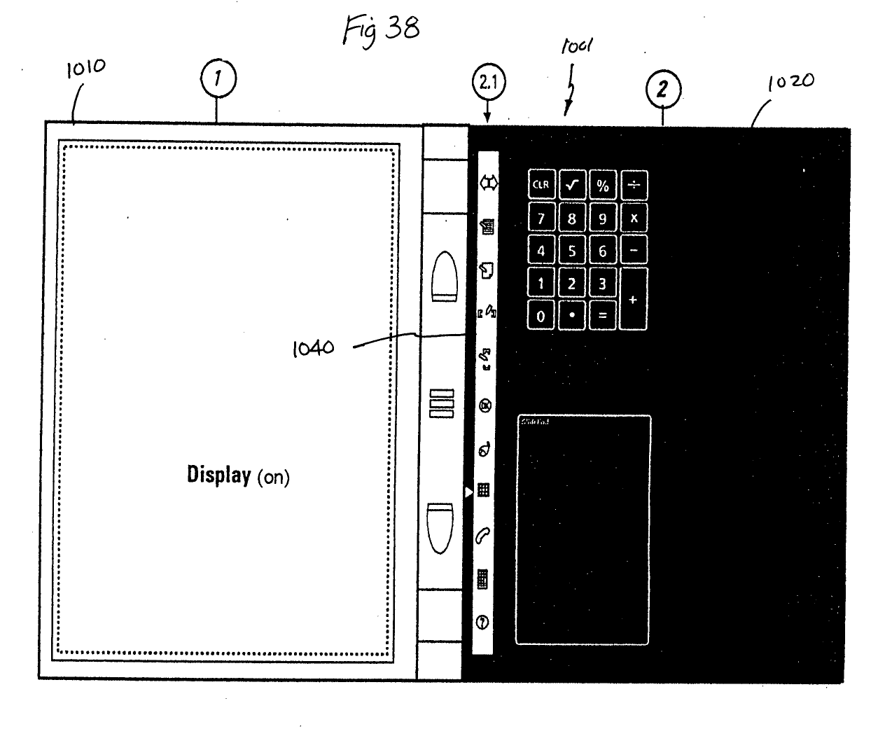

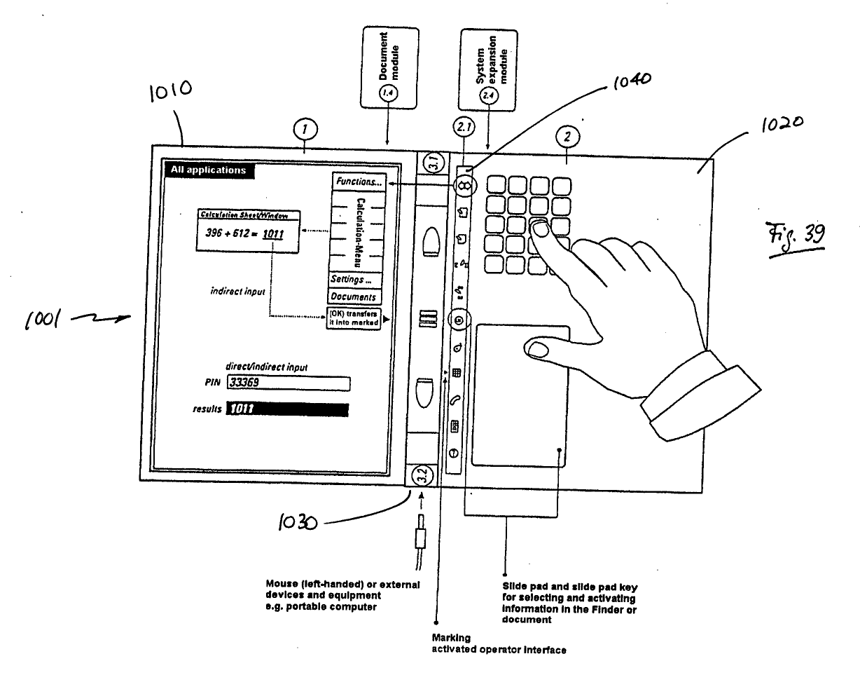

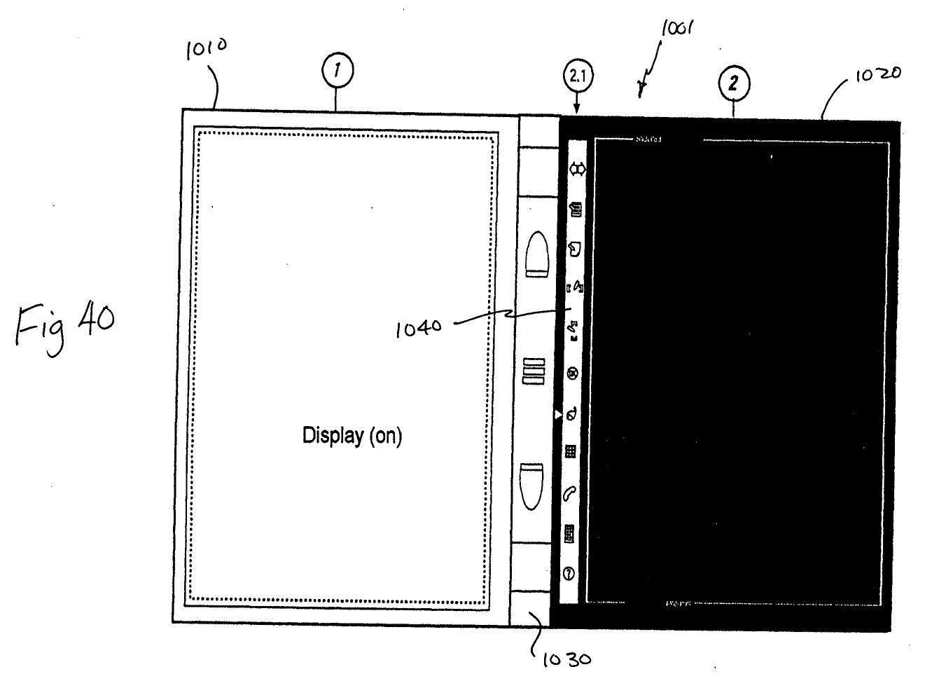

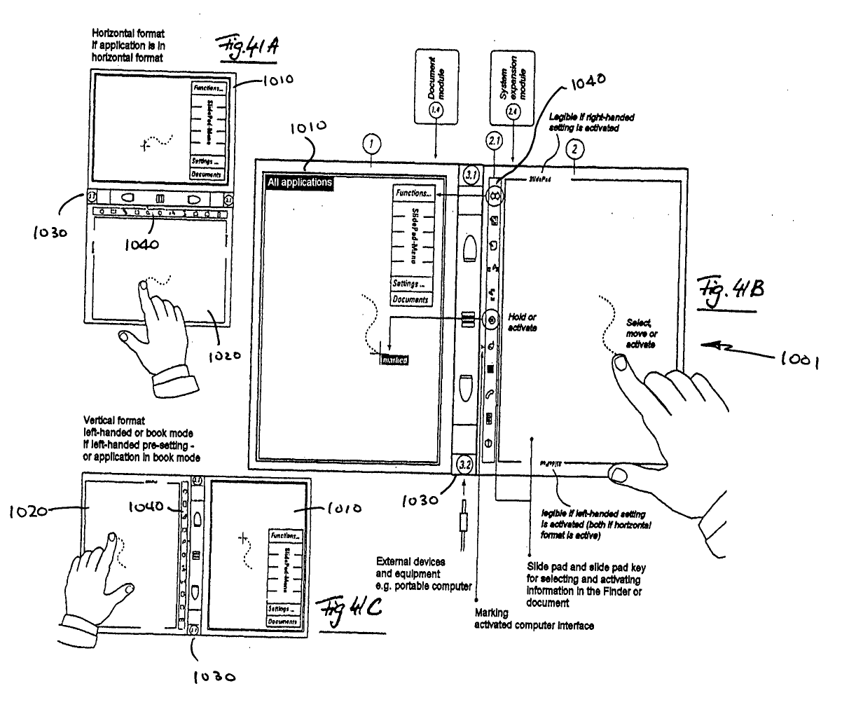

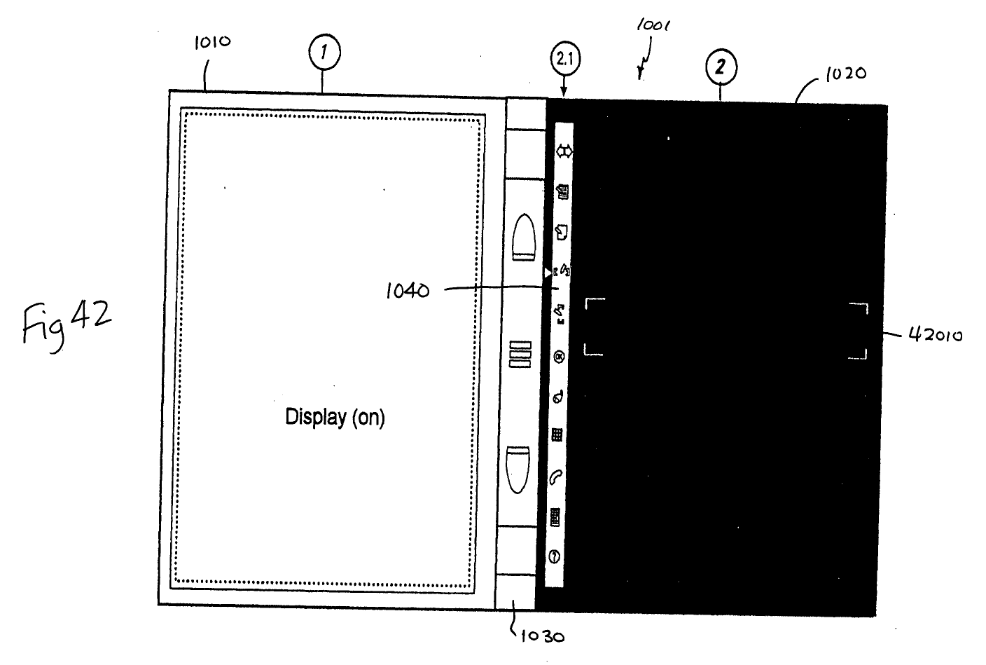

FIG. 42 shows a perspective view of a two-leaf digital mobile device according to the invention in the folded-open state and in the vertical format with a pressure-sensitive text detection zone for inputting text with a pen.

FIG. 43 shows the digital mobile device according to the invention from FIG. 42 with a pressure-sensitive text detection zone in an application with an Internet browser, the simultaneous use of the touch-sensitive surface (“touch pad”) [lacuna] by sliding a tip of a finger for inputting cursor positions etc.

FIG. 44 shows a setting [lacuna] digital mobile device according to the invention from FIG. 42, but with a main display part used in the transverse format and a main operator control part.

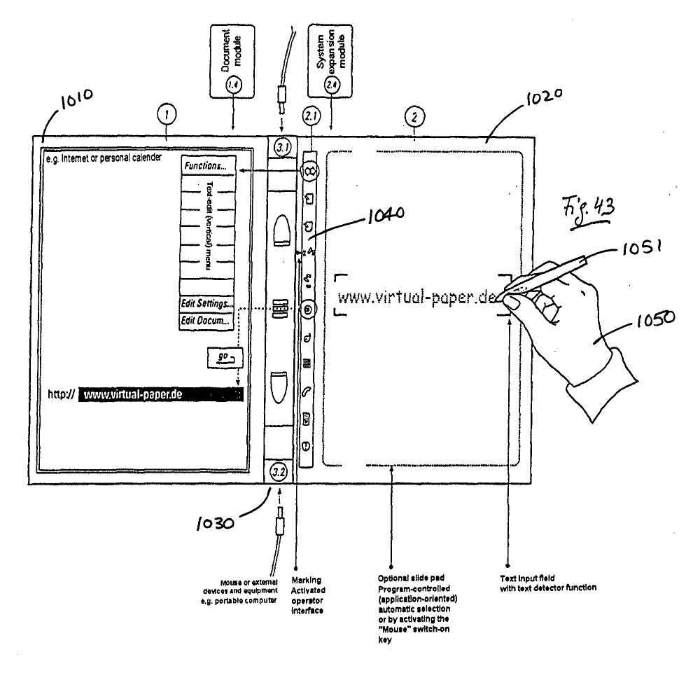

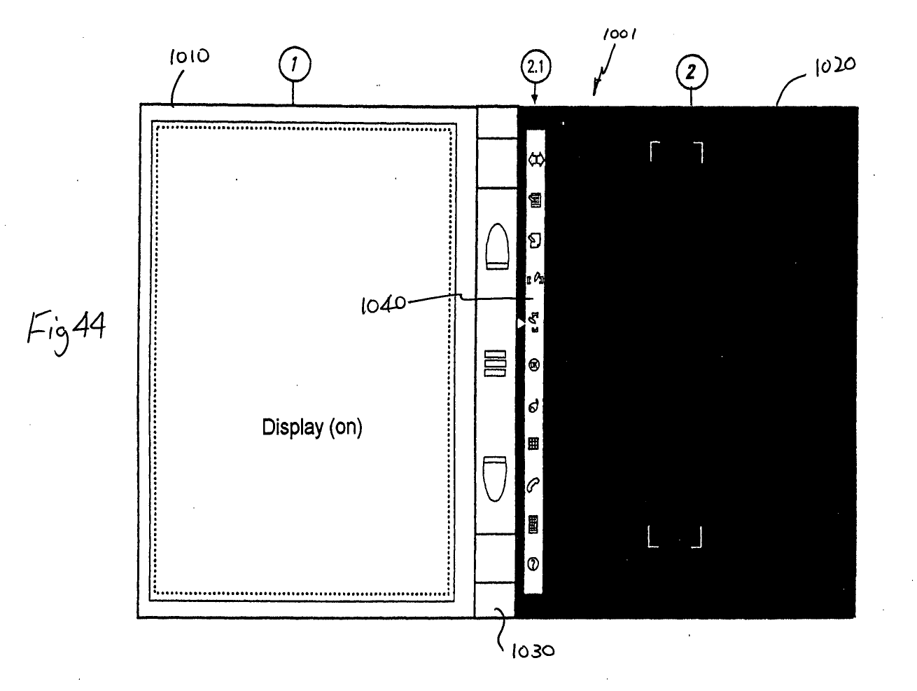

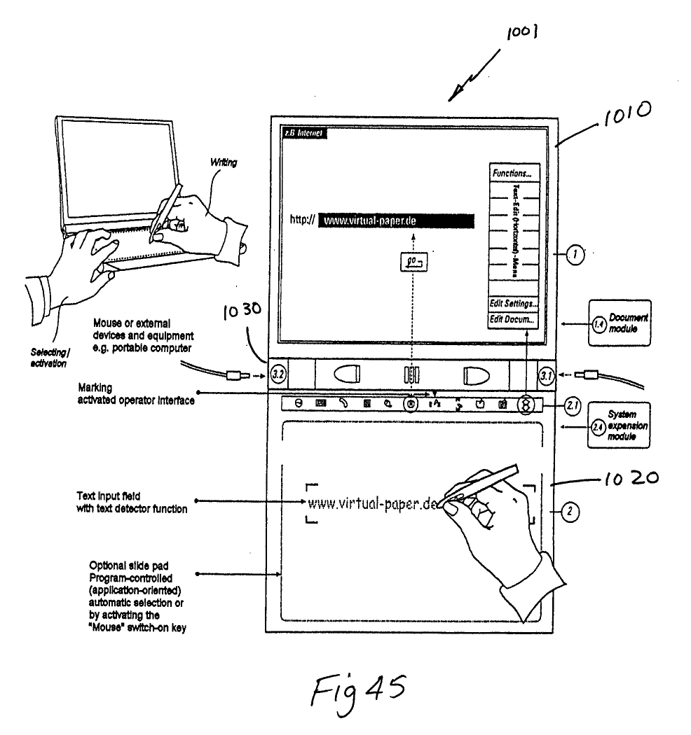

FIG. 45 is a schematic view of an application of the digital mobile device from FIG. 44 corresponding to FIG. 43, but in the transverse format.

FIG. 46 shows a perspective view of a two-leaf digital mobile device according to the invention in the folded-open state for the registration of the filling-in operation of paper forms.

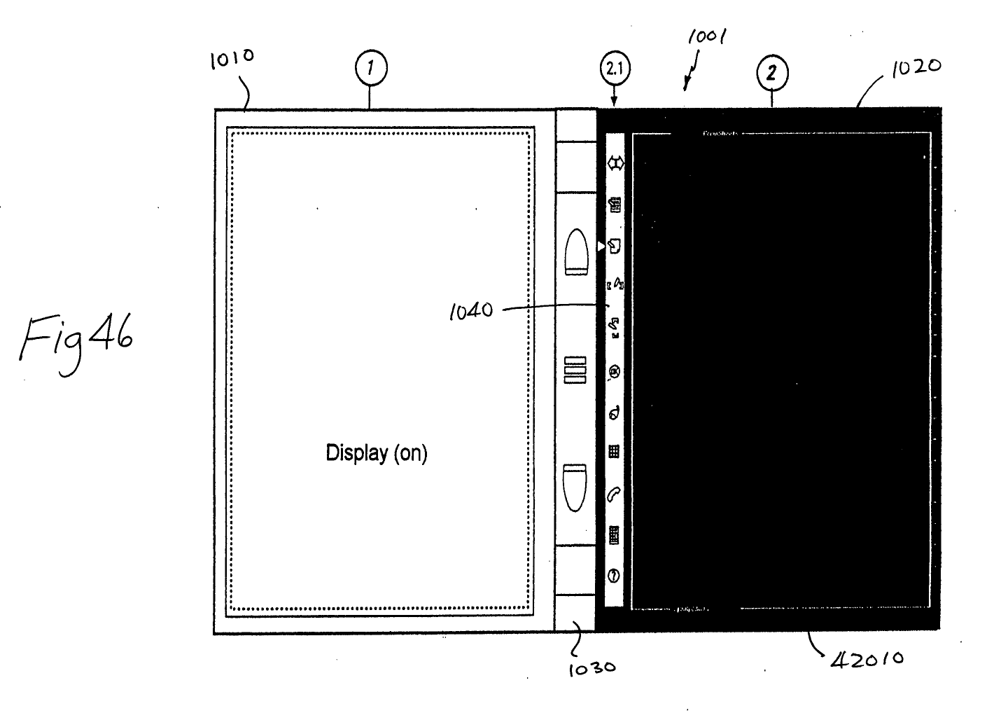

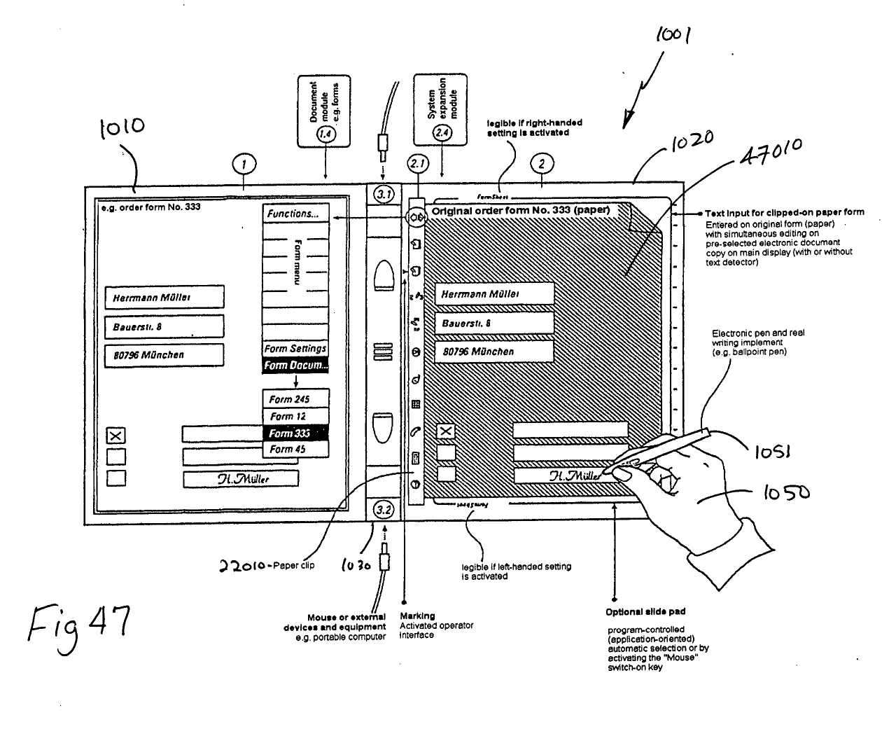

FIG. 47 is a schematic view of the digital mobile device according to the invention illustrated in FIG. 46 in which a paper form is clipped into the main operator control part and is filled in manually, the form and form data with the data entered manually being displayed on the main display part.

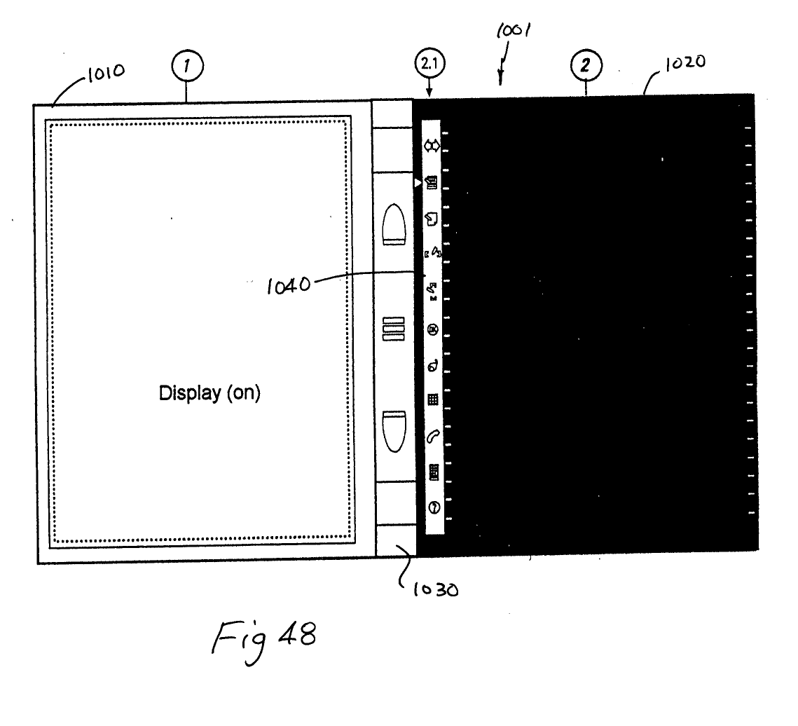

FIG. 48 shows a perspective view of a two-leaf digital mobile device according to the invention in the folded-open state, which device is configured for the inputting of free-hand notes and free-hand sketches, optionally with or without paper, using the main operator control part.

FIG. 49 is a schematic view of an application of the digital device according to the invention illustrated in FIG. 48 for inputting a free-hand sketch or free-hand notes, but without paper.

FIG. 50 shows a perspective view of a two-leaf digital mobile device according to the invention in a variant with a reversible main operator control part.

FIG. 51 is a schematic, cross-sectional view through the digital mobile device according to the invention from FIG. 50 in various activation phases of the reversible main operator control part. FIG. 51A shows the release of the reversible main operator control part by applying finger pressure near to the edge of the device. FIG. 51B shows a phase in which the reversible main operator control part springs up on being released. FIG. 51C shows a further phase in which the reversible main operator control part is folded up and is held in a guide runner on one edge. FIG. 51D shows the reversible main operator control part in the folded-over state. FIG. 51E shows the reversible main operator control part in the engaged state in which the engagement occurs near to the hinge part.

FIG. 52 shows a schematic, perspective view of the digital mobile part from FIG. 50 with a compartment for utensils and the reversible part with two surfaces which can be embodied in different ways.

FIG. 52B shows the digital mobile device according to the invention from FIG. 50, a first side of the main operator control part with a touch pad and/or pen pad being positioned facing upward.

FIG. 52C shows a digital mobile device according to the invention from FIG. 50 in which, after a reversing operation, a second side of the main operator control part is positioned facing upward, said side having a real keyboard, constructed from individual activation keys, and a slide pad.

FIG. 52D shows a variant of a digital mobile device according to the invention from FIG. 50 in which a first side of the main operator control part has a second display.

FIG. 52E shows a view of the variant of the digital mobile device according to the invention from FIG. 52D, in which variant a second side of the main operator control part has a book cover without operating means.

FIG. 53 shows a schematic view of the ergonomic adaptation of the operator control when the way in which a two-leaf digital mobile device according to the invention is supported is changed. FIG. 53A shows a “hand-held” mode in which the digital mobile device is held freely, essentially in the manner of a book. FIG. 53B shows a “free-hand” mode in which the main operator control part is supported firmly on an underlying surface and is used as a keyboard input means or pen input means. FIG. 53C shows a “hand-held/free-hand” use in which the digital mobile device is used in a partly freely held and partly supported position.

FIG. 54 is a schematic view of various rotary orientation states during the handling of a digital mobile device according to the invention.

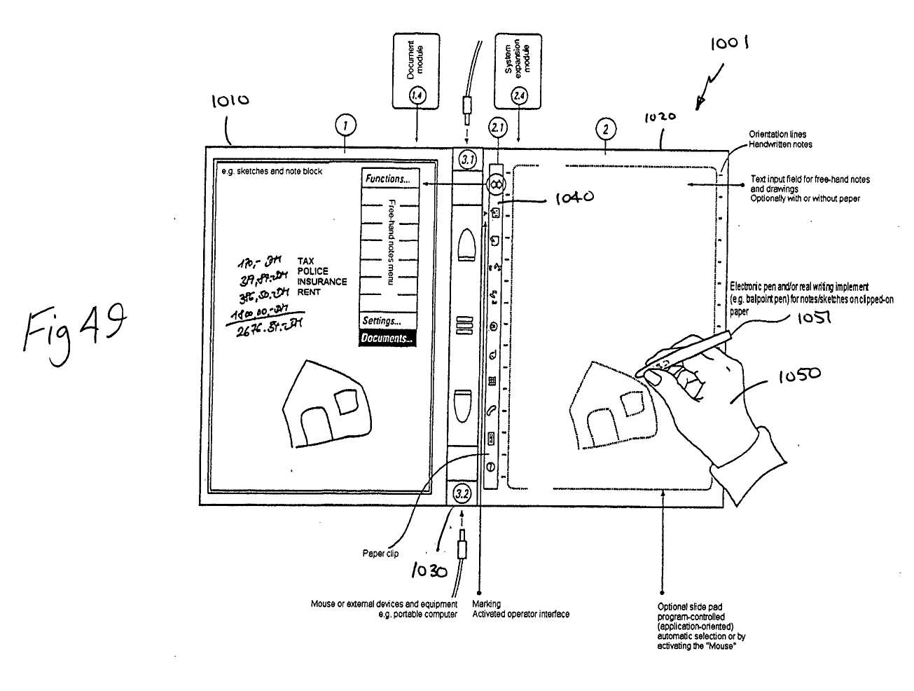

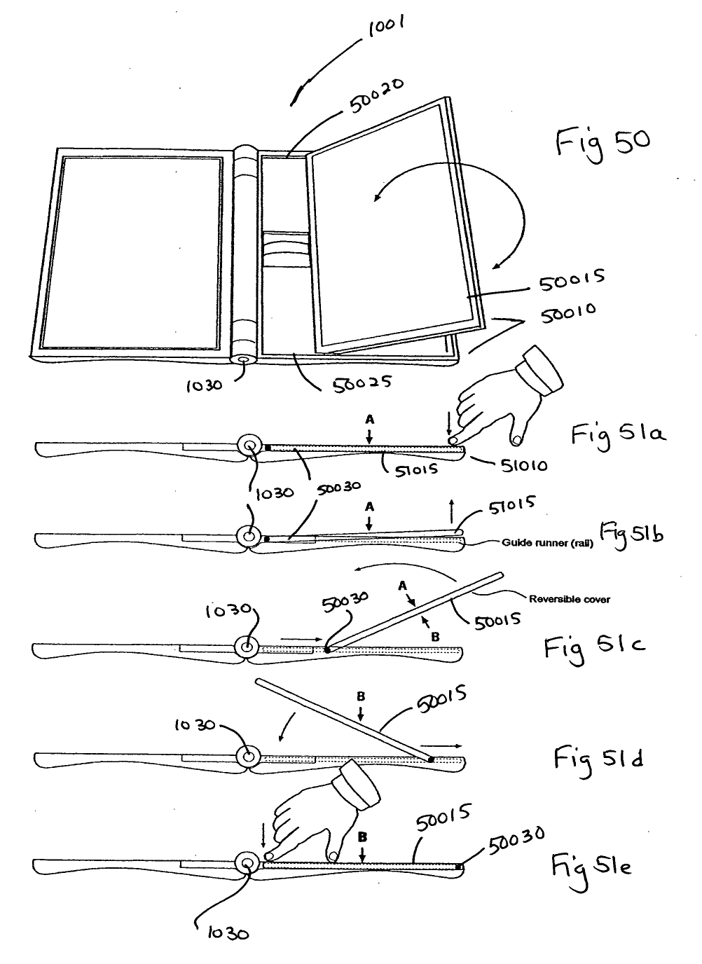

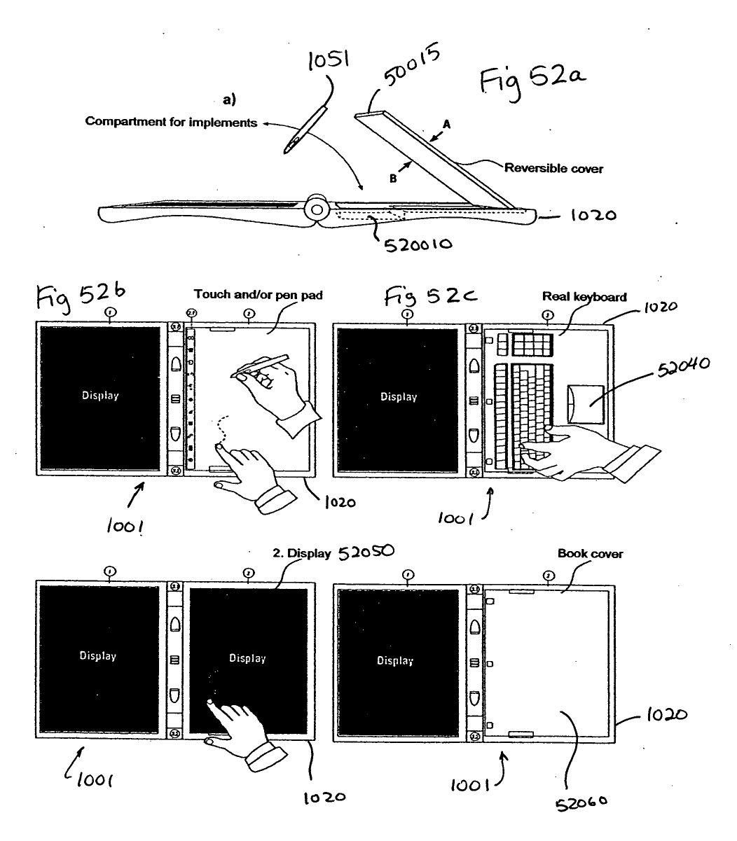

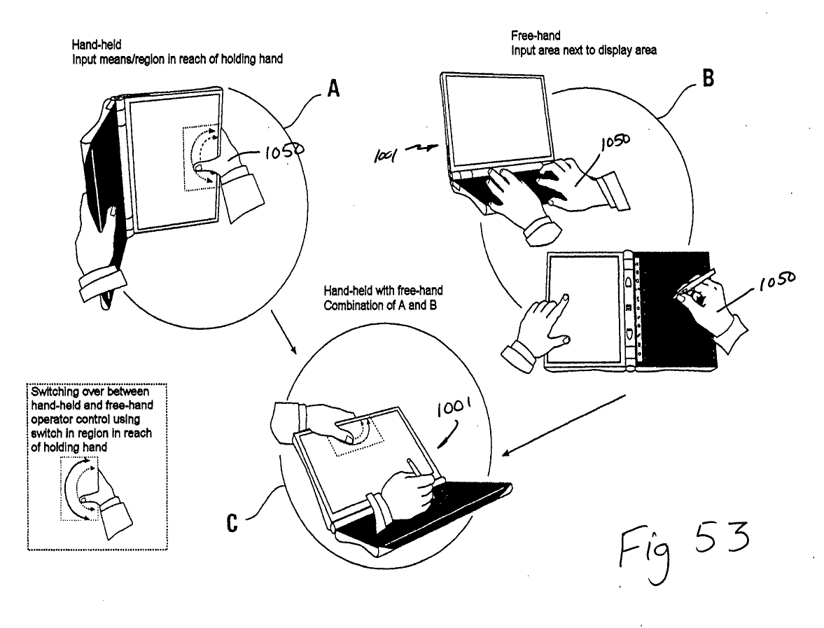

FIG. 55 is a schematic view of operating means within reach of the operator's holding hand for ergonomically making inputs into a digital mobile device according to the invention which is held in the hand, as a one-handed or two-handed embodiment.

FIG. 56 is a schematic view of the lower edge with integrated interface of the digital mobile device according to the invention illustrated in FIG. 55.

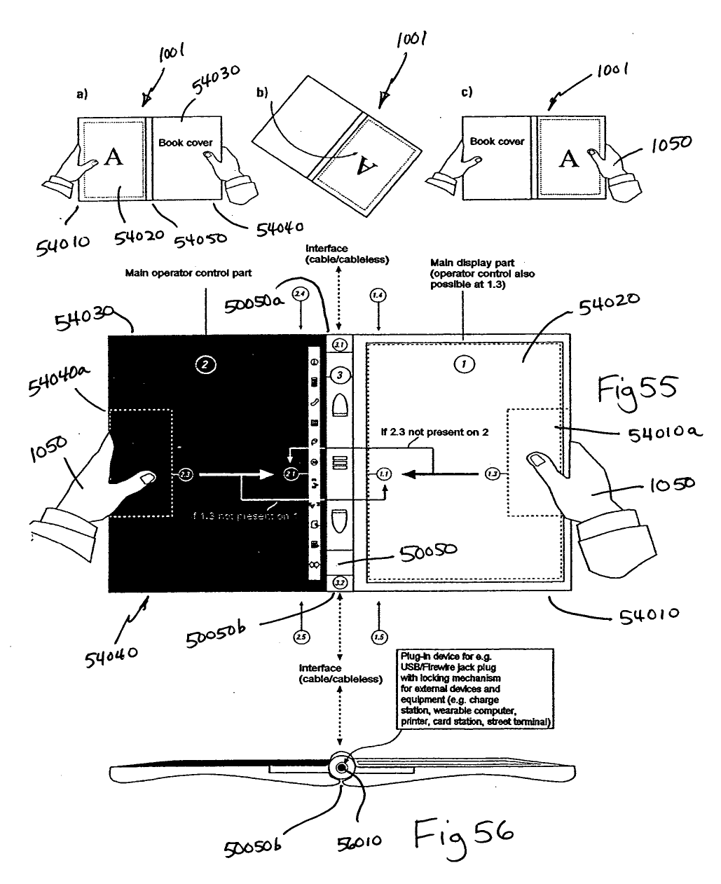

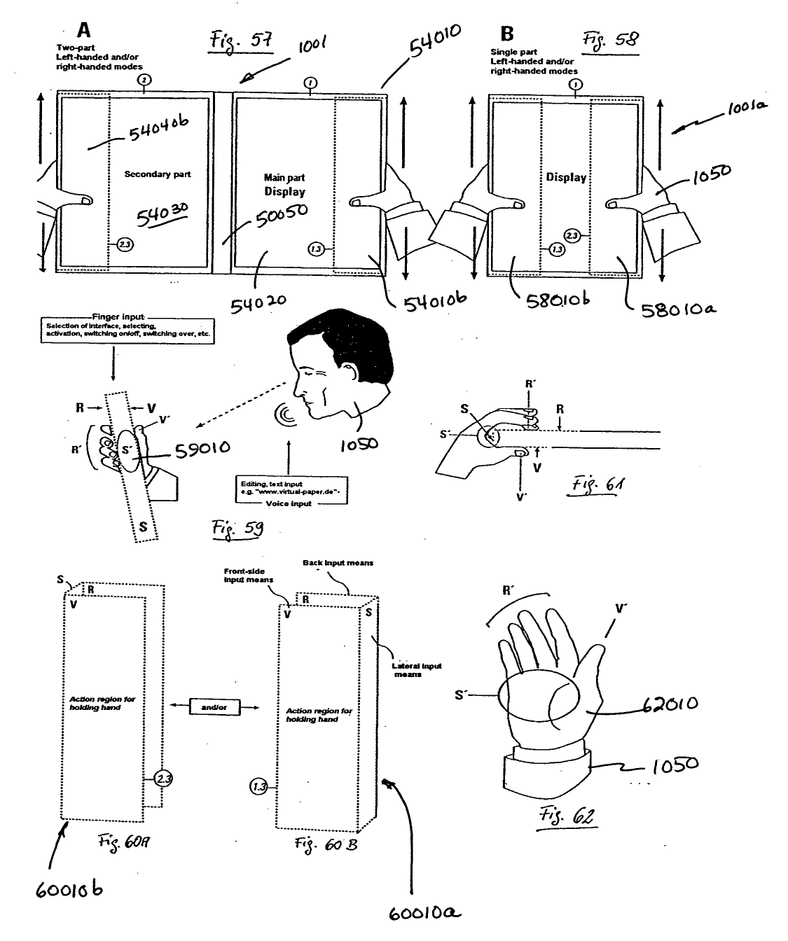

FIG. 57 is a schematic view of positioning possibilities of the operating means in the action region within reach of the operator's holding hand on a two-part digital mobile device according to the invention.

FIG. 58 is a schematic view of positioning possibilities of the operating means with a region which is in reach of the operator's holding hand on a single-leaf digital mobile device according to the invention.

FIG. 59 is a schematic view of the interaction between the hand and the operating means in the action region within reach of the operator's holding hand and a possible voice input means.

FIG. 60A is a schematic view of the action region of a first hand on the gripping edge on three sides of the display unit.

FIG. 60B is a schematic view of the action region of a second hand.

FIG. 61 is a schematic view of the interaction between the action region within reach of the operator's holding hand and the operating means on a digital mobile device according to the invention.

FIG. 62 is a schematic view of interaction regions of an operator's hand.

FIG. 63 shows a schematic view of the active regions of the operating means in the action region within reach of the operator's holding hand for single-handed or two-handed input possibilities, and left-handed and/or right-handed operator control on a two-leaf digital mobile device according to the invention.

FIG. 64 shows a schematic view of operating means alternatives in the action region within reach of the operator's holding hand on a two-leaf digital mobile device according to the invention. FIG. 64A shows a variant with a touch pad in the main operator control part and a separate main display part. FIG. 64B shows a variant with a touch pad or touchscreen on the main display part. FIG. 64D shows a variant with a tracker ball in the main display part. FIG. 64E shows a variant with a tracker ball in the main input part with a separate main display part. FIG. 64F shows a variant with a touch pad which is arranged in the main input part and has a separate main display part. FIG. 64G shows a variant with a touch pad or touchscreen region which is mounted on the main display part. FIG. 64H shows a variant with momentary-contact switches which are mounted on the main display part. FIG. 64I shows a variant with momentary-contact switches mounted on the main operator control part.

FIG. 65 shows a schematic view of operating means alternatives in the action region within reach of the operator's holding hand, relating to the interface selection, selection and activation of information on the display device on a two-leaf digital mobile device according to the invention.

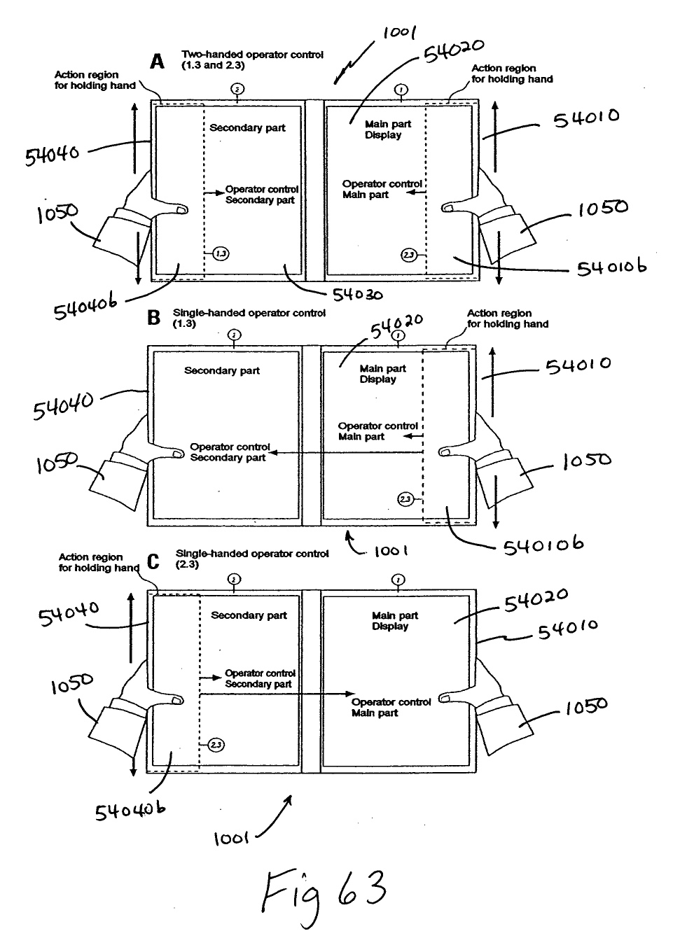

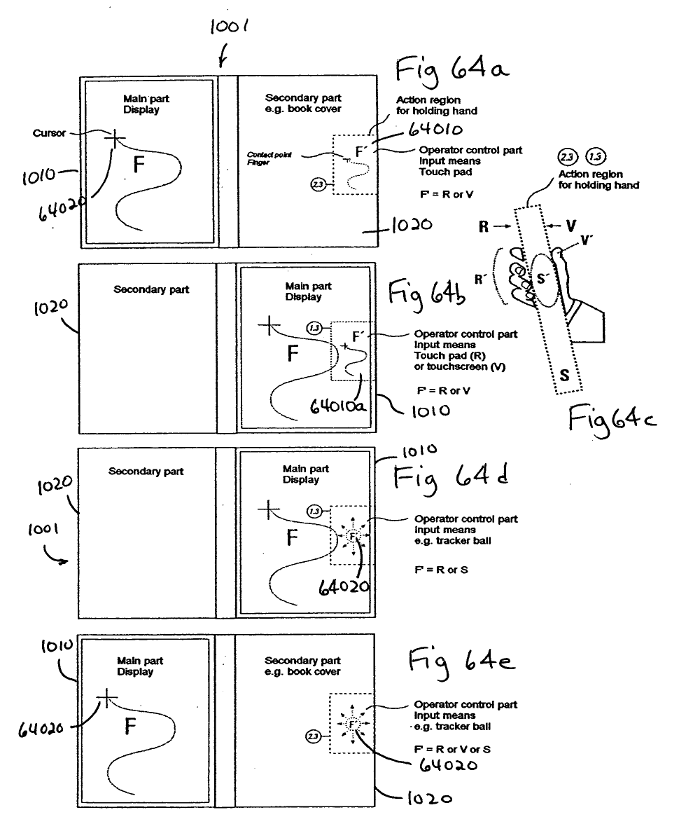

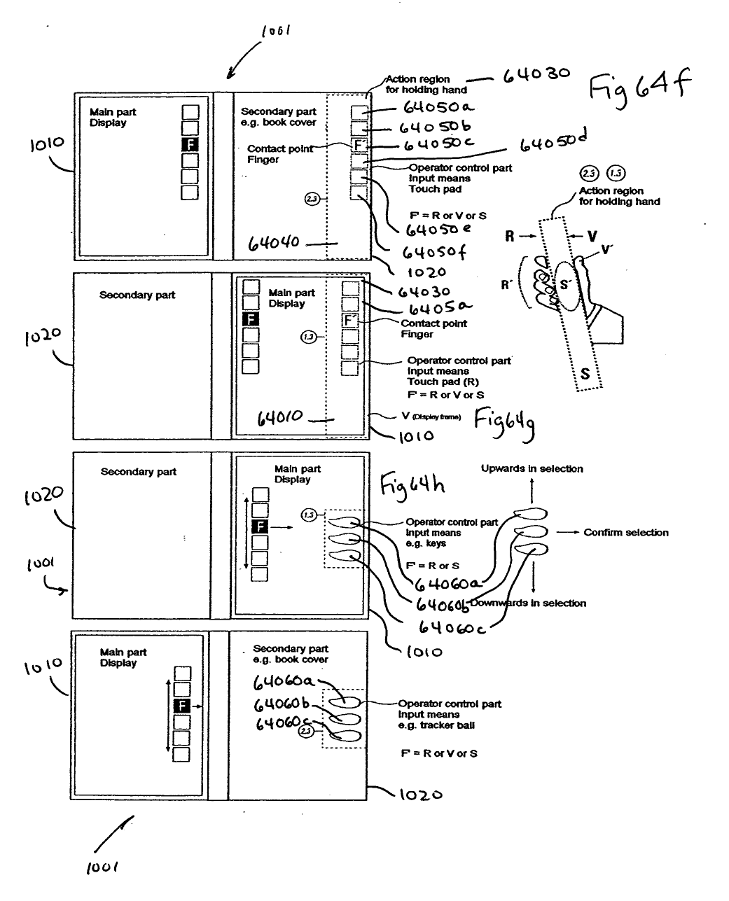

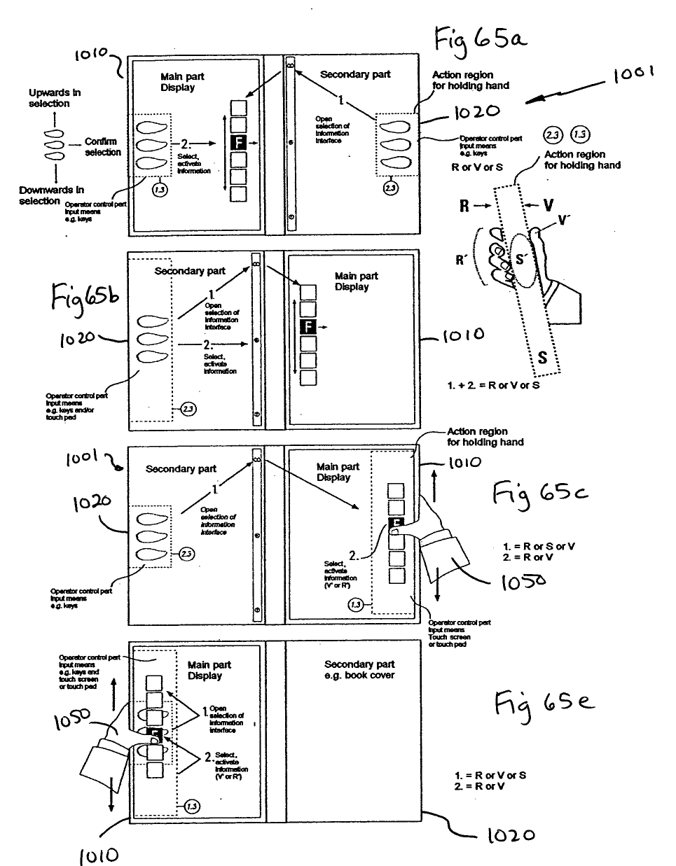

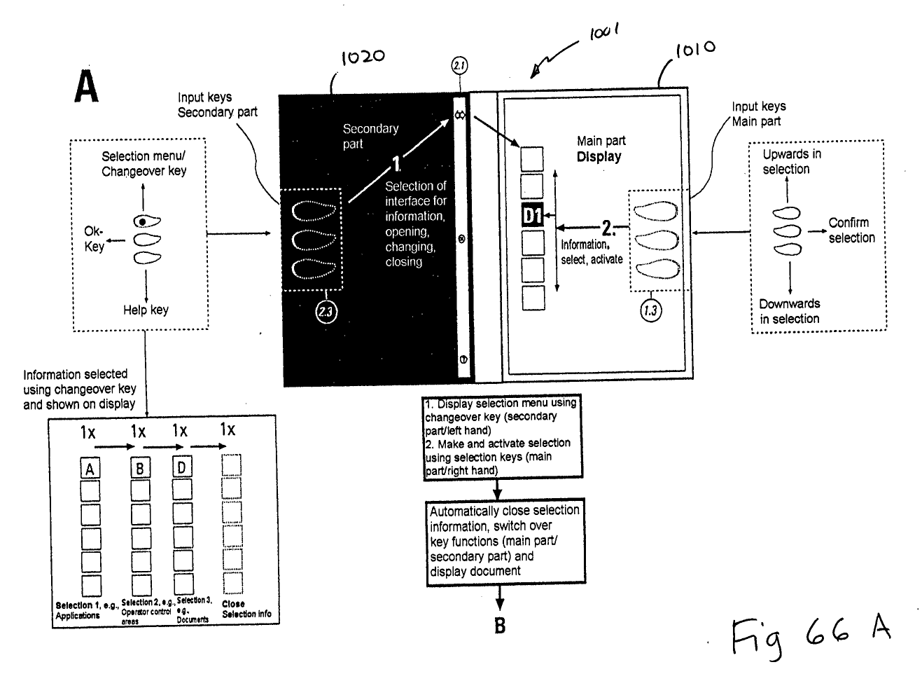

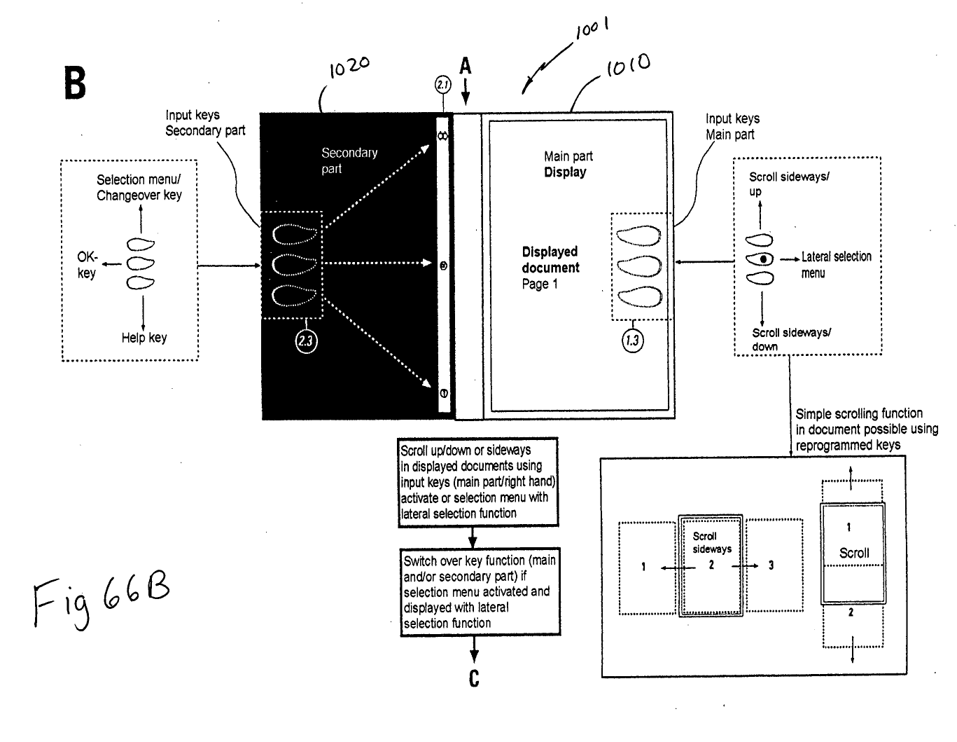

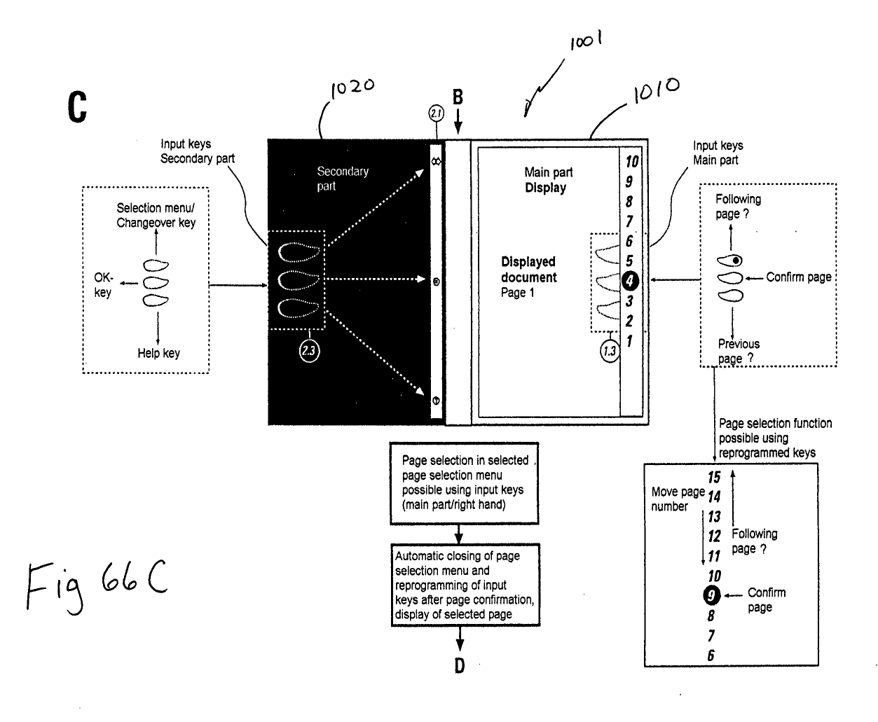

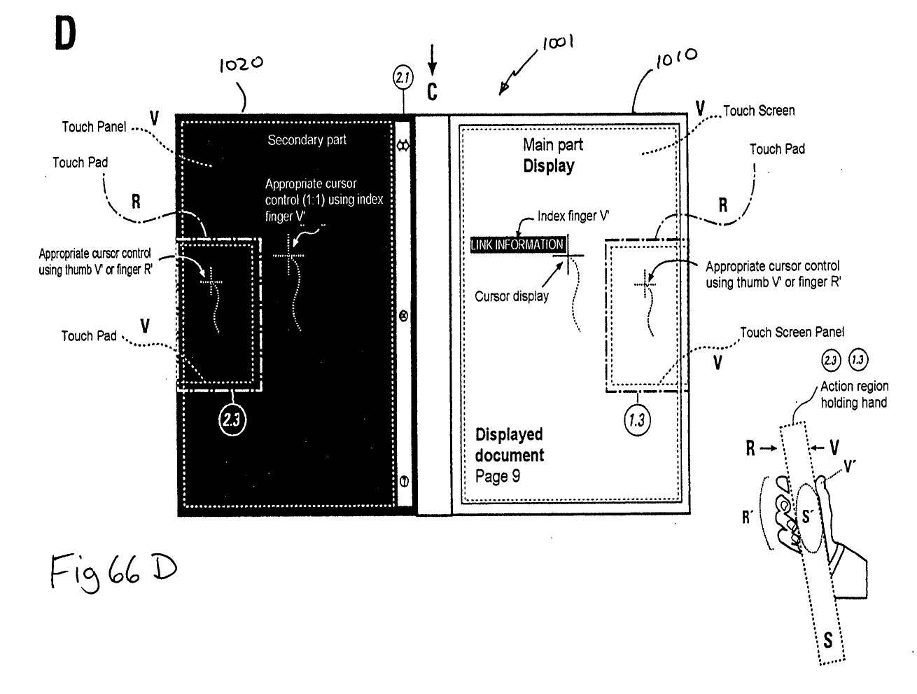

FIG. 66 shows a schematic view of operating means in the action region within reach of the operator's holding hand, relating to keyboard operation on the back, side and/or front with additional touch pad input means with different designs on a two-leaf digital mobile device according to the invention.

FIG. 67 shows a perspective back view of a two-leaf digital mobile device according to the invention with combination keys on the back of the hand-grip part.

FIG. 68 shows a schematic view of the use of the two-leaf digital mobile device according to the invention from FIG. 67 in the manner of a book held with both hands with combination keys on the back of the main display part without a hand-grip part.

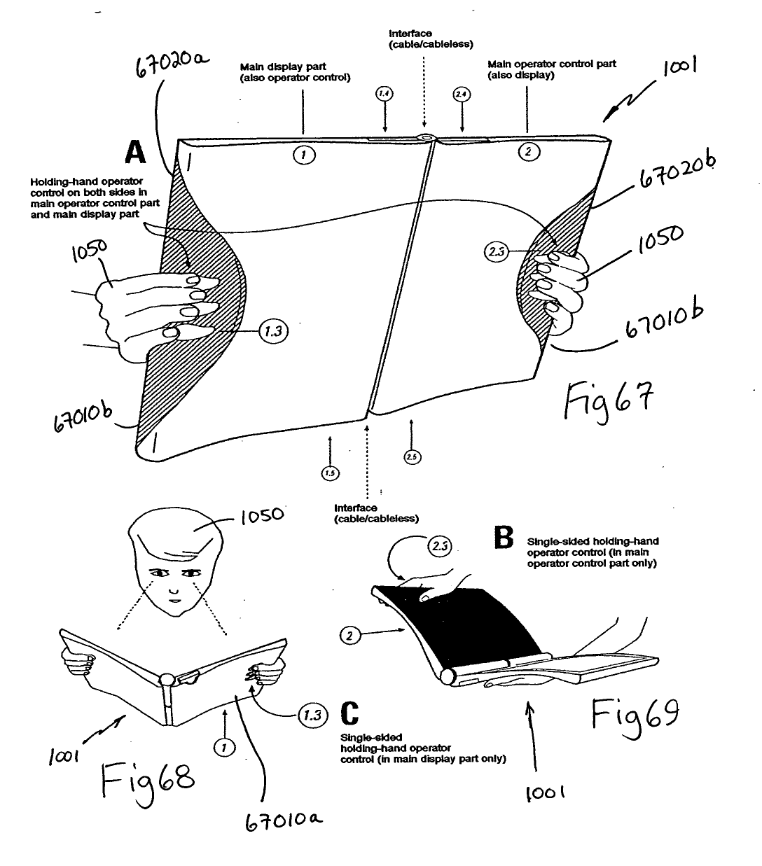

FIG. 69 shows a schematic view of the use of the two-leaf digital mobile device according to the invention from FIG. 68 with another method of handling.

FIG. 70 shows a perspective view of a two-leaf digital mobile device according to the invention which is held with two hands with pressure-sensitive regions which can be operated using a thumb.

FIG. 71 shows a perspective back view of a two-leaf digital mobile device according to the invention with function keys on the back, which keys lie in the region within reach of the operator's holding hand and can be activated by the holding hand.

FIG. 72 shows a perspective view of a two-leaf digital mobile device according to the invention which is held with the left hand and operated in the region within reach of the operator's left holding hand, the right hand operating a pen which can be used to input information.

FIG. 73 shows a perspective view of a two-leaf digital mobile device according to the invention which is held by a hand in the hinge region, an operator control operation on a touch pad being carried out with the other hand.

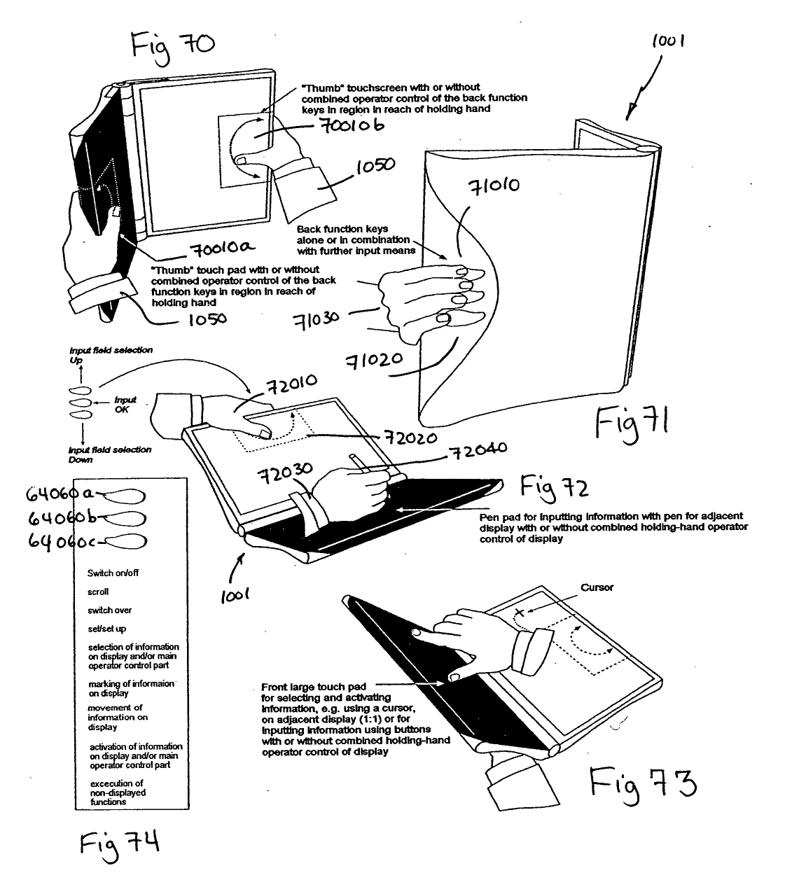

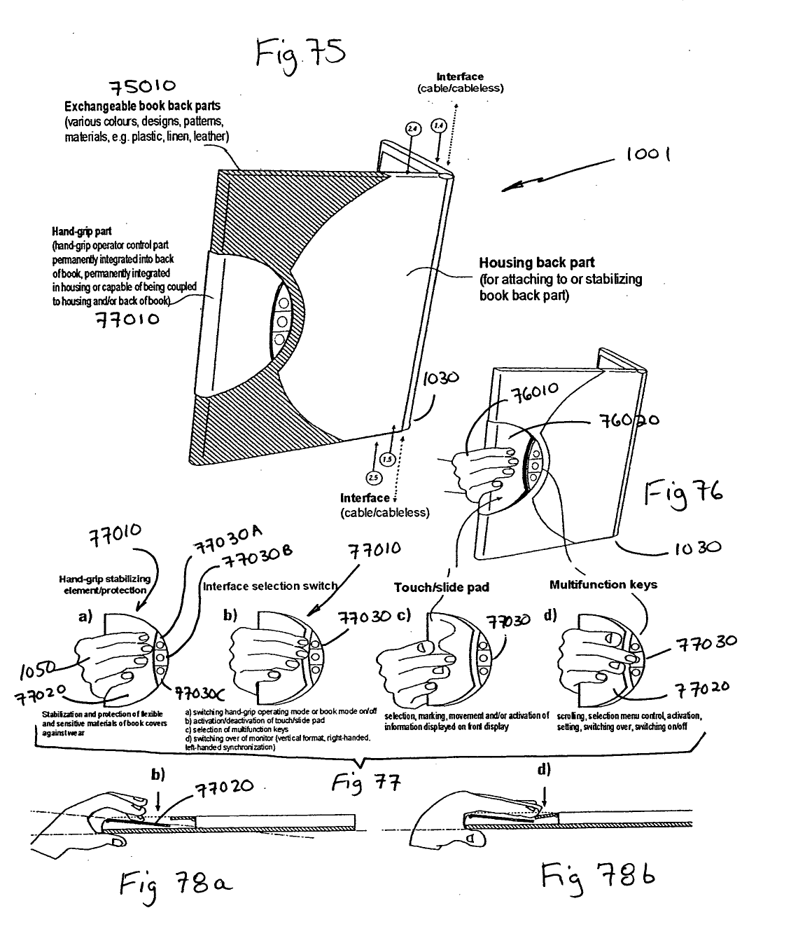

FIG. 74 shows a schematic view of three operator controls which are arranged on the back of the mobile device according to the invention, and their assigned functionalities.

FIG. 75 shows a perspective back view of a two-leaf digital mobile device according to the invention with a different embodiment of the holding-hand operating means.

FIG. 76 shows a perspective back view with an operator's hand arranged in the region within reach of the operator's holding hand on a digital mobile device according to the invention from FIG. 75 when an interface selection switch is pressed.

FIG. 77 shows various operating modes of the hand-grip part from FIG. 75 with the following functionalities: FIG. 77a: hand-grip stabilization/protection; FIG. 77b: interface selection switch; FIG. 77c: touch pad/slide pad; FIG. 77d: multifunction keys.

FIG. 78 is a schematic view of two different operating modes of the hand-grip part from FIG. 75.

FIG. 79A shows a single-leaf digital mobile device according to the invention with a hand-grip part.

FIG. 79B shows a two-leaf digital mobile device according to the invention with a hand-grip part.

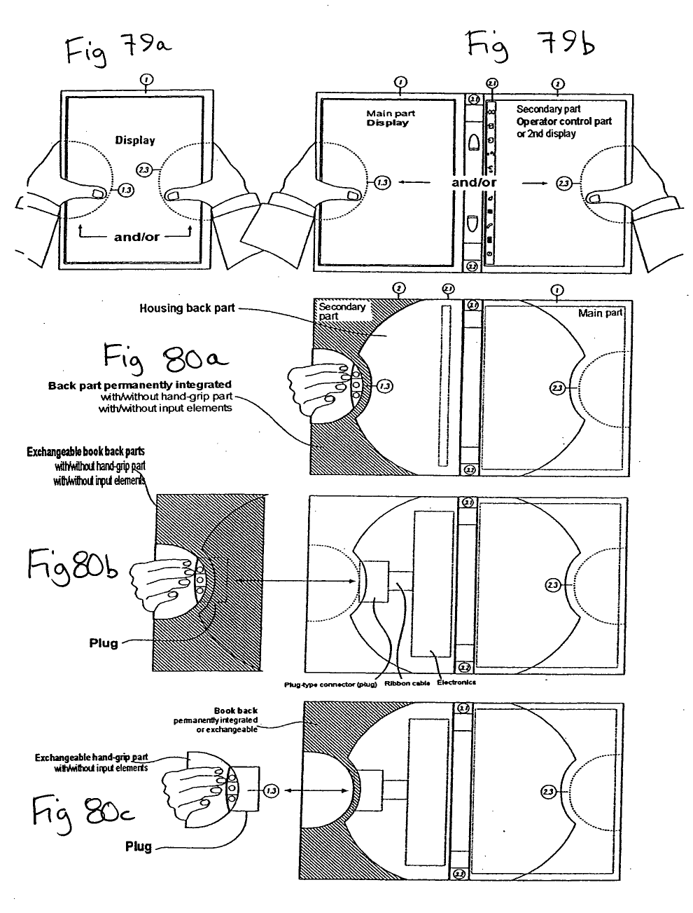

FIG. 80A shows a two-leaf digital mobile part according to the invention with a permanently integrated device back part.

FIG. 80B shows the view from FIG. 80A but with an exchangeable device back part.

FIG. 80C shows the arrangement from FIG. 80A but with an exchangeable hand-grip part.

FIG. 81 is a schematic view of a synchronization device for screen and operator control unit after left-handed/right-handed presetting.

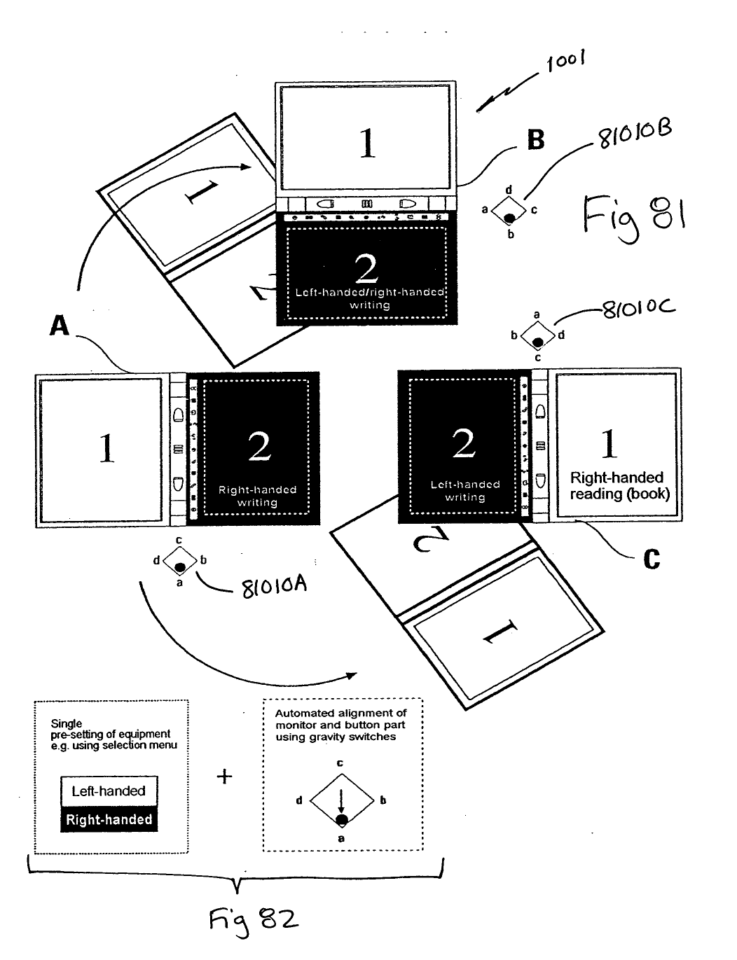

FIG. 82 is a schematic view of components of the synchronization mechanism from FIG. 81.

FIG. 83 is a schematic view of a first embodiment of a gravity switch on a digital mobile device according to FIG. 81 for automatic synchronization or setting of the display device and of the operator controls.

FIG. 84 shows the gravity switch from FIG. 83 at various angles of inclination.

FIG. 85 is a schematic view of an automatic setting according to FIG. 84 for right-handed people as a function of whether an application is selected in which it is necessary to make inputs or in which reading in the manner of a book is to be performed.

FIG. 86 shows details of the operation illustrated in FIG. 85.

FIG. 87 shows a third embodiment of a gravity switch for a digital mobile device according to FIG. 81.

FIG. 88 shows a cross-sectional view of a two-leaf digital mobile device according to the invention with a gravity switch according to FIG. 87.

FIG. 89 shows the gravity switch from FIG. 87 at various angles of inclination.

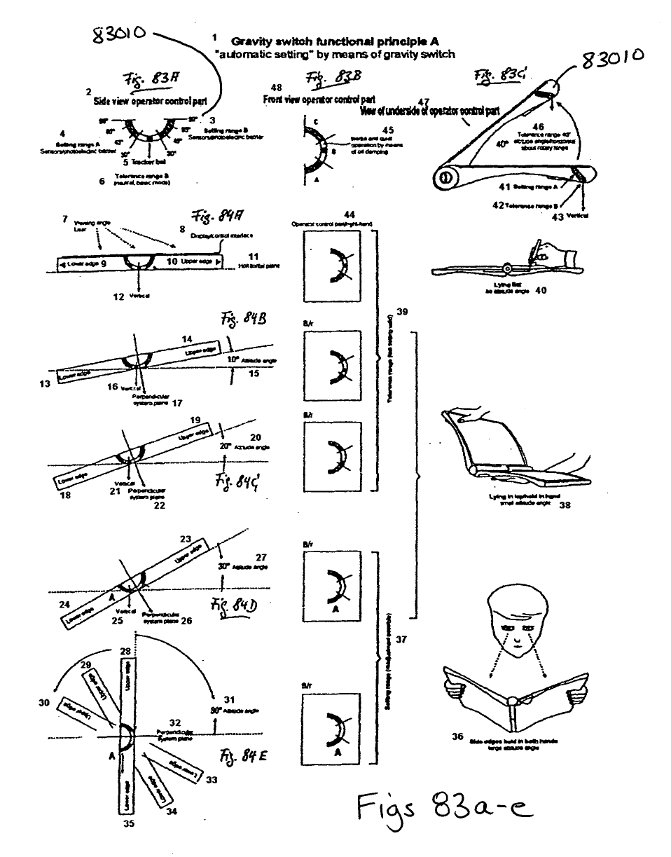

FIG. 90 shows a semi-automatic setting operation for a two-leaf digital mobile device according to the invention for a right-handed presetting with a gravity switch according to FIG. 87.

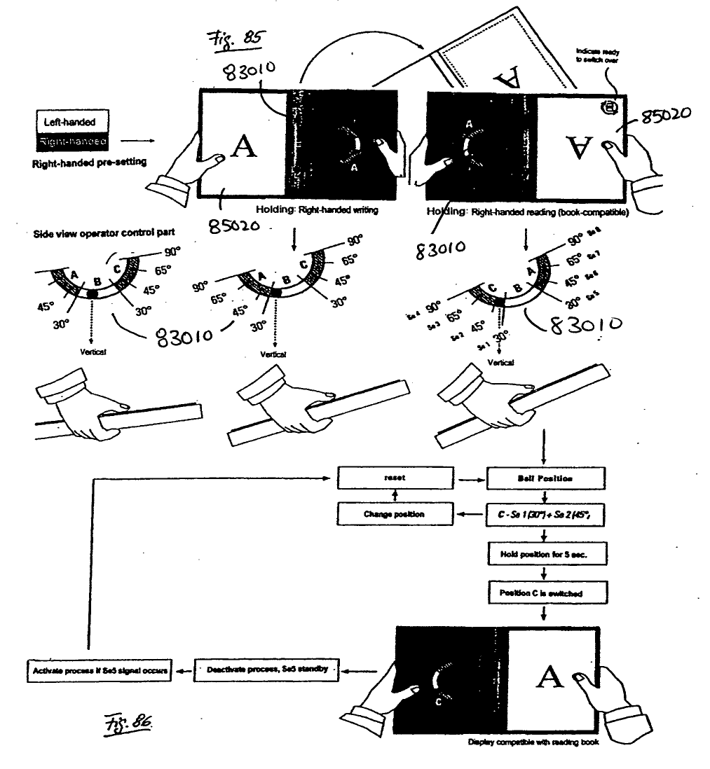

FIG. 91 shows a schematic cross-sectional view of a gravity switch according to a fourth embodiment with a mechanical transmission of the switching force via a tracker ball.

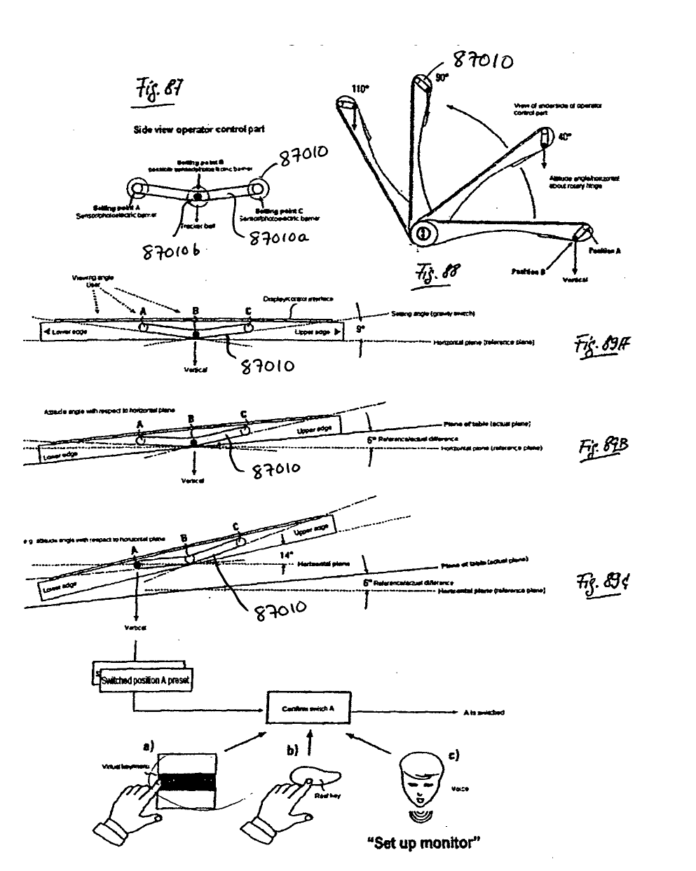

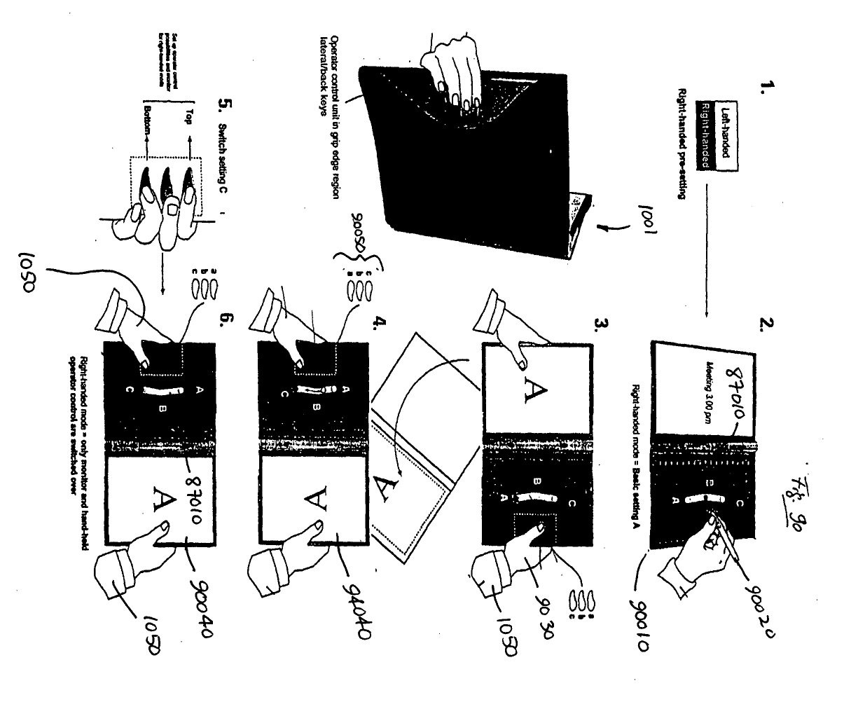

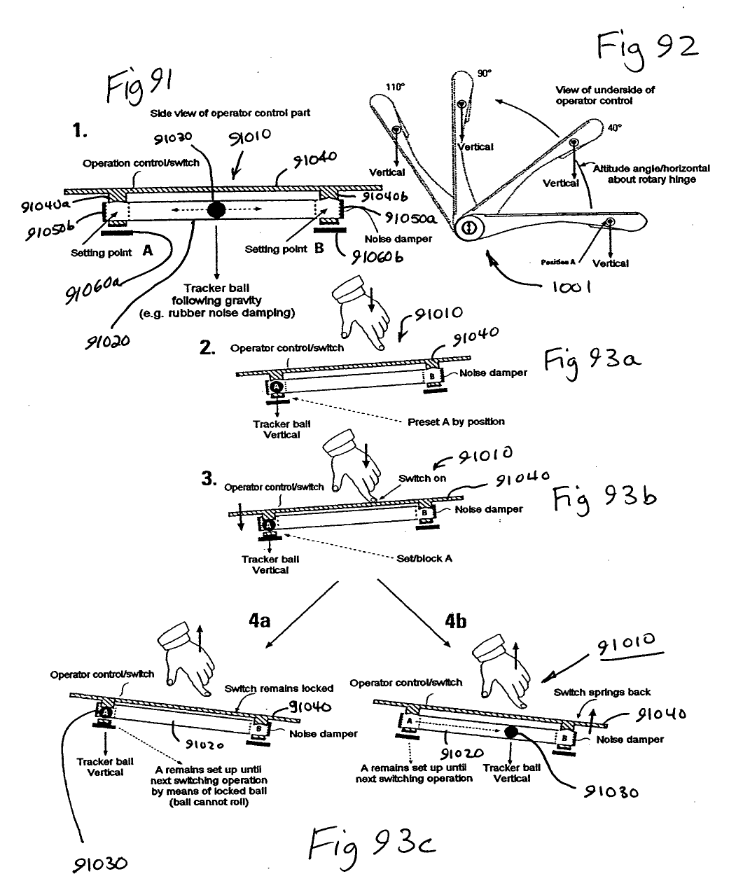

FIG. 92 shows a two-leaf digital mobile device according to the invention with a gravity switch from FIG. 91.

FIG. 93 shows a gravity switch according to FIG. 91 in various operating states.

FIG. 94 shows a mechanical setting operation of a two-leaf digital mobile device according to the invention with a gravity switch according to FIG. 91.

FIG. 95 -blank-

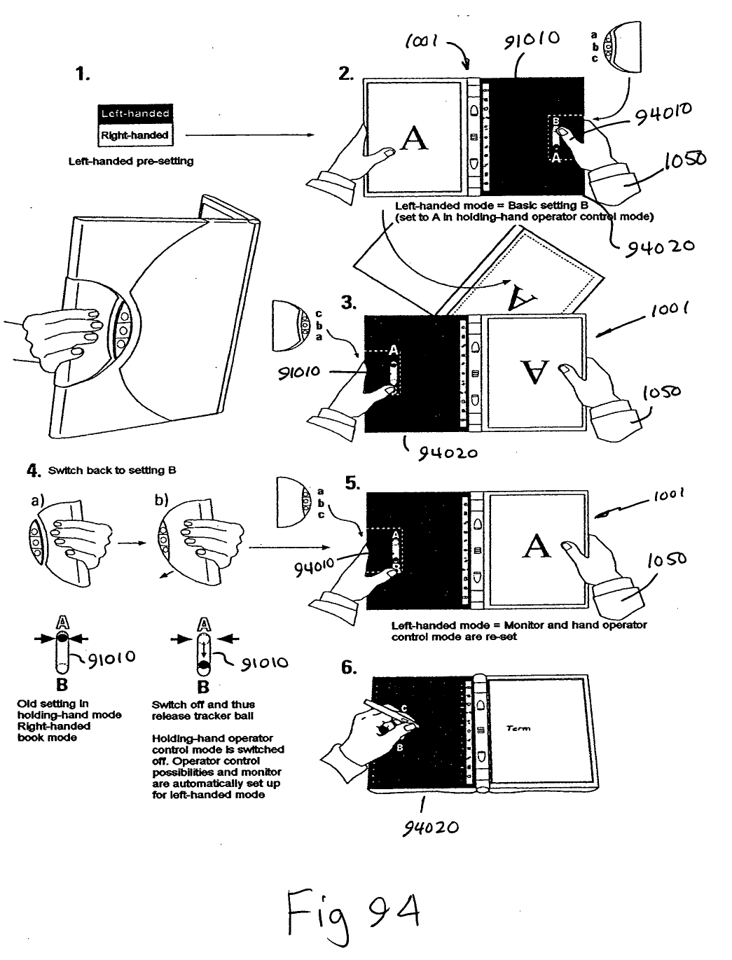

FIG. 96 -blank-

FIG. 97 -blank-

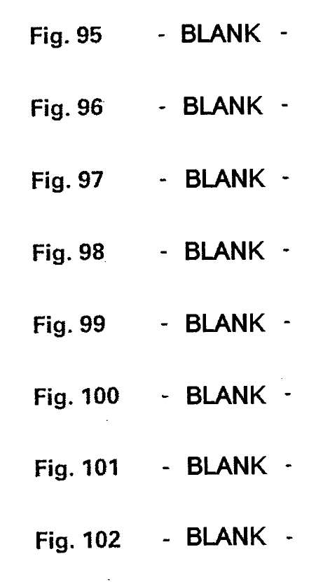

FIG. 98 -blank-

FIG. 99 -blank-

FIG. 100 -blank-

FIG. 101 -blank-

FIG. 102 -blank-

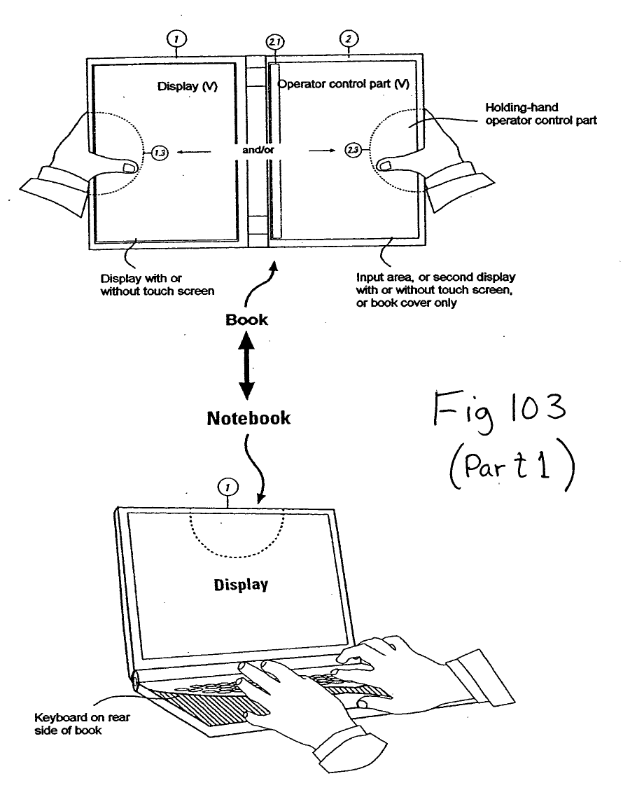

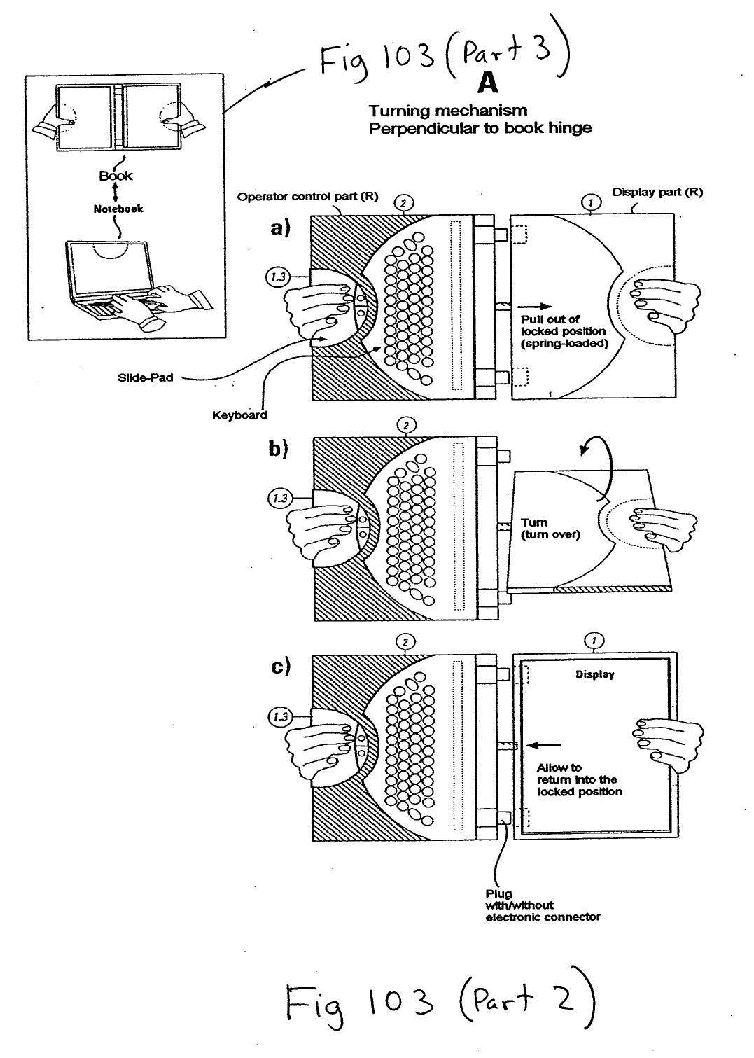

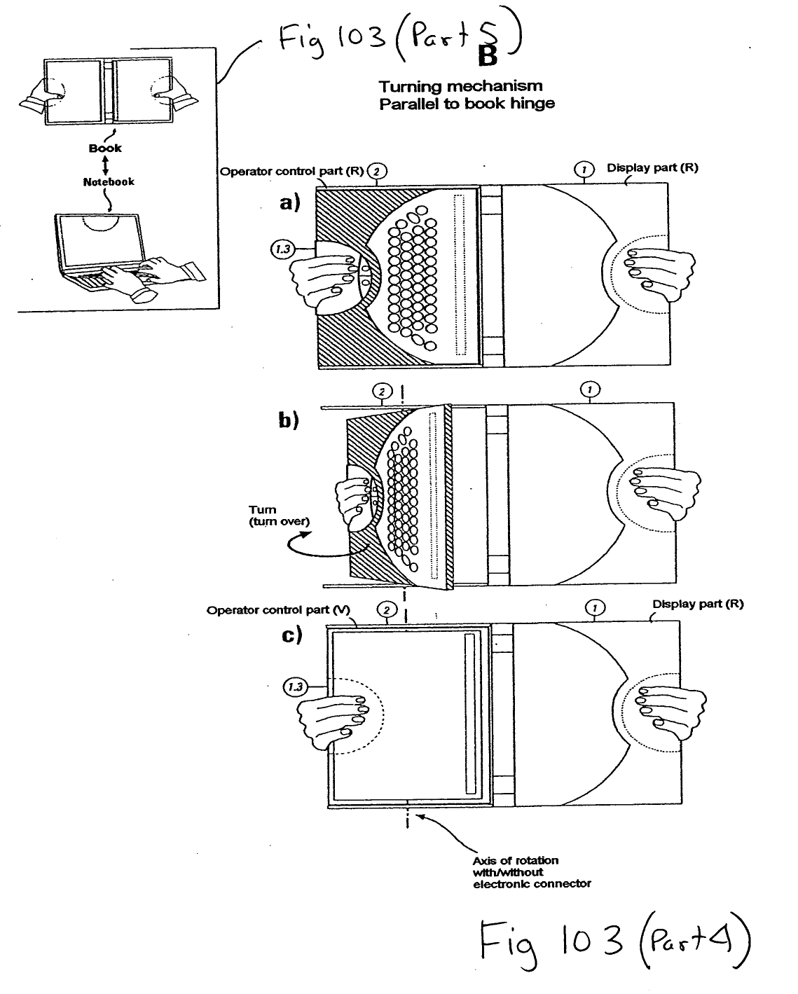

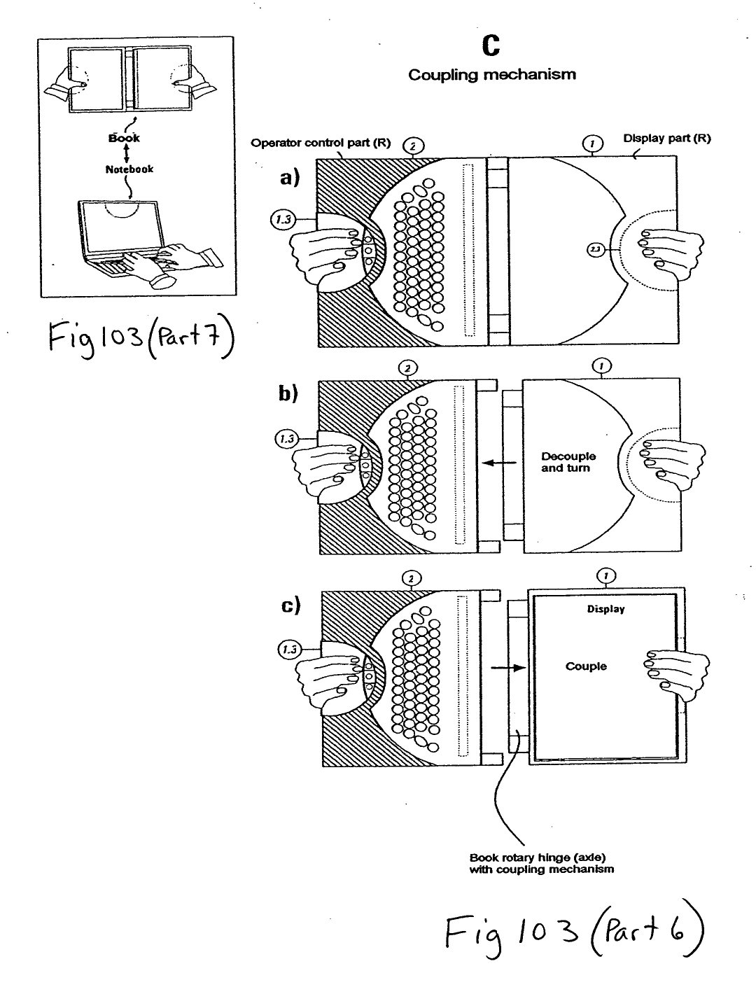

FIG. 103 shows a schematic view of a two-leaf embodiment of a digital mobile device according to the invention with a turning mechanism for a functional part.

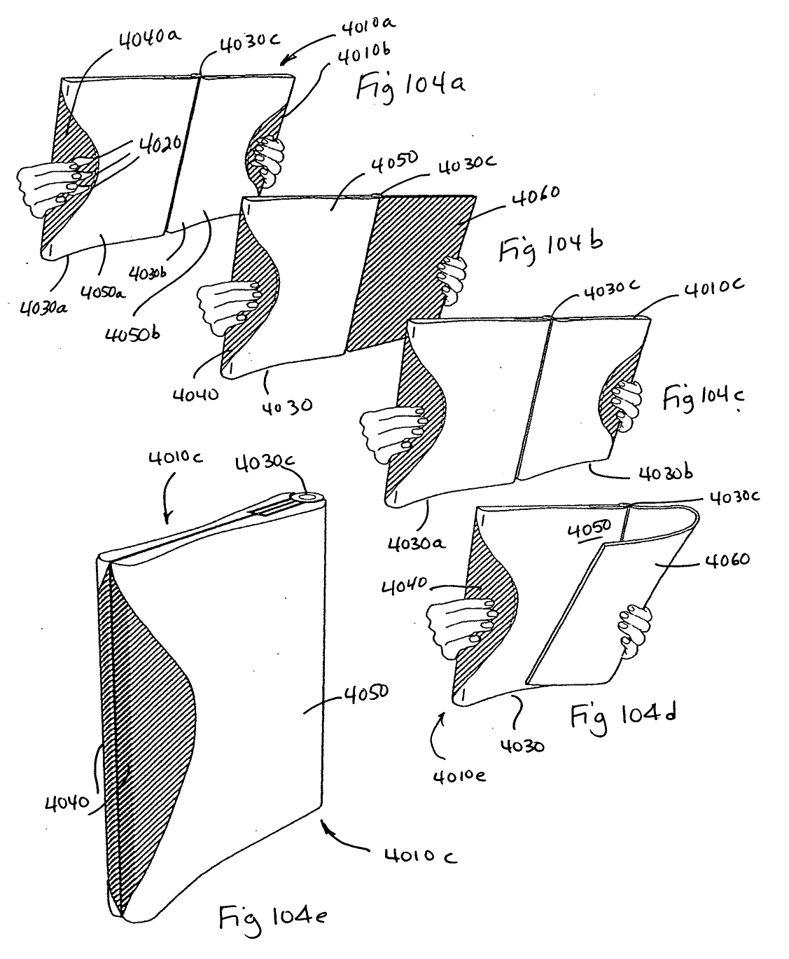

FIG. 104 shows, in the partial FIGS. 104a to 104e, the back view and external view of the housing of different variants of digital hand-held parts according to the invention.

FIG. 105 shows a schematic cross-sectional view through a housing from FIG. 104c.

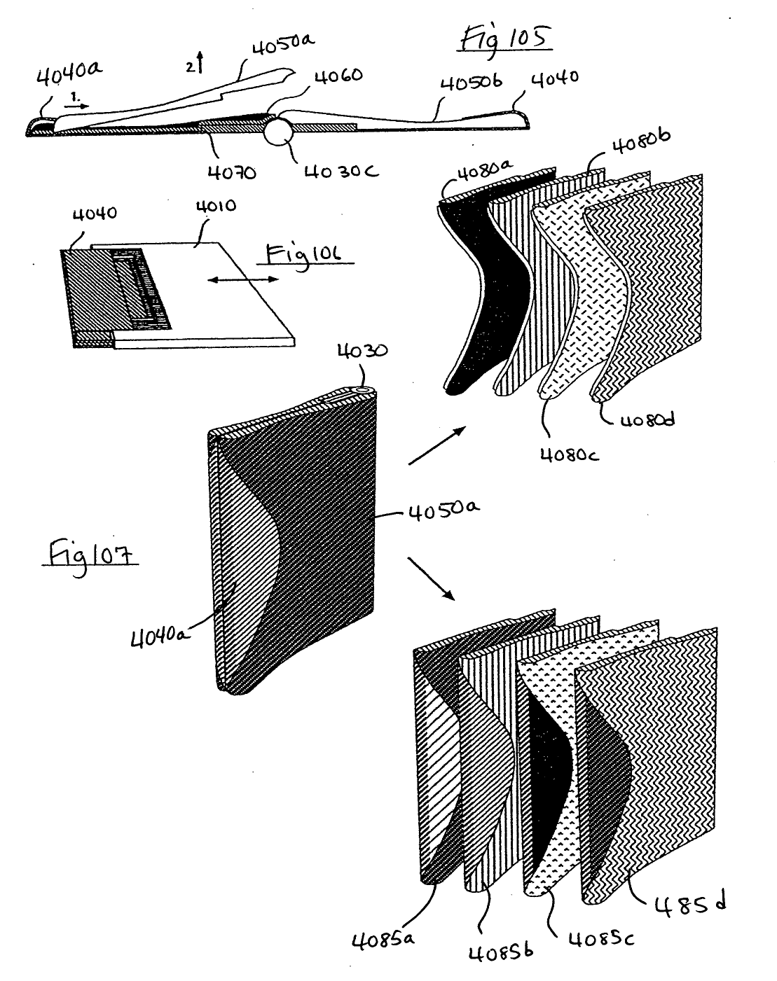

FIG. 106 shows a schematic view of a back part of a housing.

FIG. 107 shows a schematic view of exchangeable components of a modular back part of a housing.

FIG. 108 shows, in the partial FIGS. 108a to 108c, rear views of further variants of housings of digital hand-held parts according to the invention.

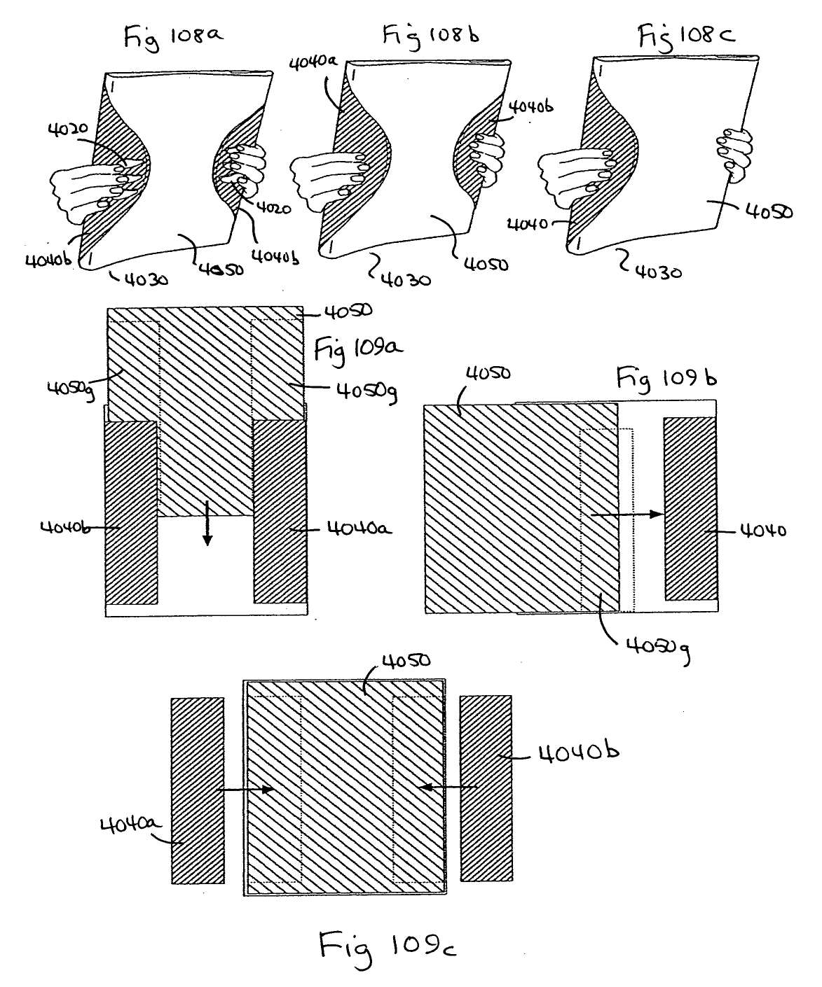

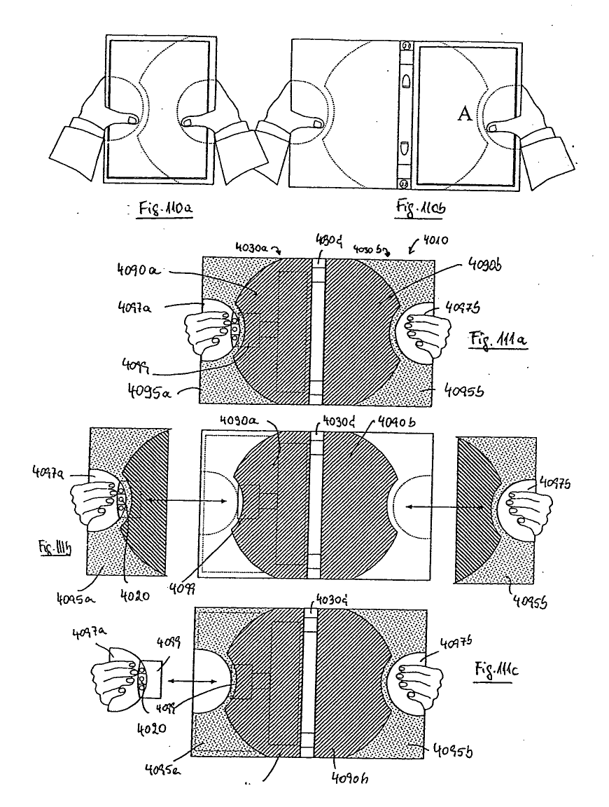

FIG. 109 is a schematic view of the process of exchanging specific back parts on modular housing backs.

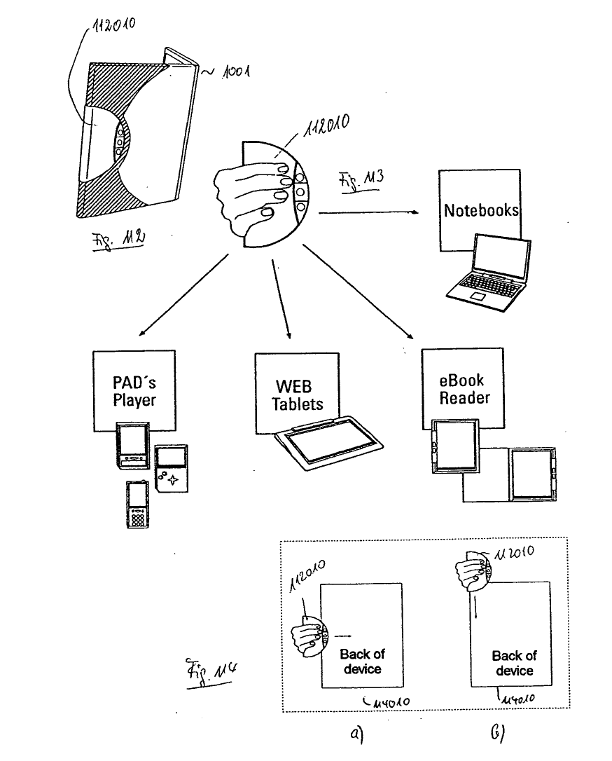

FIG. 110 shows, in the partial FIGS. 110a and 110b, schematic views of different function zones of a modular housing of a single-leaf or two-leaf digital hand-held part according to the invention.

FIG. 111 shows, in the partial FIGS. 111a to 111c, different aspects of a modular housing of a digital hand-held part according to the invention.

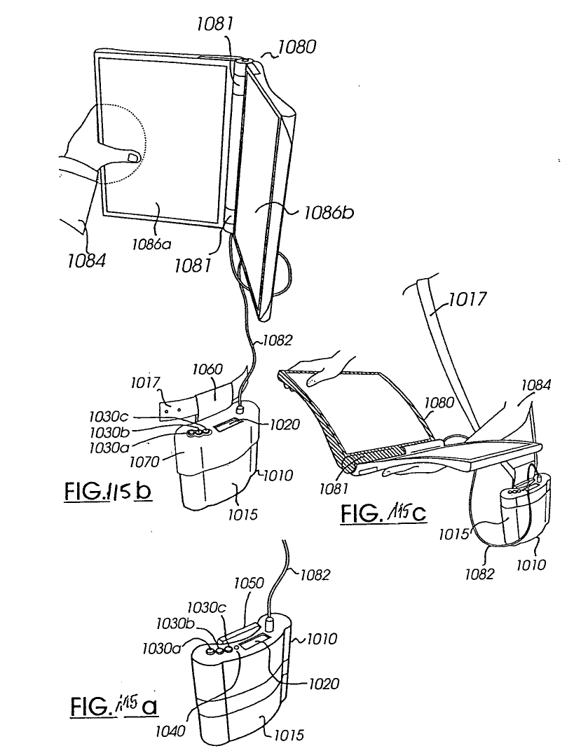

FIG. 112 shows an illustration of a mobile device according to the invention.

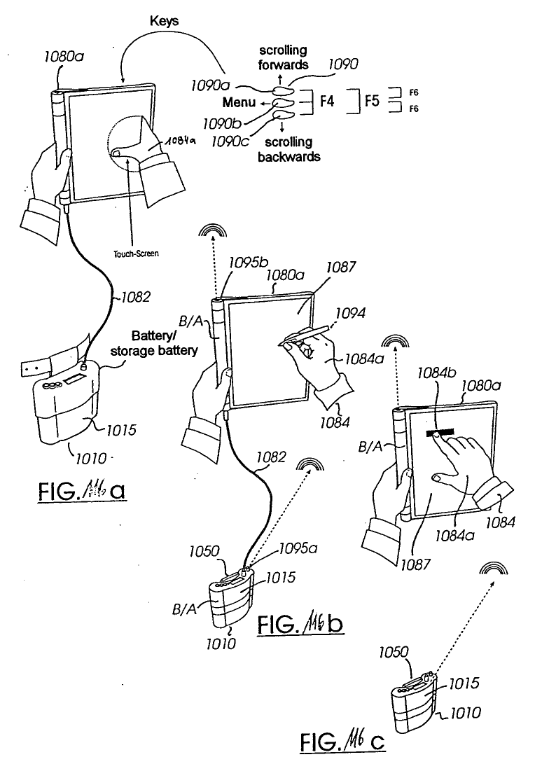

FIG. 113 shows an illustration of a modular hand-grip part.

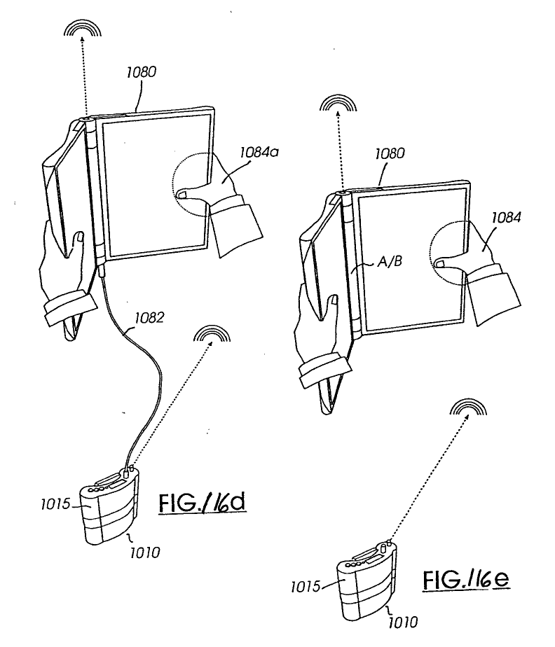

FIG. 114 shows the modular hand-grip part from FIG. 113 when it is fitted into the rear of a piece of equipment.

FIG. 115 shows, in the partial FIGS. 115a to 115c, a data processing device according to the invention with a wearable computer.

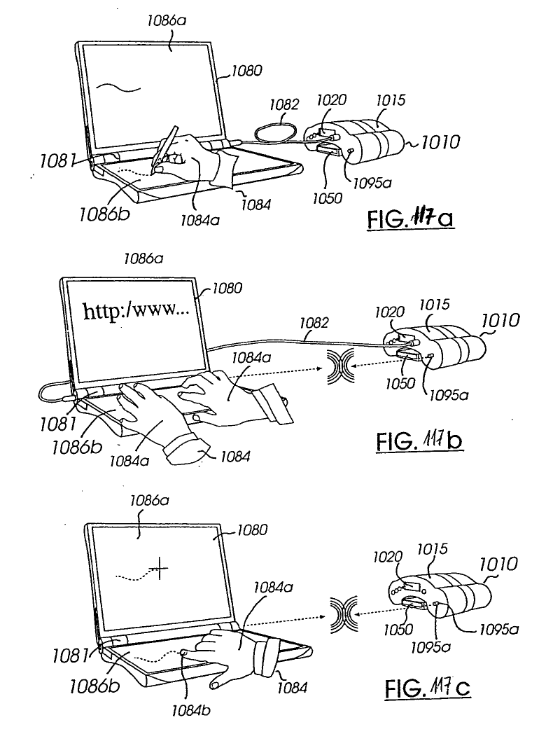

FIG. 116 shows, in the partial FIGS. 116a to 116c, variants of the data processing device illustrated in FIG. 115.

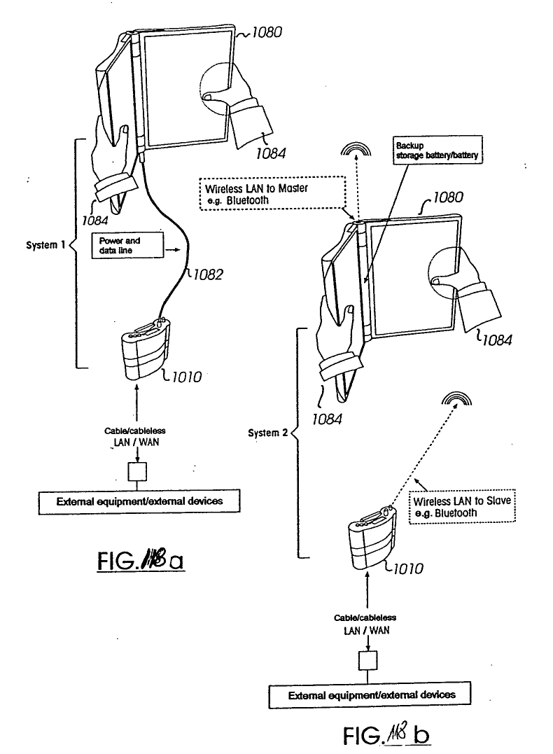

FIG. 117 shows, in the partial FIGS. 117a to 117c, a further variant of a data processing device according to the invention.

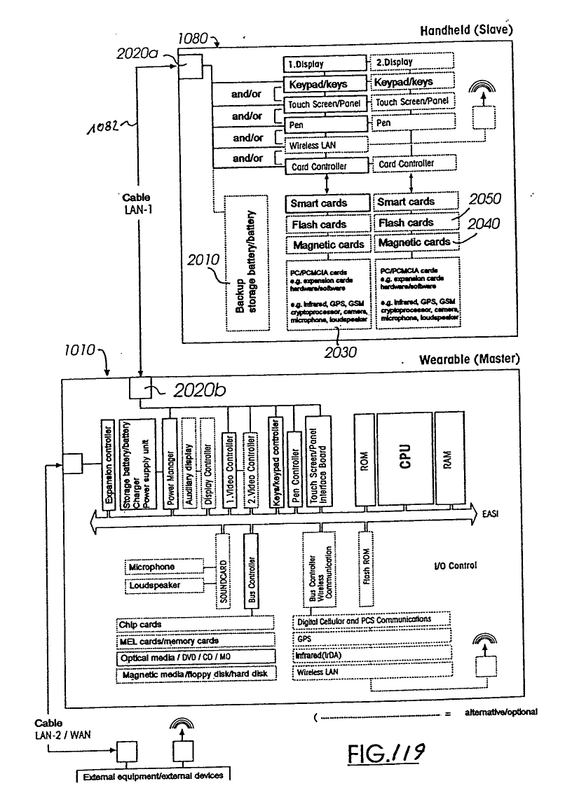

FIG. 118 shows a view of a first variant of a data processing system according to the invention with a wearable computer and a hand-held part which are connected to one another via a cable (FIG. 118a) or in a wire-free fashion (FIG. 118b).

FIG. 119 shows a highly schematic block circuit diagram of the first variant of a data processing system according to the invention which is illustrated in FIG. 118.

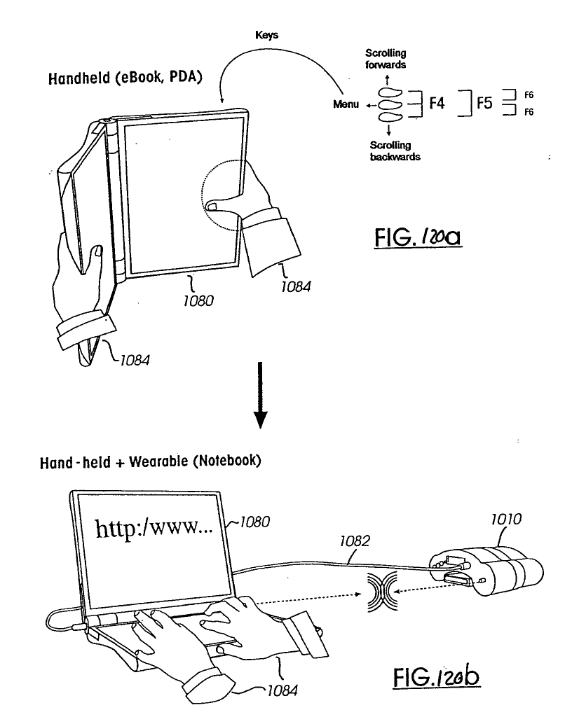

FIG. 120 shows a view of a second variant of a data processing system according to the invention with a wearable computer and a hand-held part, the hand-held part also being capable of being used independently (FIG. 120a) or being connected to a wearable computer (FIG. 120b) in a wire-free fashion and/or by means of a cable.

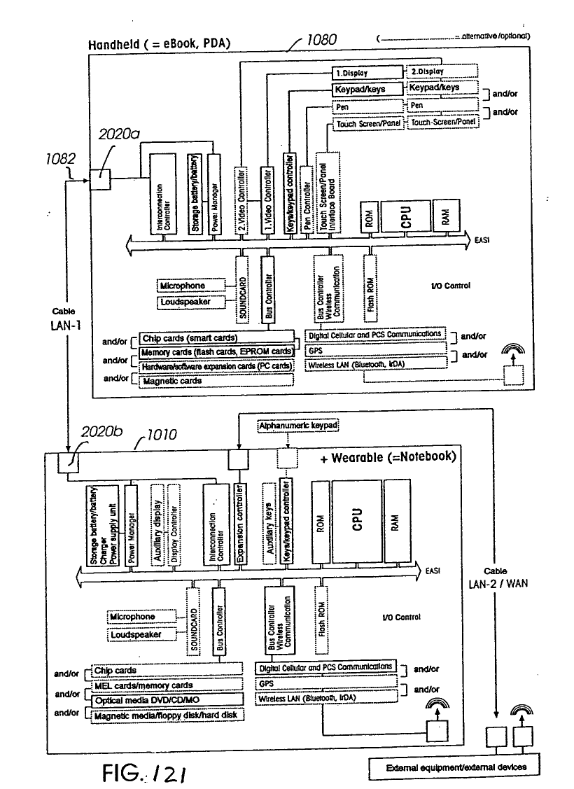

FIG. 121 shows a highly schematic block circuit diagram of the second variant of a data processing system according to the invention which is illustrated in FIG. 119.

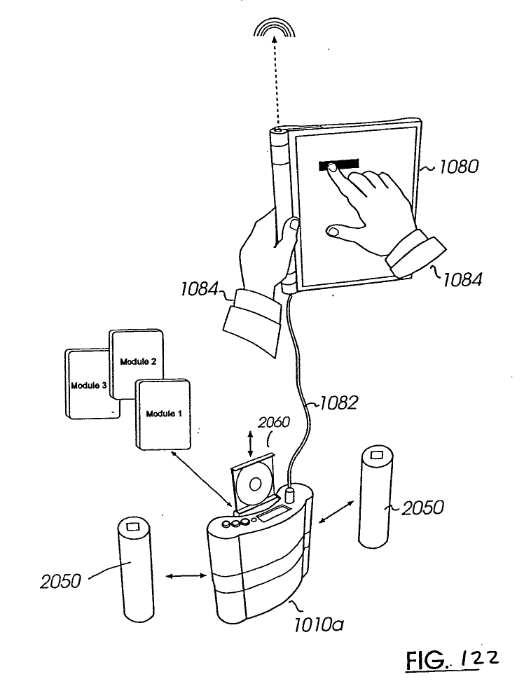

FIG. 122 shows a view of a third variant of a data processing system according to the invention with a wearable expansion device and a hand-held part, the hand-held part being also capable of being used alone.

FIG. 123 shows a highly schematic block circuit diagram of the third variant of a data processing system according to the invention which is illustrated in FIG. 122.

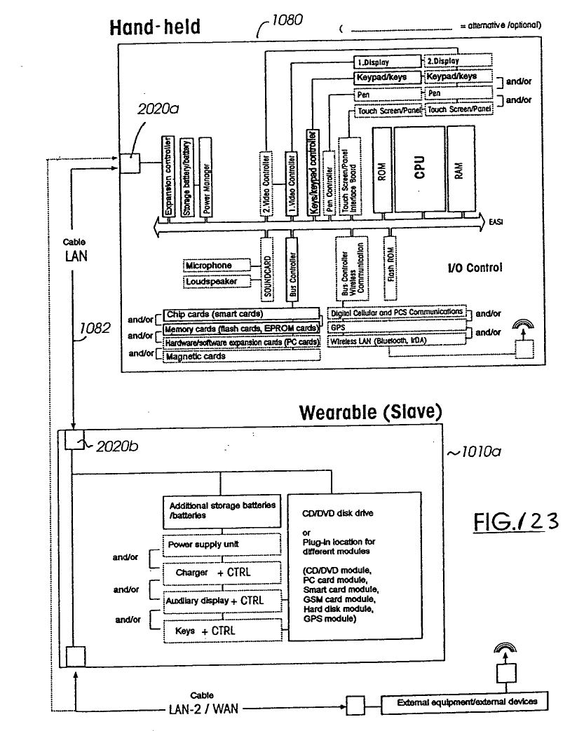

FIG. 124 shows a perspective view of a digital mobile device according to the invention with a display part and operating part and a separate attachment.

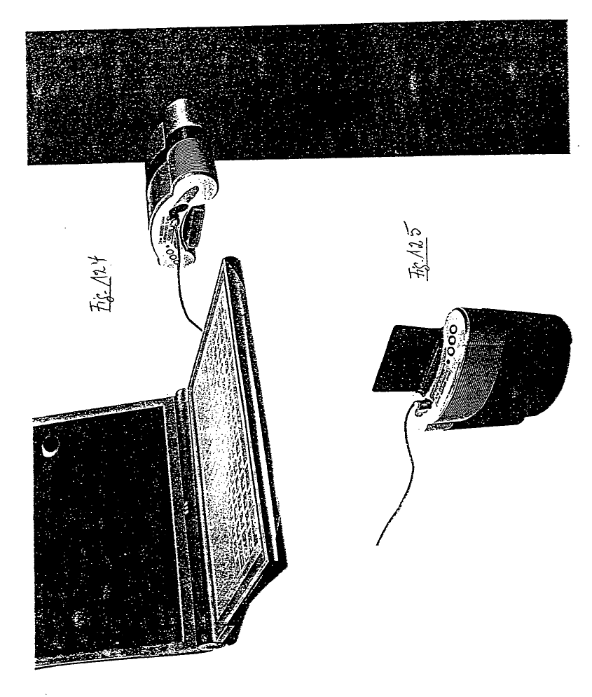

FIG. 125 shows a perspective view of the attachment from FIG. 95 with a carrying bag and belt loop for use as a “wearable” device.

FIG. 126 shows a perspective view of the attachment and of the operator control part and display part from FIG. 95.

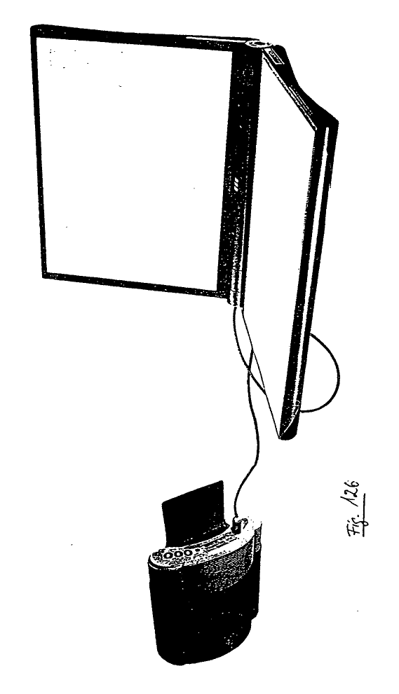

FIG. 127 shows a digital mobile device in a different embodiment as a wearable computer 127010 which can be used in particular as a multimedia player.

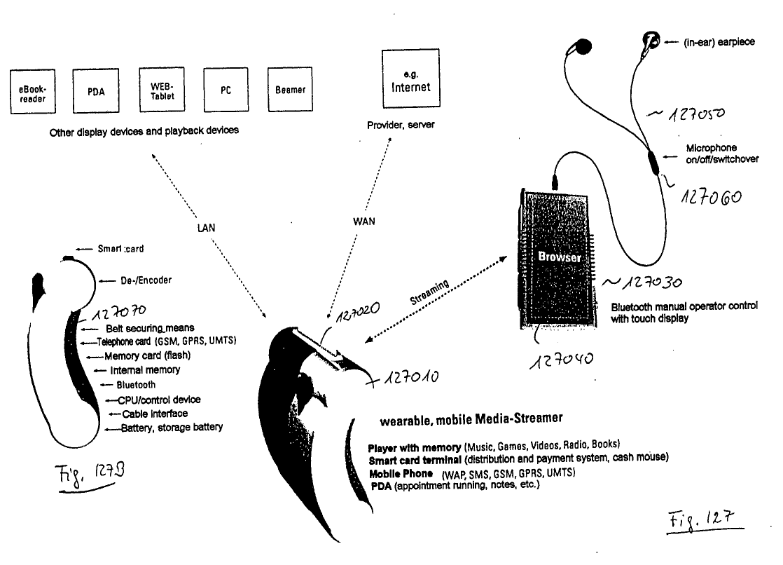

FIG. 128 shows the display and operator control unit from FIG. 127.

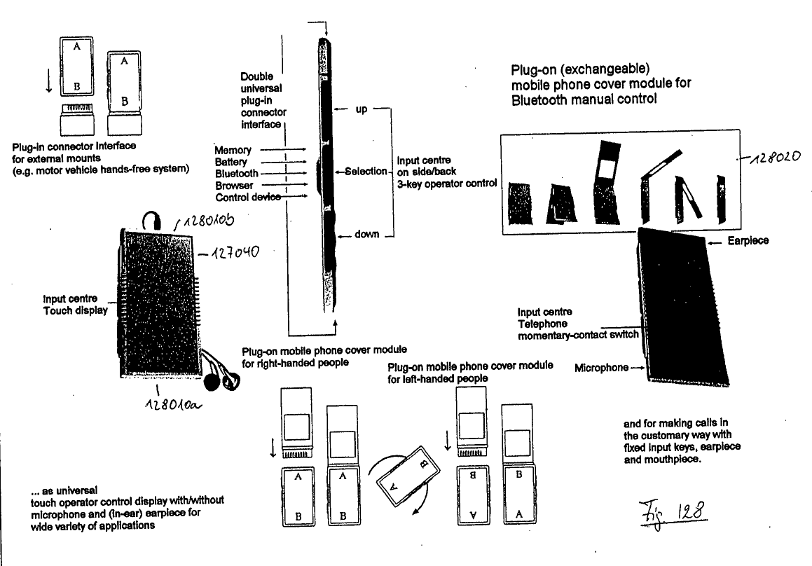

FIG. 129 shows the possibility of using the display and operator control unit from FIG. 127 for different devices and applications.

FIG. 130 shows a schematic perspective view of a detachable two-leaf mobile device according to the invention with a coupling mechanism in the hinge and a coupling lock which is to be inserted, using the example of a storage battery.

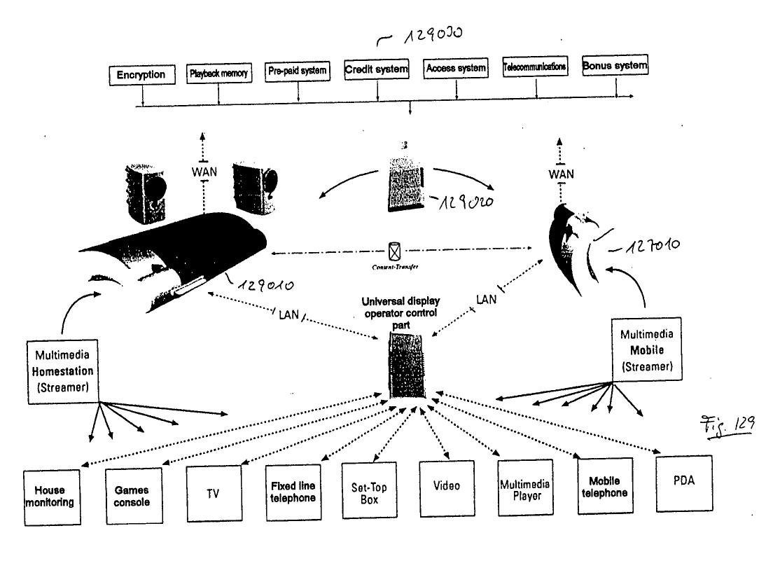

FIG. 135 TBD

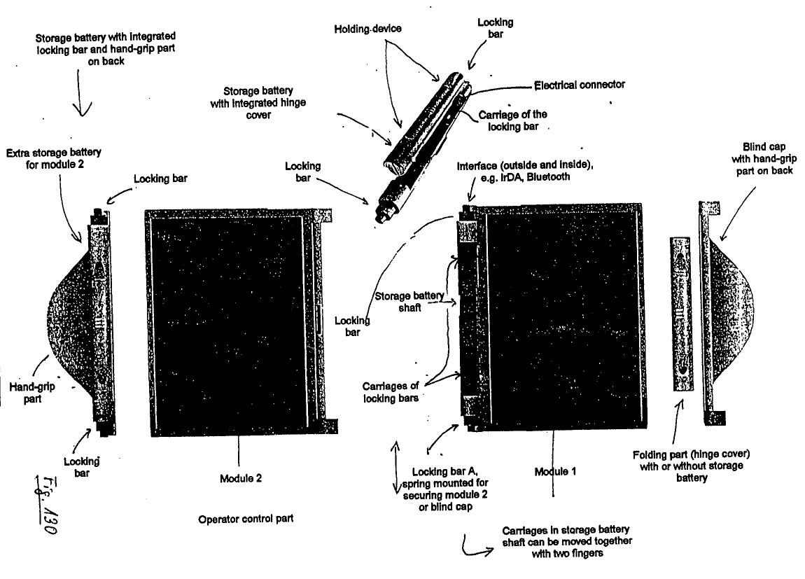

FIG. 136 TBD

FIG. 137 TBD

FIG. 1 shows a schematic perspective view of a digital mobile device 1001 according to the invention in three different use situations. The digital mobile device 1001 comprises a first leaf part 1010 which is embodied as a main display part, a second leaf part 1020 which is embodied as a main operator control part and a hinge part 1030 which connects the first leaf part 1010 and the second leaf part 1020 so that it can pivot in the manner of a book. A region 1040 which is provided with one or more operator controls, and is referred to below as “interface selection bar” is preferably located in the main operator control part 1020. The operator controls can be embodied, for example, as pushbutton keys.

Outside the interface selection bar 1040, the main operator control part 1020 is provided with a location-sensitive and pressure-sensitive sensor device (not illustrated), i.e. the sensor device is capable of detecting pressure forces applied on the surface of the main operator control part 1020, for example with tips 1050 of fingers or by means of a pressure pen 1060.

FIG. 1A shows the inputting of a pointer position for a pointer symbol 1070 (illustrated on the main display part 1010) via movement of a tip of a finger on the touch-sensitive surface of the main operator control part 1010 in the manner of a “slide pad”.

FIG. 1B shows the inputting of characters by activating pressure-sensitive key regions 1080 on the main operator control part 1020 which are each assigned to individual keys and thus form a keyboard. In one preferred embodiment, the main operator control part 1020 has an active or passive display functionality (not illustrated) which can be used, for example, for displaying the characters respectively assigned to the key regions 1080.

FIG. 1C shows the inputting of written characters using a pressure pen 1060 on the pressure-sensitive surface of the main operator control part 1020.

The digital mobile device according to the invention contains a digital processor (not illustrated) with a central processor unit which can be, for example, of the INTEL Pentium type, with sufficient working and mass storage and with all the necessary peripheral modules. The software which runs on this system controls in particular the illustrated, outwardly apparent behaviour of the digital mobile device according to the invention.

FIG. 2 shows the interface selection bar 1040, provided in the digital mobile device 1001 according to the invention from FIG. 1, with operator controls 2010a to 2010d. The operator controls 2010a to 2010d can be embodied in particular as pushbutton keys, for example. It is also possible to use capacitively operating contactless proximity switches. In one preferred embodiment, the individual operator controls 2010a to 2010d are provided with a visual display, for example by means of a light-emitting diode (not illustrated).

FIG. 3 shows a plan view of an inventive digital mobile device 1001 according to FIG. 1 in the folded-open state. The digital mobile device 1001 comprises a first leaf part 1010 which is embodied as a main display part, a second leaf part 1020 which is embodied as a main operator control part, and a hinge part 1030 which connects the first leaf part 1010 and the second leaf part 1020 so that they can pivot in the manner of a book. In the main operator control part 1020 there is preferably a region 1040 which is provided with one or more operator controls 1040a to 1040k and which is referred to below as “interface selection bar”. The operator controls 1040a to 1040k may be embodied, for example, as pushbutton keys. Outside the interface selection bar 1040, the main operator control part 1020 is provided with a location-sensitive, pressure-sensitive sensor device (not illustrated), i.e. the sensor device is capable of detecting pressure forces which are applied on the surface of the main operator control part 1020 using, for example, the fingertips 1050 or a pressure pen 1060. The main operator control part 1020 also has a display (not illustrated) for displaying operator interfaces, i.e. individual regions (not illustrated) of the surface of the main operator control part 1020 can be marked visually by means of the display, for example in the manner of the labelling of a keyboard (not illustrated) or in some other expedient way relating to the functionality which is to be expected when they are actuated. One possible way of technically implementing the display function is to use a touch-sensitive screen (touch screen).

The function of the operator controls 1040b to 1040e and 1040g to 1040j is to be able to activate various operator interfaces B1 to B8 on the main operator control part 120 when they are activated by the user. On the main operator control part 1020 it is possible to see icons A1 to A9 which symbolize various applications which can be activated as a function of the respectively selected operator interface B1 to B8. Fixed functionalities are assigned to the operator controls 1040a, 1040f and 1040k. The operator controls 1040a, 1040f and 1040k constitute multifunction keys which serve to manipulate information displayed on the main display part 1010.

FIG. 4 shows a plan view of an inventive digital mobile device 1001 according to FIG. 1 in the folded-open state with an application A6 running. The operator interface B3 (not represented in more detail in the drawing) is activated on the main operator control part 1020. The main display part 1010 shows, in particular, icons F1 to F10, E and D for the operator control functions which are available to the user (not illustrated) in this application A6.

FIG. 5 shows a first variant of the inventive digital mobile device 1001 (shown in FIG. 1) in the folded-open state, specifically an inventive digital mobile device with a main display part 1010 without an input possibility, and a main operator control part 1020 to be operated by the user 1050. The user 1050 activates the operator control B1 and as a result sets up on the main operator control part 1020 a specific operator interface (not shown in more detail on the drawing) which is assigned to B1. In the example illustrated, the main operator control part 1020 functions as a slide pad. The user 1050 slides the fingertip of a finger of his hand over the surface of the main operator control part 1020. Under the control of the software (not illustrated in more detail) running in the processor (not illustrated) of the mobile device 1001, the reaction of the mobile device to this slide pad input is displayed to the user 1050 on the main display part 1010 by, for example, a specific icon A6 displayed on the main display part 1010 being displayed in an inverted form, said icon A6 being arranged, in relation to the entire surface of the main display part 1010, at a point which corresponds to the location where the finger of the user 1050 applies pressure relative to the entire surface of the main operator control part.

FIG. 6 shows a second variant of the inventive digital mobile device 1001 shown in FIG. 1 in the folded-open state, specifically an inventive digital mobile device with a main display part 1010 with an input possibility provided, for example, by means of a touch-sensitive screen (touch screen) and a main operator control part 1020. The user 1050 sets up a predetermined operator interface (not shown in more detail on the drawing) by activating the operator control B1. The selection of the functionality which is assigned to the icon A6 displayed on the main display part 1010 can be made directly here by the finger of the user 1050 touching the touch screen in the region of the displayed icon A6.

FIG. 7 shows an inventive digital mobile device according to FIG. 5 or FIG. 6 in which the main display part 1010 and the operator control part 1020 are mechanically separated, for example by configuring the hinge 1030 so that it can be decoupled. Such a separation enables the digital mobile device to be improved ergonomically. The main operator control part 1020 and the main display part 1010 are connected to one another electrically in a suitable way so that electrical signals can be transmitted back and forth between the two parts. This can be carried out, on the one hand, in a wire-bound fashion by means of an electric lead (not illustrated). On the other hand, wire-free methods such as infrared data transmission, for example by means of IrDA, or radio data transmission, for example by means of Bluetooth, can be used (neither of which is illustrated).

FIG. 8 shows, in the partial FIGS. 8A to 8E, a functional example of the use of operator controls which are contained in the interface selection bar 1040 according to FIG. 3 as multifunction keys in the basic mode.

In FIG. 8A, depending on the position of the operator controls 1040a, 1040f and 1040k on the main operator control part 1020, the main operator control part 1010 displays information such as “Open Finder”, “Switch on device” or “General operating help”. It proves advantageous always to assign specific basic functions to the operator controls 1040a, 1040f and 1040k in the illustrated way as the user 1050 can then easily remember this. If the operator control 1040a is activated repeatedly by the user 1050, firstly a list of the favourite applications A1 to A6 is displayed. If the operator control 1040a is activated by the user 1050 once more, a list of various setting and configuration options B1 to B8 is then displayed. If the operator control 1040a is activated by the user 1050 once more, a list with the documents D33, D21, D67, D9, D15, D18, D21 last modified is then displayed. If the operator control 1040a is activated by the user 1050 once more, the list of the favourite applications A1 to A6 is then finally displayed again. The icons shown in FIG. 8 are to be understood as being only symbolically representative; in practice, shapes which are graphically more meaningful may be used.

By subsequently activating the operator control 1040f as illustrated in FIG. 8B, a series of icons, which each represent a text document modified in the past with a text-processing application, are displayed on the main display part 1010 in the way described above in the illustrated exemplary embodiment.

By subsequently activating the operator control 1040k illustrated in FIG. 8C, icons which each represent a text document modified in the past with a text-processing application are displayed, as already represented in FIG. 8B. In the situation illustrated in FIG. 8C, all the documents, not just the documents last modified, are displayed.

FIG. 8d shows how a specific menu entry of a selection menu displayed on the main display part 1010 is marked with a finger of a hand of the user 1050 by activating the operator interface, actuated as a slide pad, of the main operator control part 1020.

FIG. 8e shows how a specific icon D26, representing a document, of a number of icons D25 to D41 displayed on the main display part 1010 is marked with a finger of a hand of the user 1050 by activating the operator interface, actuated as a slide pad, of the main operator control part 1020.

FIG. 9 shows a schematic representation of the functional arrangement of the multifunction key in the basic mode. By activating the actuation element 1040a of the interface selection bar 1040, it is possible to activate a selection mode and deactivate it again (Finder). In this exemplary embodiment, when the operator control 1040a is activated a series of icons A1 to A3, which each symbolize a favourite application, appear on the main display part 1010. Activating the operator control 1040a once more causes a series of icons B1 to B8, which each symbolize a parameter setting option, to appear on the main display part 1010. Activating the operator control 1040a once more then causes a series of icons D33, D21, D67, D9, D15, D18 and D21, which each symbolize a document from a list of documents recently modified, to appear on the main display part 1010. If the operator control 1040f is activated in this state, all the documents are displayed on the main display part 1010 by means of corresponding icons. If, on the other hand, the operator control 1040a is activated in this state, the Finder is minimized and does not appear on the main display part 1010. When all the documents are displayed, it is possible, by activating the operator control 1040k, to sort the display of the documents according to different applications. By scrolling by continued activation of the operator control 1040a, it is possible to identify and mark a specific document using the corresponding icon, which is displayed, for example, by reverse video or outlining. The selection which has thus been made can be activated by activating the operator control 1040f, i.e. the selected document is opened with the application assigned to it and can be modified.

FIG. 10 shows a functional example of operator controls as multifunction keys and setting keys, contained in the interface selection bar shown in FIG. 3, in the setting mode. Here, the sequence illustrated in FIG. 10 corresponds basically to that illustrated in FIG. 8. However, whereas the emphasis in FIG. 8 is on the selection of a document by the user and the application is determined by the document selected, FIG. 10 concentrates on the selection of an application F1 to F4 and E and D.

FIG. 11 shows a schematic representation of the functional arrangement of the multifunction keys in the application mode corresponding to the sequences in FIG. 10. Initial activation of the operator control 1040 out of the basic state by the user 1050 causes a number of icons to appear on the main display part 1010, each of said icons symbolizing the current application A7 from the set of applications available on the mobile device 1001, and the functional setting options F1, F2, F3 and F4 of said applications as well as the documents E and D last modified with this application. As a result of the operator control 1040 being activated once more by the user 1050, a number of icons, which each symbolize applications A1 to A9 available on the mobile device 1001, are made to appear on the main display part 1010. Here, it is in particular also possible to indicate that individual applications A6, A9 are active in the background in the standby mode.

FIG. 12 shows the principle of the selection of an application A1, A2, A3, A4, A5, A6, A7, A8, A9 or of a document D1, D2, . . . D24 by setting up the operator interface of the main operator control part 1020. In this exemplary embodiment, the main display part 1010 is embodied as a touch-sensitive touch screen.

The partial FIGS. 1a, 1b and 1c of FIG. 12 show, by way of example, a sequence which is based on a device state of the mobile device 1001 in which icons symbolizing the available applications A1 to A9 have already been made to appear on the main display part 1010. Activating the operator control B3 causes a specific, assigned operator interface of the main operator control part 1020 to be activated. In the partial FIG. 1b, only those applications A3, A4, A7 which can be operated with the operator interface B3 are then displayed on the main display part by means of their respective icons. By virtue of the user 1050 touching the main display part with a finger of a hand at the point at which the icon corresponding to the application A7 is made to appear, the application A7 is activated. The partial FIG. 1c illustrates how the application A7 with the operator interface B3 is available after the activation of A7 in partial FIG. 1b.

The partial FIGS. 2a, 2b and 2c of FIG. 12 show, by way of example, a sequence which is based on a device state of the mobile device 1001, in which icons symbolizing the available applications A1 to A9 have not yet been made to appear on the main display part 1010. Partial FIG. 2b illustrates how those applications which are compatible with the operator interface B8 are symbolized by icons after the operator control B8 has been activated on the main display part.

The partial FIGS. 3a, 3b and 3c of FIG. 12 show, by way of example, a sequence which is based on a device state of the mobile device 1001, in which icons symbolizing the available documents D1 . . . D25 are made to appear on the main display part 1010. Partial FIG. 3b illustrates how that document D2 whose assigned application A6 is compatible with the operator interface B8 is symbolized by an icon after the operator control B2 has been activated on the main display part.

FIG. 13 shows in a schematic view the principle of selecting an operator interface by activating an application A1, A2, A3, A4, A5, A6, A7, A8, A9 or a document D1, D2, . . . D24.

The partial FIGS. 1a, 1b and 1c of FIG. 13 show, by way of example, a sequence which is based on a device state of the mobile device 1001 in which icons symbolizing the available applications A1 to A9 have already been made to appear on the main display part 1010. The application A4 is activated by activating the touch screen at the location of the icon corresponding to this application. In the partial FIG. 1b, an operator interface is selected by activating the operator control 1040. Here, any operator interfaces which can in fact be used are preferably highlighted visually, for example by means of background lighting using LEDs.

The partial FIGS. 2a, 2b and 2c of FIG. 13 show, by way of example, a sequence which is based on a device state of the mobile device 1001 in which icons symbolizing the available applications A1 to A9 have not yet been made to appear on the main display part 1010. The partial FIG. 2b illustrates how the available applications A1 to A9 are symbolized by icons after the operator control 1040 on the main display part has been activated. The application A1 is activated, in partial FIG. 2b, by activating the touch screen at the location of the icon corresponding to this application.

The partial FIGS. 3a, 3b and 3c of FIG. 13 show, by way of example, a sequence which is based on a device state of the mobile device 1001 in which icons symbolizing the available documents D1 . . . D24 have been made to appear on the main display part 1010. Activating the touch screen at the location of the icon corresponding to the document D2 causes the application A6 assigned to this document to be activated. The partial FIG. 3b illustrates how the document D2 is opened and ready for editing on the main display part after the application A6 has been activated.

FIG. 14 shows a perspective view of a digital mobile device 1001 according to the invention of a modular design with a hand-grip part 14010 arranged on the gripping edge. The digital mobile device 1001 according to the invention has, in particular, exchangeable book back parts 4010a, 4010b.

FIG. 15 shows a perspective view of a book back part 4010 without a hand-grip part and without a housing part.

FIG. 16 shows the mechanical interplay between a hand-grip part and a book back part. In particular, FIG. 16 shows a schematic view of a housing back part 4010 with a removable grip region 4040. The grip region 4040 is formed by an essentially U-shaped part which can be pushed onto the edge region (in the direction of the arrow) and also pulled off again.

FIG. 17 shows a cross-sectional view through the inventive digital mobile device 1001 which is illustrated in FIG. 14 and has a modular design. FIG. 17 shows in particular a schematic plan view of the lower edge or upper edge of an exemplary embodiment, which provides an exchangeable compressible cover region 4050a, 4050b. Here, the grip region 4040a, 4040b is embodied essentially integrated with the front part of the housing, whereas the cover region 4050a, 4050b is embodied in the form of separate, removable cover shells. These cover shells 4050a, 4050b are secured under the grip region 4040a, 4040b by clamping and can be easily removed and replaced by the user by means of a sideways movement (1.) and subsequent upward movement (2.). The cover shells 4050a, 4050b are preferably provided on their upper side and lower side with a projecting spring which engages in a corresponding groove in the housing and provides protection against the ingress of dirt and moisture. The electronics 4060 are protected, for example by means of a sealing compound or by means of some other protective coating (not illustrated), to such an extent that they are not damaged even when the cover shell is replaced properly.

FIG. 18 shows a two-leaf digital mobile device 1001 according to the invention with a main display part 1010 and a main operator control part 1020, embodied as a touch pad, of equal size, as a book cover, in the folded-open state. The main display part 1010 and the main operator control part 1020 are connected to one another by means of a hinge 1030 so as to be capable of folding open and shut in the manner of a book. The hinge 1030 can have interfaces, for example plug-type connectors, for electrical signals or for the purposes of supplying power, at one end or both ends. The hinge 1030 can also have devices for wire-free data communication, for example for radio transmission (for example Bluetooth) or infrared transmission (for example IrDA). That region of the hinge 1030 which lies facing the user at the top when the mobile device 1001 is folded open can preferably be provided with an operational display 20010.

FIG. 19 shows a perspective view of the lower edge of the inventive mobile device 1001 illustrated in FIG. 18, with a plug-in device 19010, arranged in the end piece of the hinge 1030, for example for a universal serial bus, fire wire or the like and/or for external devices and equipment such as a charge station, portable computer, printer, card station or street terminal.

FIG. 20 shows a schematic detailed view of an exemplary operational display 20010 of a digital mobile device 1001 according to the invention from FIG. 18. This operational display is composed of three LEDs 20010a, 20010b, 20010c or of comparable display means. The upper LED 20010a indicates activity at external electrical interfaces of the mobile device 1001 by lighting up or flashing. The central LED 20010b indicates activity of the central processor unit (control processor, not illustrated) of the mobile device 1001 by lighting up or flashing. The lower LED 20010c indicates activity at external electrical interfaces of the mobile device 1001 by lighting up or flashing.

FIG. 21 shows a cross-sectional view of the digital mobile device 1001 according to the invention from FIG. 18 in a flexible embodiment, for example with a polymer screen. In order to produce haptics which are pleasant for the user and which are based on those which he is accustomed to from paper media, it is possible to provide a predetermined bending point 21010 at which the housing can be bent easily and resiliently in parallel with a line which is parallel with the hinge 1030, owing to the mechanical flexibility of the housing. For this purpose, the electrical devices in the interior of the housing (not illustrated) are embodied so as to be flexible, using known technologies, in particular using flexible conductor track films. A display technology which can be executed in a way which provides mechanical flexibility, for example in the form of a polymer film screen, is used as the display device.

FIG. 22 shows a perspective view of a two-leaf digital mobile device 1001 according to the invention with a paper clip 2210 which is integrated in the side edge of the operator control part in the folded-open state. Here, the main operator control part 1020 of the mobile device 1001 is provided with a touch-sensitive surface, i.e. the mechanical pressure applied to the surface of the main operator control part 1020 can be sensed and evaluated by the central processor unit (not illustrated). When the mobile device is equipped in such a way, it proves particularly advantageous to provide the paper clip 22010 with which a sheet of paper (not illustrated) can be secured to the mobile device 1001. If the user (not illustrated) uses a normal writing pen to write on the sheet of paper secured to the mobile device 1001, the pressure paths of the mobile device can be sensed and stored with or without recognition of written characters. In particular, written characters may optionally be displayed with or without OCR conversion on the main display part 1010.

FIG. 23 shows a schematic view of the function of the paper clip 22010 in the digital mobile device from FIG. 22. A strip of metal 22015 which can fold upwards in the longitudinal direction with respect to the hinge 1030 is held down in a sprung fashion on the surface of the main operator control part 1020 in the vicinity of the hinge. The piece of paper is secured between the strip of metal 22015 and the main operator control part 1020.

FIG. 24 is a schematic, cross-sectional view of the digital mobile device 1001 from FIG. 22 with a paper clip 22010 in a different embodiment and with the sheet of paper 22020 clipped in position. In this exemplary embodiment, an angled piece of metal 24010 is provided which has two right-angled limbs 24010a, 24010b. The first limb 24010a points downwards and is drawn in a sprung fashion into a corresponding recess of the main operator control part 1020. The second limb 24010b is oriented parallel to the surface of the main operator control part 1020 and is used to clip the sheet of paper 22020 securely in position.

FIG. 25 shows a functional arrangement of the operator controls provided in the interface selection bar, with setting momentary-contact switches for setting up the input area from FIG. 22, and with multifunction keys for manipulating information on the display.

FIG. 26 shows a perspective view of a two-leaf digital mobile device 1001 according to the invention with a Help display 26010, integrated in the side edge of the main operator control part 1020, for variable function symbols. The integrated Help display 26010 has a touch-sensitive surface with a linear row of operator control points which are marked by means of icons which can be actuated in a variable way by the central processor unit (not illustrated) which controls the mobile device 1001, said row of operator control points being oriented parallel to the axis of the hinge 1030, having the purpose of performing operator control actions of the user and being equipped, in one preferred embodiment, with background lighting (not illustrated) which makes the individual operator control points easy to see for the user. In the simplest case, the Help display has, as a background, a film keypad (not illustrated) composed of operator control points which are arranged linearly one on top of the other and can be operated by the user by means of finger pressure. Known techniques of touch screen technology are particularly preferred for implementing the Help display 26010.

FIG. 27A shows a schematic view of the method of operation of operator controls provided in the interface selection bar 1040 in an inventive digital mobile device 1001 according to FIG. 26 with a set-up for right-handed people. In particular, it proves advantageous for right-handed people if, given book-like use of the mobile device 1001, the main display part 1010 comes to rest on the left and the main operator control part 1020 with the interface selection bar 1040 comes to rest on the right.

FIG. 27B shows the arrangement from FIG. 27A with a set-up for left-handed people after the display unit has been turned (upside down). In a way which is consistent with this, as a result of the turning, the main display part 1010 comes to rest on the right and the main operator control part 1020 with the interface selection bar 1040 on the left. However, if the labelling, in particular of the interface selection bar 1040, were merely printed on, the icons which would be visible on it would be upside down from the user's point of view and could only be identified with difficulty. In contrast, configuring the interface selection bar 1040 with the Help display 26010 illustrated in FIG. 26 makes it possible to distinguish between a right-handed operating mode and a left-handed operating mode under the control of the software running on the central processor unit (not illustrated) of the mobile device 1001. In the right-handed operating mode, the icons represented on the interface selection bar 1040 are upright from the user's point of view if the main display part 1010 comes to rest on the left and the main operator control part 1020 with the interface selection bar 1040 comes to rest on the right. In the left-handed operating mode, the icons represented on the interface selection bar 1040 are upright from the user's point of view if the main display part 1010 comes to rest on the right and the main operator control part 1020 with the interface selection bar 1040 comes to rest on the left. When the operating mode is changed, the icons are “turned upside down”.

FIG. 28 is a schematic view of the changing assignment of the visually displayed operator control points (operator controls) of the interface selection bar 1040 implemented by means of the Help display 26010 represented in FIG. 26, when there are successive activations of the changeover function as a result of activation of the operator control 1040a. In particular, it is possible to implement navigation concepts in which different actuation options of the main operator control part 1020 are symbolized by means of individual icons (2.1). It is also possible to implement navigation concepts in which different applications which can run on the mobile device are symbolized by means of individual icons (2.2). It is also possible to implement navigation concepts in which different documents are symbolized by means of individual icons (2.3).

FIG. 29 shows a perspective view of a two-leaf digital mobile device 1001 according to the invention with a functional symbol display in the main display part 1010 and operator control possibility in the operator control part 1020 or in the main display part 1010 in the folded-open state.

FIG. 30A is a schematic view of the method of operation of operator controls provided in the interface selection bar 1040, in a digital mobile device according to the invention in accordance with FIG. 29 with a setting for right-handed people.

FIG. 30B shows the arrangement from FIG. 29A with a setting for left-handed people after the display unit has been turned (upside down). FIG. 31 is a schematic view of the changing assignment of the operator controls of the interface selection bar 1040 given successive activations of the changeover function by means of the operator control 1040a.

Overall, the representations in FIGS. 29 to 31 correspond to those in FIGS. 26 to 28. However, with respect to the solution shown in FIGS. 26 to 28, FIGS. 26 to 28 show an alternative in which a way of implementing the interface selection bar 1040 which is separate in terms of design technology is dispensed with. Instead, touch-sensitive display areas, embodied in the manner of a touch screen, both of the main display part 1010 and of the main operator control part 1020 assume the function of simulating a variable interface selection bar in an elongated region parallel to and near to the longitudinal axis of the hinge 1030, suitable software configuration similarly permitting a distinction to be made between a right-handed operating mode and a left-handed operating mode.

FIG. 32 shows a schematic view of an exemplary type of design of the input area 1020a of the main operator control part 1020.

In this exemplary embodiment, the input area 1020a of the main operator control part 1020 is divided into a number of subregions 1020a1 to [lacuna]

In particular the following are to be distinguished:

a first subregion 1020a1 which is arranged, for example, top left with labels in the vertical format and which is used as a pocket calculator keypad;

a second subregion 1020a2 which is arranged, for example, bottom left with labels in the transverse format and which is used as a telecommunication keypad; and

a third subregion 1020a3 which extends, for example, over the entire height on the right and is provided with labels in the transverse format.

In addition, marking zones 1021a4 can be seen, which delimit a fourth subregion 1020a4 which extends approximately centrally in the transverse direction over the width of the main operator control part 1020 and overlaps here with the first, second and third subregions 1020a1, 1020a2, 1020a3.

FIG. 32A is a schematic view of a labelling film which is provided with suitable background lighting and is fitted with keypad-like labelling. The colouring of the labelling film and the labelling are matched to one another in such a way that when the background lighting is switched off the labelling is virtually invisible.

FIG. 32B shows a background lighting system 32010 which is arranged underneath the labelling film illustrated in FIG. 32A. The background lighting 32010 can be switched on and off for the individual subregions 1020a1, 1020a2, 1020a3 and 1020a4 independently of one another, under the control of the central processor unit (not illustrated) which controls the mobile device 1001. By virtue of the fact that the background lighting can be activated separately for the individual subregions 1020a1, 1020a2, 1020a3 and 1020a4, it is possible to provide the user with an expedient keypad input possibility with visual highlighting, as a function of the respectively selected application.

FIG. 32C shows a contact sensor system 31020 which is arranged underneath the labelling film and the background lighting system and has an interface selection bar 1040 which covers the entire area of the main operator control part 1020. The contact sensor system 32020 is capable, in a preferred embodiment, of detecting the location both of instances of contact with the fingertip (keypad function) and of instances of contact with a pointed pen (pen function) precisely and signalling it to the central processor unit (not illustrated) which controls the mobile device.

The illustrations in FIG. 32 are only of an exemplary nature. The person skilled in the art is aware of various techniques for implementing pressure-sensitive touch screens. In particular, embodiment variants are possible in which the sequence of the layering of the subsystems varies in comparison with the example shown in FIGS. 32A, 32B and 32C.

FIG. 33A shows various sequence phases when a digital mobile device 1001 according to the invention is switched on. FIG. 33A shows the switch-on process when the operator control 1040f is activated in the interface selection bar 1040.

FIG. 33B shows the digital mobile device 1001 according to the invention in a setting and self-test phase.

FIG. 33C shows the digital mobile device 1001 according to the invention in a subsequent standby state.

FIG. 34 shows a perspective view of a two-leaf digital mobile device 1001 according to the invention in the folded-open state for use of the keyboard in the transverse format. As is apparent from FIG. 34, the background lighting system 32010 is switched on only for the subregion 1020a3. The subregion 1020a2 with the telecommunication keypad is not illuminated. However, this does not mean that the pressure-sensitive device 32020 underneath the subregion 1020a2 is deactivated. In the subregion 1020a2, the pressure-sensitive device 32020 acts simply as a slide pad for positioning processes to be easily carried out by the user without external devices such as a mouse being required for this purpose. However, this does not exclude the possibility of, for example, connecting a mouse externally if the user so wishes.

FIG. 35 is a schematic view of a use of the digital mobile device 1001 according to the invention from FIG. 34 for operating, by means of thumbs, text processing software and a deactivation lock which is to be actuated simultaneously in order to activate the keys. The mobile device preferably comprises a sound output device, for example a loudspeaker (not illustrated). If a keypad function is triggered by means of pressure from a fingertip of the hand of the user 1050 in the subregion 1020a3, it is possible to provide for a reference noise, for example “click!”, “snap!” or the like, to be output in order to give the user audible feedback that the key has been successfully pressed.

In general, it is desirable to keep the pressure necessary to trigger the keypad as low as possible. This is the case in particular because the travel of the key may be very small, or virtually equal to zero, owing to the design of the pressure-sensitive area. It is also conceivable to use a location-sensitive proximity sensor instead of a location-sensitive pressure sensor. This can result in the problem of incorrect triggering of keypad functions, for example due to objects such as paper or the like accidentally coming into contact with the keypad, or due to inadvertent touching.

In one particularly preferred embodiment, it is therefore possible to provide an incorrect operation lock with which, when triggering the keypad functions, the user 1050 must simultaneously and continuously place a thumb 1050a on a specific region within the subregion 1020a3, approximately in the centre of the outer edge of the main operator control part 1020, in order thereby to signal to the mobile device 1001 that an actual keypad entry is being made, and for example incorrect triggering is not occurring.

The mobile device 1001 can be equipped with receptacle devices (not illustrated) for expansion parts. The reference 35010 refers to a plug-in document module memory. The reference 35020 refers to a plug-in system expansion module.

FIG. 36 shows a two-leaf digital mobile device 1001 according to the invention in the folded-open state in a mode for use as a communications device, in particular as a mobile telephone device. As is apparent from FIG. 36, the background lighting system 32010 is switched on only for the subregion 1020a2. The subregion 1020a3 with the typewriter keypad is, like the subregion 1020a1 with the pocket calculator keypad, not illuminated. However, this does not mean that the pressure-sensitive device 32020 underneath this subregion 1020a1 is deactivated; the pressure-sensitive device 32020 simply acts in the subregion 1020a2 as a slide pad for the user to easily carry out positioning processes without requiring external devices such as a mouse for that purpose. However, this does not exclude the possibility of, for example, connecting a mouse externally if the user so wishes.

FIG. 37 is a schematic view of a use of the digital mobile device 1001 which is illustrated in FIG. 36 and has a plug-in mobile telephone module 35020 (expansion module) as a communications device, for example for communication by means of telephony, e-mail or image telephony. The associated telephone card can then be plugged in as a document card 35010. In one preferred embodiment, the mobile telephone module 35020 can also be used separately from the mobile device 1001. The data traffic between the mobile telephone module 35020 and the main device of the mobile device 1001 may be embodied, for example, using a radio link according to the Bluetooth standard.

By means of the telephony keypad in the subregion 1020a2 and the slide pad in the subregion 1020a1 and by using the display of the main display part 1010, the user 1050 can select all the necessary functions such as telephone address book etc. and carry out his communication processes by means of suitable programs which run in the central processor unit (not illustrated) of the mobile device 1001.

If the user wishes to output a text message, for example an SMS message or an e-mail, the keypad can, when necessary, be activated in the subregion 1020a3.

A hands-free device may also optionally be provided in the mobile device 1001 according to the invention.

FIG. 38 shows a perspective view of a two-leaf digital mobile device 1001 according to the invention in the folded-open state in an operating mode as an accessory for various applications for inputting numbers into a marked field or for calculation applications. As is apparent from FIG. 38, the background lighting system 32010 is switched on only for the subregion 1020a1 with the pocket calculator keypad. The subregion 1020a2 with the telephony keypad is, like the subregion 1020a2 with the typewriter keypad, not illuminated. However, this does not mean that the pressure-sensitive device 32020 underneath this subregion 1020a2 is deactivated; the pressure-sensitive device 32020 simply acts in the subregion 1020a2 as a slide pad for the user to easily carry out positioning processes without requiring external devices such as a mouse for that purpose. However, this does not exclude the possibility of, for example, connecting a mouse externally if the user so wishes.

FIG. 39 shows the digital mobile device 1001 according to the invention in FIG. 38 in a schematic view when applied in a computer program running in the central processor unit (not illustrated) of the mobile device 1001.

FIG. 40 shows a perspective view of a two-leaf digital mobile device. 1001 according to the invention with a large touch-sensitive sliding surface (slide pad) for actuating and activating information in the main display part. The background lighting system 32010 is deactivated for all the subregions 1020a1, 1020a2, 1020a3. The entire surface of the main operator control part 1020 functions as a slide pad.

FIG. 41 shows various adaptation alternatives of the digital mobile device 1001 according to the invention illustrated in FIG. 40 in terms of use with a vertical format or transverse format and for use for left-handed and right-handed people.

FIG. 41A shows an application in which the mobile device 1001 is used in the transverse format. FIG. 41B shows an application in which the mobile device 1001 is used in the vertical format for right-handed people.

FIG. 41C shows an application in which the mobile device 1001 is used in the vertical format for left-handed people or in the book mode. In the book mode, the emphasis is on convenient reading on the right-hand leaf of the mobile device. In the book mode, the main input part 1020 is therefore turned over to the left-hand side even for right-handed people.

FIG. 42 shows a perspective view of a two-leaf digital mobile device 1001 according to the invention in the folded-open state and in the vertical format with a pressure-sensitive text detection zone 42010 for inputting text with a pen.

FIG. 43 shows the digital mobile device according to the invention from FIG. 42 with a pressure-sensitive text detection zone 42010 in an exemplary application with an Internet browser, the simultaneous use of the touch-sensitive surface (touch pad) [lacuna] by sliding a tip of a finger for inputting cursor positions etc. In the present example, the user 1050 uses a pressure pen 1051 to write the designation of the desired Internet URL into the text detection zone 42010. The text written by the user 1050 is converted into a character chain (for example in ASCII or UNICODE coding) by a program, running on the central processor unit (not illustrated) of the mobile device 1001, using an OCR (Optical Character Recognition) process.

FIG. 44 shows a setting [lacuna] digital mobile device 1001 according to the invention from FIG. 42, but with a main display part used in the transverse format and a main operator control part.

FIG. 45 is a schematic view of an application, corresponding to FIG. 43, of the digital mobile device 1001 from FIG. 44, but in the transverse format.

FIG. 46 shows a perspective view of a two-leaf digital mobile device 1001 according to the invention in the folded-open state for the registration of the filling-in operation of a paper form 47010.

FIG. 47 is a schematic view of the digital mobile device 1001 according to the invention which is illustrated in FIG. 46 and in which the paper form 47010 is clamped into the main operator control part 1020 by means of the paper clip 22010, and is filled in manually, the form 47010 and the form data with the data entered manually by the user 1050 using a pressure pen 1051 being displayed simultaneously on the main display part 1010. The entire surface of the main operator control part 1020 serves as a pressure-sensitive input area and senses the writing movements of the pressure pen 1051. For the paper form 47010, a previously created electronic form has been loaded into the main display part 1010. The writing on the paper form 47010 by the user is automatically transferred, as line graphics or as text data according to an OCR process, into the electronic form displayed on the main display part 1010, and can be stored on a storage medium (not illustrated) when necessary.

FIG. 48 shows a perspective view of a two-leaf digital mobile device 1001 according to the invention in the folded-open state which is configured for the inputting of free-hand notes and free-hand sketches, optionally with or without paper, using the main operator control part.

FIG. 49 is a schematic view of an application of the digital device according to the invention illustrated in FIG. 48 with the user 1050 inputting a free-hand sketch or free-hand notes using a pressure pen 1051, but without paper. The lines which are sensed by the pressure-sensitive surface of the main display part 1020 are displayed simultaneously on the main display part 1010 and can be stored when necessary on a storage medium (not illustrated).

FIG. 50 shows a perspective view of a two-leaf digital mobile device 1001 according to the invention in a variant with a reversible main operator control part 50010. Here, one leaf of the mobile device 1001, preferably the leaf constituting the main operator control part 1020, is modified by means of a reversible mechanism. The reversible main operator control part 50010 comprises a reversible panel 50015. This reversible panel 50015 may, for example, have an operator interface on one side, for example with the design illustrated in FIG. 32, and an additional display element which fills the area on the opposite side. Other configurations are possible. It is thus appropriate for certain applications to embody one side of the reversible plate 50015 as a passive stable metal surface which can serve as a robust writing support.

The reversible main operator control part 50010 comprises not only the reversible panel 50015 but also two guide rails, specifically an upper guide rail 50020 which is arranged in the region of the upper edge of the leaf, and a lower guide rail 50025 which is arranged in the region of the lower edge of the leaf. The reversible part 50015 has a projecting pin 50030 on one of its vertical lateral edges on its underside, and on one of its vertical lateral edges on its upper side. The pins 50030 each engage in the upper or lower guide rail 50025 so that the reversible part 50015 cannot drop out, or be removed, from the mobile device 1001 by its left vertical lateral edge, but otherwise can be moved horizontally back and forth over the full width of the leaf.

FIG. 51 is a schematic, cross-sectional view through the digital mobile device 1001 according to the invention from FIG. 50 in various activation phases of the reversible main operator control part 50010.

FIG. 51A shows a first position of the reversible part 50015 in which the pins 50030 are oriented towards the left with respect to the hinge 1030, and a first surface A of the reversible part 50015 points upwards. The reversible main operator control part 50010 is triggered by the pressure of a finger near to the edge 51010 of the device.

FIG. 51B shows a second phase in which the reversible part 50015 springs up on being released.

FIG. 51C shows a third phase in which the reversible part 50015 is folded up and is held in the upper or lower rails 50025 by means of the pins 50030 on the left-hand edge.

FIG. 51D shows the reversible part 50015 in the folded-over state in which its second surface B points upwards and the pins 50030 move towards the right-hand outer leaf edge 51010.

FIG. 51E shows the reversible part 50015 in the engaged state in which the engagement occurs near to the hinge part. The surface B points upwards, and the pins 50030 are arranged near to the right-hand edge 51010.

The reversible mechanism depicted is given only for the purposes of illustration. Of course, other functionally equivalent reversible mechanisms may be used. The reversible part 50015 is locked to the edge 51010 of the housing using the customary means, for example a latching snap mechanism or by means of small permanent magnets.

FIG. 52 shows a schematic perspective view of the digital mobile part 1001 from FIG. 50 with a utensil compartment 520010 and the reversible part 50015 with two areas A, B which may be embodied in different ways. In this variant, the overall height of the leaf element of the main operator control part 1020 is selected to be sufficiently large that in the engaged state a cavity, which can be used as a utensil compartment, for example for pressure pens 1051 or the like, is arranged underneath the reversible part 5005.

FIG. 52B shows the digital mobile device 1001 according to the invention from FIG. 50, a first side of the main operator control part 1020 with a touch pad and/or pen pad being positioned facing upwards.

FIG. 52C shows the digital mobile device according to the invention from FIG. 52B in which, after a reversing operation, a second side of the main operator control part 1020 is positioned facing upwards, said side having a real keypad 52030, constructed from individual activation keys, and a real slide pad 52040. The reversible technology can therefore be used, in particular, to propose a further improved mobile device which not only has a main display 1010 and a touch pad but also a keypad 52030 and a separate slide pad 52040.

FIG. 52D shows another variant of the digital mobile device 1001 according to the invention in accordance with FIG. 50 in which a first side of the main operator control part 1020 has a second display. 52050. This second display 52050 proves particularly advantageous for mobile devices 1001 which are predominantly used as an electronic book as reading material can then be made available on both leaves.

FIG. 52E shows an illustration of the variant of the digital mobile device according to the invention in accordance with FIG. 50D in which a second side of the main operator control part has a book cover 52060 without display or operating means.

FIG. 53 shows a schematic view of the ergonomic adaptation of the operator control when the way in which a two-leaf digital mobile device according to the invention is supported is changed. FIG. 53A shows a “hand-held” mode in which the digital mobile device is held freely, essentially in the manner of a book. FIG. 53B shows a “free-hand” mode in which the main operator control part is supported firmly on an underlying surface and is used as a keyboard input means or pen input means. FIG. 53C shows a “hand-held/free-hand” use in which the digital mobile device is used in a partly freely held and partly supported position.

FIG. 53A shows the handling of a mobile device 1001 in the case of book-like, free-hand operator control, i.e. the mobile device 1001 is used by the user 1050 in the manner of a book which has been opened and is being held in a free-hand fashion.

FIG. 53B shows the handling of a mobile device 1001 with supported operator control, i.e. the mobile device 1001 is used by the user 1050 while it is resting on a supporting surface (for example a surface of a table).

FIG. 53C shows the handling of a mobile device 1001 with partially free-hand, partially supported operator control, i.e. the mobile device 1001 is used by the user 1050 with one leaf carried in a free hand and with one leaf resting on a supporting surface (for example a surface of a table).

The universal mobile device 1001 according to the invention is preferably embodied in such a way that the user 1050 can change between the modes of use illustrated in the partial FIGS. 53A, 53B and 53C without having to perform complicated operator control interventions on the mobile device 1001 himself.

FIG. 54 is a schematic view of various rotary orientation states during the handling of a digital mobile device 1001 according to the invention. The two-leaf digital mobile device 1001 according to the invention, which is held in the hand, comprises a first leaf 54010 which is provided with a display 54020, and a second leaf 54040 which is provided with a book cover 54030, the first leaf 54010 and the second leaf 54020 being coupled by means of a hinge 50050 so that they can be opened and closed in the manner of a book.

FIG. 54A illustrates a first orientation of the mobile device 1001 in which the second leaf 50040 provided with the book cover 54030 is arranged on the right and is held by the user's right hand.

FIG. 54B illustrates a rotational process which is performed manually by the user 1050 and with which the mobile device 1001 is placed upside down.

FIG. 54C illustrates a second orientation of the mobile device 1001 in which the second leaf 50040 which is provided with the book cover 54030 is arranged on the left and is held by the left hand of the user 1050.

FIG. 55 is a schematic view of operating means within reach of the operator's holding hand for ergonomically making inputs into a two-leaf digital mobile device 1001 according to the invention which is held in the hand and has a first leaf 54010 provided with a display 54020, and a second leaf 54040 provided with a book cover 54030, the first leaf 54010 and the second leaf 54020 being coupled by means of a hinge 50050 in the manner of a book so that they can be opened and closed.

The two hinge ends 50050a and 50050b can be provided with electrical plug-in connector devices (not illustrated) or wire-free data transmission devices, in particular infrared transmitters (for example IrDA, not illustrated). So that these interfaces function both in a left-handed operating mode and in a right-handed operating mode without cables becoming entangled or impediments to the wire-free data transmission, it is particularly advantageous to provide the electrical plug-in connector devices and/or wire-free data transmission devices at both ends 50050a, 50050b of the hinge 50050.

A region 54010a, 54040a within reach of the operator's holding hand is entered, approximately half the way up, on each of the leaves 54010 and 54040, shown in each case by broken lines at the corresponding outer edge of the leaf facing away from the hinge 50050. The regions 54010a, 54040a within reach of the operator's holding hand are here those regions on the surface of the leaves 54010, 54040 which the user 1050 of the mobile device 1001 can comfortably reach with the fingers of his hand without having to change the position of the rest of his hand relative to the mobile device 1001 when he holds the mobile device in his hands in the manner of a book.

FIG. 56 is a schematic view of the lower edge with an integrated interface of the digital mobile device 1001 according to the invention illustrated in FIG. 55 with an electric plug-in connection 56010, for example according to the USB standard or according to the “fire wire” standard, integrated in the underside 50050b of the hinge 50050. It is also possible to provide a jack plug mechanism. In addition, it proves advantageous to provide an electrical power supply connection to a power supply unit (not illustrated).

FIG. 57 is a schematic view of positioning possibilities of operating means in the action region within reach of the operator's holding hand on a two-part digital mobile device 1001 according to the invention with a first leaf 54010 provided with a display 54020, and a second leaf 54040 provided with a book cover 54030, the first leaf 54010 and the second leaf 54020 being coupled by means of a hinge 50050 in such a way that they can be opened and closed in the manner of a book.

A holding-hand action region 54010b, 54040b is entered on each of the leaves 54010 and 54040, as shown in each case by broken lines on the corresponding outer edge of the leaf facing away from the hinge 50050. The holding-hand action regions 54010b, 54040b are here those regions on the surface of the leaves 54010, 54040 which the user 1050 of the mobile device 1001 can comfortably reach with the fingers of his hand when he holds the mobile device in his hands in the manner of a book.

The holding-hand action regions 54010b, 54040b mark those regions of a mobile device 1001 according to the invention on which operator controls which are to be activated when the user 1050 holds the mobile device 1001 in his hands can preferably be arranged both on the side facing the user 1050 and on the reverse side.

FIG. 58 is a schematic view of positioning possibilities of the operating means with a region which is in reach of the operator's holding hand on a single-leaf digital mobile device 1001a according to the invention. Here too, similarly to the conditions described with respect to a two-leaf device in FIG. 57, two holding-hand action regions 58010a, 58010b are indicated.

FIG. 59 is a schematic cross-sectional view, for example along the line A-A′ in FIG. 57, of the interaction between the hand and operating means in the holding-hand action region as well as of possible voice inputting means. The reverse side of the leaf 54010 is designated by the reference symbol R, and the front side of the leaf 54010 is designated by the reference symbol V.

FIG. 60A is a schematic view of the action region of a left hand on the gripping edge on three sides of a first leaf (not illustrated in more detail).

FIG. 60B is a schematic view of the action region of a right hand on the gripping edge on three sides of a second leaf (not illustrated in more detail).

In FIGS. 60A and 60B, a side wall is provided in each case with the reference symbol S. Correspondingly, a front side is provided with the reference symbol V and a rear side with the reference symbol R.

In a two-leaf mobile device 1001, two corresponding action regions 60010a and 60010b with a total of two front side faces V, two reverse side faces R and two side faces S are available in the holding-hand action regions 54010b, 54040b indicated in FIG. 57, in order to arrange easy-to-operate operating means (not illustrated in more detail), that is to say a total of six faces. It is also possible to make use of just a subset of these faces for the arrangement of operating means.

FIG. 61 is a schematic view of the interaction in the holding-hand action region between a hand of the user 1050 and an operating means in a digital mobile device 1001 according to the invention in one of the action regions 60010a, 60010b illustrated in FIG. 60A and FIG. 60B.

FIG. 62 is a schematic view of interaction regions of an operating hand 62010 of a user 1050. FIG. 62 is to be read in conjunction with FIGS. 59 to 61. The ball of the hand, provided with the reference symbol S′, can be particularly advantageously used to activate operator controls in the side region S (lateral input means). The thumb, designated by the reference symbol V′, can particularly advantageously be used to activate operator controls in the front-side region (front-side input means). The other fingers apart from the thumb, which are designated by the reference symbol R″, can particularly advantageously be used to activate operator controls in the rear-side region (rear-side input means).

FIG. 63 shows, by reference to the illustration in FIG. 57, a schematic view of the action regions of the operating means in the action region within reach of the operator's holding hand for single-handed or two-handed input possibilities, and left-handed and/or right-handed operator control on a two-leaf digital mobile device 1001 according to the invention.

FIG. 63A shows a first operating mode of the mobile device 1001 in which two-handed operator control is carried out, operating means (not illustrated in more detail) being arranged both in the action region 54010b and in the action region 54040b.

FIG. 63B shows a second operating mode of the mobile device 1001, preferably for right-handed people, in which mode single-handed operation is carried out by means of the right hand, operating means (not illustrated in more detail) being arranged only in the action region 0.54010b.

FIG. 63C shows a third operating mode of the mobile device 1001, preferably for left-handed people, in which mode single-handed operation is carried out by means of the left hand, operating means (not illustrated in more detail) being arranged only in the action region 54040b.

FIG. 64 shows a schematic view of exemplary operating means alternatives in the action region within reach of the operator's holding hand on a two-leaf digital mobile device 1001 according to the invention. The partial FIGS. 64A to 64I show variants of ergonomically advantageous arrangements of operator controls which can be combined with one another and which do not necessarily all need to be implemented in a single exemplary embodiment of a mobile device 1001 according to the invention.

FIG. 64A shows a variant with a touch pad 64010 on the front side or on the reverse side in the main operator control part 1020 and with a separate main display part 1010. Movements of a cursor 64020 triggered by activating the touch pad 64010 can be seen on the main display part 1010.

FIG. 64B shows a variant of the situation illustrated in FIG. 64A, with a touch pad or touch screen 64010a on the main display part 1010. In this case, a specific region 64010A of the surface of the touch screen performs the function of a touch pad if the touch pad is implemented on the front side V. The implementation is alternatively effected on the reverse side R by means of a separate component. Movements of a cursor 64020 triggered by activation of the touch pad 64010 can be seen on the main display part 1010.

FIG. 64D shows a variant with a tracker ball 64020 in the main display part 1010. The tracker ball 64020 can preferably be implemented in the side region S or on the reverse side R. Movements of a cursor 64020 which are triggered by activating the tracker ball 64020 can be seen on the main display part 1010.

FIG. 64E shows a variant with a tracker ball 64020 on the side S, in the front region V or at the rear R of the main input part 1020 with a separate main display part 1010. Movements of a cursor 64020 which are triggered by activating the tracker ball 64020 can be seen on the main display part 1010.

FIG. 64F shows a variant with a touch pad 64040 on the front side V, lateral side S or rear side R, arranged on the main input part 1020 in the action region 64030 within reach of the operator's holding hand, the mobile device 1001 being equipped with a separate main display part 1010. The operating means 64050a to 64050f which are implemented by means of the touch pad 64040 act on the display in the main display part 1010 when activated by the user.

FIG. 64G shows a variant with a touch pad or touch screen region 64040 on the front side V, lateral side S or rear side R, provided on the main display part 1010. The operating means 64050a to 64050f implemented by means of the touch pad 64040 act on the display in the main display part 1010 when activated by the user.

FIG. 64H shows a variant with momentary-contact switches 64060a to 64060c provided at the side S or at the rear R of the main display part 1010. In one particularly preferred embodiment, the upper momentary-contact switch 64060A is used to move up a marker displayed on the display, or to scroll backwards, the lower momentary-contact switch 64060C is used to move down a marker displayed on the display, or to scroll forwards, and the central momentary-contact switch 64060B is used to select an object chosen by means of the two other momentary-contact switches and displayed on the display.

FIG. 64I shows a variant of the arrangement illustrated in FIG. 64H, but with momentary-contact switches 64060a to 64060c provided on the main operator control part 1020.

FIG. 65 shows a schematic view of operating means alternatives in the action region within reach of the operator's holding hand, relating to the interface selection, selection and activation of information on the display device 1010 on a two-leaf digital mobile device 1001 according to the invention.

The partial FIGS. 65A to 65E show by way of example individual applications of the technical concepts of inventive mobile devices 1001 illustrated in FIGS. 55 to 64. More details are also given in particular in the labelling information on the drawing. The preferred variants of the arrangement of the respective operating means in terms of their position at the front (V), at the side (S) or at the rear (R) are also respectively indicated next to the drawing.

FIG. 66 shows a schematic view of operating means in the action region of the operator's holding hand, relating to keyboard operation on the back, side and/or front with additional touch pad input means with different designs on a two-leaf digital mobile device 1001 according to the invention.

The partial FIGS. 66.1 to 66.4 show by way of example individual applications of the technical concepts of inventive mobile devices 1001 illustrated in FIGS. 55 to 64. More details can also be obtained in particular from the labelling information on the drawing. The preferred variants of the arrangement of the corresponding operating means relating to their position at the front (V), at the side (S) or at the rear (R) are respectively given next to the drawing.

FIG. 67 shows a perspective back view of a two-leaf digital mobile device 1001 according to the invention with combination keys 67010a, 67010b on the back of the hand-grip parts 67020a, 67020b for two-handed operation by the user 1050, i.e. a set of combination keys 67010a, 67010b is arranged on the back of each leaf.

FIG. 68 is a schematic view of the use of the two-leaf digital mobile device 1001 according to the invention from FIG. 67 in the manner of a book held with both hands with combination keys 67010a on the back for single-handed operation by the user 1050, i.e. the mobile device 1001 is held in both hands but operated with only one hand.

FIG. 69 is a schematic view of the use of the two-leaf digital mobile device 1001 according to the invention from FIG. 68 with another method of handling.

FIG. 70 shows a perspective view of a two-leaf digital mobile device 1001 according to the invention which is held with two hands with pressure-sensitive regions 70010a, 70010b which can be operated using a thumb.

FIG. 71 shows a perspective back view of a two-leaf digital mobile device 1001 according to the invention with function keys 71010 on the back, which keys 71010 lie in the region 71020 within reach of the operator's holding hand and can be activated by the holding hand. 71030.

FIG. 72 shows a perspective view of a two-leaf digital mobile device 1001 according to the invention which is held with the left hand 72010 and operated in the region 72020 within reach of the operator's left holding hand 72010, the right hand 72030 operating a pen 72040 which can be used to input information.

FIG. 73 shows a perspective view of a two-leaf digital mobile device 1001 according to the invention which is held by a hand in the hinge region, an operator control operation on a touch pad being carried out with the other hand.

FIG. 74 shows a schematic view of three operator controls which are arranged on the back of the mobile device 1001 according to the invention, and their assigned functionalities. The keys 64060a, 64060b, 64060c shown have been described in more detail above with respect to FIGS. 64, 65, 66 and 67. Functional details on these keys are given in the drawing in FIG. 74.

FIG. 75 shows a perspective back view of a two-leaf digital mobile device 1001 according to the invention with a different embodiment of the holding-hand operating means, in particular removable back parts 75010 being provided. The possibility of replacing these back parts 75010 permits, for example, the mobile device 1001 according to the invention to be offered on the market with a fashionable casing with different colours, shapes, patterns and materials on the standard basic device so as to incur little extra expenditure.

FIG. 76 shows a perspective back view with an operator's hand 76010 arranged in the region within reach of the operator's hand on a digital mobile device 1001 according to the invention from FIG. 75 when an interface selection switch 76020 is pressed.

FIG. 77 shows various operating modes of the hand-grip part 77010 of the mobile device according to the invention from FIG. 75. The hand-grip part 77010 comprises, in particular, a gripping panel 77020 which is oriented from the hinge 1030 of the mobile part away towards the outer edge of the leaf, and an adjoining keypad block 77030 which is, however, oriented towards the hinge 1030 and preferably has three keys 77030A, 77030B, 77030C which are arranged together. The functionality of the keys 77030A, 77030B and 77030C has already been explained in FIGS. 64 to 67 in relation to the references 64060A, 64060B and 64060C there. The following aspects are illustrated schematically on an individual basis:

FIG. 77a: Hand-grip stabilization/protection: an expedient embodiment of the gripping panel 77020 with a particularly robust, easy-grip surface which is pleasant to the touch makes the mobile device 1001 easier to operate as the user 1050 can without difficulty leave the fingers of one hand on the gripping panel even for relatively long periods of time in order to be able to execute an operating action at short notice when necessary.

FIG. 77b: Interface selection switch: an electric pushbutton switch (not illustrated) can be arranged underneath the gripping panel 77020 and is actuated when the gripping panel 77020 is pressed by the fingers of a hand of the user 1050. As the fingers of this hand are already in the basic position on the gripping panel 77020, it proves particularly advantageous to use the pushbutton switch which can be actuated by the gripping panel 77020 as an interface selection switch. The mobile device 1001 according to the invention is constructed in such a way that when the user 1050 is making normal use of the device, for example reading items presented on the display, the user is confronted as little as possible with operator control menus, operating icons and the like. However, if the user 1050 wishes to perform an operator control operation, it is necessary to trigger the display of operator control menus, icons and the like. The gripping panel switch can advantageously be used for this triggering operation.

FIG. 77c: Touch pad/slide pad: the surface of the gripping panel 77020 can advantageously be provided with a touch pad or slide pad for inputting directional information.

FIG. 77d: Multifunction keys: multifunction keys 77030a, 77030b and 77030c can advantageously be provided for scrolling upwards, selecting and scrolling downwards.

FIG. 78 shows a schematic view of two different operating modes of the hand-grip part 77010 from FIG. 77.

The depressed gripping panel 77020 is shown schematically in FIG. 78A.

The depressed key 77030b, with the gripping panel 77020 also depressed, is shown schematically in FIG. 78B.

FIG. 79A shows a single-leaf digital mobile device 1001 according to the invention with hand-grip part. Please refer to the description relating to FIG. 110A.

FIG. 79B shows a two-leaf digital mobile device 1001 according to the invention with hand-grip part. Please refer to the description relating to FIG. 110B.

FIG. 80A shows a two-leaf digital mobile device 1001 according to the invention with a permanently integrated device back part. Please refer to the description relating to FIG. 11A.

FIG. 80B shows the illustration from FIG. 80A, but with an exchangeable device back part. Please refer to the description relating to FIG. 111B.

FIG. 80C shows the arrangement from FIG. 80A, but with an exchangeable hand-grip part. Please refer to the description relating to FIG. 111C.

FIG. 81 is a schematic view of a mobile device 1001 according to the invention with a synchronization device for the screen and operator control unit after left-handed/right-handed presetting.

Numerous settings relating to the operating modes of the mobile device 1001 depend on its orientation relative to the gravitational field of the Earth. In particular, the methods of use illustrated in FIG. 81 can be determined from the orientation of the leaves in the gravitational field:

| Type | First leaf | Second leaf |
|---|---|---|
| Book-like use, | (approximately) | (approximately) |
| held in hands | upright in | upright in |
| | vertical position | vertical position |
| Book in lying | (approximately) | (approximately) |
| position | flat | flat |
| Notebook | (approximately) | (approximately) |
| | upright in | flat |
| | horizontal | |
| | position | |

It therefore proves particularly advantageous to provide at least one leaf, but better both leaves, of the mobile device with one gravity sensor each, which sensor detects the orientation of the respective leaf in the field of gravity. The output signals of the gravity sensor/gravity sensors are fed to the electronic controller (central processor unit, not illustrated) of the mobile device 1001 and can be detected for the automatic detection of operating modes.

FIG. 81 is a schematic view of a rectangular gravity sensor 81010 in various states of use of the mobile device. A rectangular gravity sensor 81010 comprises an enclosed cavity with an essentially square arrangement in which a tracker ball is enclosed. The rectangular gravity sensor 81010 is integrated into one leaf of a mobile device 1001 in such a way that each of the four corners of the gravity sensor points to one of the outer edges of the leaf. Depending on the orientation of the edges of the leaf in the gravitational field, the tracker ball will come to rest in one of the four corners. Each of the four corners is therefore equipped with a sensor which expediently detects whether or not the ball is in the respective corner. This can be done, for example, by visual means using a photoelectric barrier. It is also possible to fabricate the tracker ball from an electrically conductive material, for example from metal, and to detect its location at the corners by means of electrical contacts.

FIG. 81B shows an orientation of the mobile device 1001 in the gravitational field, in which orientation the tracker ball of the rectangular gravity sensor 81010A is in the corner b. This orientation as a “Notebook” is advantageous both for right-handed and for left-handed people for writing functions as the leaf which is pointing downwards permits writing functions with a writing pen (not illustrated).

FIG. 81C shows an orientation of the mobile device 1001 in the gravitational field, in which orientation the tracker ball of the rectangular gravity sensor 81010A is in the corner c. This orientation is advantageous for right-handed people for reading functions as the leaf which is arranged on the right permits reading material to be displayed on a display.

FIG. 82 shows a schematic view of the gravity switch 81010 of the synchronization mechanism from FIG. 81 with presetting of the device for left-handed/right-handed people. As is apparent from the description of FIG. 81, it is possible to perform an optimum assignment of functionalities to individual leaves of the mobile device 1001 according to the invention for right-handed or left-handed people if, firstly, the characteristic “left-handed” or “right-handed” and, secondly, the position of individual leaves in the gravitational field are known. It therefore proves advantageous, with a mobile device 1001 according to the invention, to be able to make a “left-handed” or “right-handed” configuration setting so that the control unit (not illustrated) of the mobile device 1001 can automatically perform the setting of the use mode in terms of the functional apportioning and implementation to the leaves from the “left-handed” or “right-handed” presetting (entered only once when starting to use the device) in conjunction with the relation of the device to the gravitational field. This automatic feature also includes, in particular, the function of always automatically presenting the user with display contents with an upright, readable configuration.

FIG. 83 shows a schematic view of a second embodiment of a gravity switch 83010 on a digital mobile device according to FIG. 81 for automatic synchronization or setting of the display device and of the operator controls. The semicircular gravity switch 83010 contains a semicircular tubular section in which a tracker ball can move freely in the gravitational field. The position of the tracker ball can be sensed by means of suitable sensors (not illustrated) and fed to the controller (not illustrated) of the mobile device 1001. FIG. 83A shows a cross section through a leaf which functions as an operator control part and has an embedded semicircular gravity switch 83010. FIG. 83B shows a front view of a leaf which functions as an operator control part and has an embedded semicircular gravity switch 83010. FIG. 83A is a schematic view of a semicircular gravity switch 83010 which is embedded in a leaf, in two leaf positions relative to the gravitational field.

FIG. 84 shows the semicircular gravity switch 83010 from FIG. 83 at different angles of inclination.

FIG. 84A relates to the case of a mobile device 1001 which is resting flat on a level underlying surface.

FIG. 84B relates to the case of a mobile device 1001 which has been raised slightly from a level underlying surface with an attitude angle of approximately 10 degrees.

FIG. 84C relates to the case of a mobile device 1001 which is being held in the hands, or is resting on a lap, with an attitude angle of approximately 20 degrees.

FIG. 84D relates to the case of a mobile device 1001 which is being held at an attitude angle of approximately 30 degrees.

FIG. 84E relates to the case of a mobile device 1001 which is being held at a significantly steeper attitude angle of up to approximately 90 degrees.

So that incorrect triggering of the switching over of the operating mode which is triggered by the gravity switch, for example when the mobile device is moved suddenly by the user, is avoided, it is necessary to define filter criteria according to which the controller (not illustrated) of the mobile device 1001 performs discrimination as to whether the position of the mobile device 1001 in the gravitational field has changed permanently or whether there is only a brief disruption occurring:

a) definition of tolerance ranges of the measured angles, and

b) definition of time constants, i.e. minimum times to which a change in position of the mobile device in the gravitational field must persist in order to bring about automatic resetting of the operating mode.

FIG. 85 is a schematic view, based on a semicircular gravity switch 83010, of an automatic setting according to FIG. 84 for right-handed people as a function of whether an application is selected in which it is necessary to make an input or in which reading in the manner of a book is to be performed. For this purpose, the mobile device 1001 according to the invention is configured in a configuration menu (not shown in more detail) for the “right-handed” operating state. If the right-handed user 1050 holds the mobile device 1001 in his hands with the writing sensor surface 85020 on the right, the display is automatically activated in such a way that the reading material presented there appears in the customary reading direction from top to bottom. If the right-handed user 1050 turns the mobile device 1010 “upside down”, through 180 degrees, this operation is detected by the semicircular gravity sensor 83010. The reading material is firstly “upside down” on the display 85020 which is now on the right, and an icon symbolizing “ready to switch over” appears on the display. Only after a predetermined time, for example after 5 seconds, does the mobile device 1001 detect that the position of use has changed permanently, and it transforms the contents displayed on the display 85020 in such a way that they are now “the right way up” again. The mode of use has thus been switched over by the user 1050 from the “right-handed writing” into “right-handed book reading” mode by simply turning around the mobile device 1001 without his also having to cope with configuration menus and dialogues.

FIG. 86 shows details of the sequence illustrated in FIG. 85.

FIG. 87 shows a third embodiment of a gravity switch for a digital mobile device according to FIG. 81. FIG. 87 shows a bent-tube gravity switch 87010 as a modification of the semicircular gravity switch 83010 illustrated in FIGS. 83 to 86. The bent-tube gravity switch comprises a bent tube 87010a in which a tracker ball 87010b can move. The tube 87010a is bent slightly approximately at its centre. This results in three positions at which the tracker ball can assume a (meta)stable position which is dependent on the orientation in the gravitational field, specifically the setting point A as a first end point of the tube 87010a, setting point B at the bend in the tube 87010a and setting point C at the other (second) end point of the tube 87010a. A sensor (not illustrated) which is capable of detecting the tracker ball 87010b is provided at each of the setting points A, B and C.

FIG. 88 shows a cross-sectional view of a two-leaf digital mobile device 1001 according to the invention with a gravity switch 87010 according to FIG. 87 when the operator control part provided with the gravity sensor 87010 is folded up.

FIG. 89 shows the gravity switch 87010 from FIG. 87 at various angles of inclination.

From FIG. 89A it is apparent that the tracker ball 87010b comes to rest at the setting point B when the leaf of the mobile device is resting flat on the table.

Even when there is a slight angle of inclination, the tracker ball 87010b firstly still remains at the setting point B; cf. FIG. 89B.

The tracker ball only moves suddenly to the setting point A when there is a relatively large angle of inclination, as is apparent from FIG. 89C. This event can be used to trigger a semi-automatic configuration routine in the controller (not illustrated) of the mobile device 1001. For example, a selection menu which offers the item “Orient monitor”, which can be selected by touch screen activation, can be displayed. Alternatively, the triggering is carried out by activating a key. It is also possible to provide a voice-activated control, for example by means of a spoken command: “Orient monitor!”.

FIG. 90 shows a semi-automatic setting operation for a two-leaf digital mobile device 1001 according to the invention for a right-handed presetting with a bent-tube gravity switch 87010 according to FIG. 87.

In the situation illustrated in FIG. 90.2, the mobile device 1001 is resting flat on a level underlying surface, for example the surface of a table. The tracker ball 87010b is at the setting point B. The first leaf 9010 of the mobile device 1001 comes to rest on the right and can be used by the user 1050 for writing using a writing pen 90020.

FIG. 90.3 shows that the user has lifted off the mobile device 1001 illustrated in FIG. 90.2 from the underlying surface and is now holding it with both hands in the manner of a book. The tracker ball 87010b is then at the setting point A. The first leaf 9010 of the mobile device 1001 is still on the right and can be operated by the user 1050 in the region 9030 within reach of the operator's hand.

FIG. 90.4 shows a situation after the user has turned the mobile device 1001 “upside down” by means of a rotational movement. The tracker ball 87010b is then at the setting point C. The first leaf 9010 of the mobile device 1001 is now on the left and can be operated by the user 1050 in the region 9030 within reach of the operator's hand. The second leaf 90040 with the display is on the right; the displayed contents are however still “upside down” as the time constant after which a change in the state of the bent-tube gravity switch 87010 is detected as valid by the controller (not illustrated) of the mobile device 1001 has not yet expired. The assignment of the functionalities to the momentary-contact switches 90050 on the back is also still “upside down”.

FIG. 90.6 shows the state, illustrated in FIG. 90.4, after the time constant has expired. The contents displayed on the display 90040 have the correct orientation for reading, and the assignment of the functionalities to the momentary-contact switches 90050 on the back is now no longer “upside down”; cf. FIG. 90.5.

FIG. 91 shows a schematic cross-sectional view of a gravity switch according to a fourth embodiment with a mechanical transmission of the switching force via a tracker ball. The captive ball gravity switch 91010 shown comprises in particular a straight tube 91020 with a tracker ball 91030 which can move in it. In order to reduce noise effects when the tracker ball 91030 rolls, the straight tube 91010 can be sealed off at both ends with noise-damping closures 91050a, 91050b, for example made of rubber or rubber-like plastic. The tracker ball 91030 can also be fabricated from rubber or rubber-like plastic in order to reduce noise. A pushbutton-switch operator control 91040 is arranged above the tube 91020. The pushbutton-switch operator control 91040 has a projection 91040a, 91040b in the region of each of the ends of the tube 91020, which projection 91040a, 91040b engages through the corresponding opening of the tube casing into the interior of the tube 91020. In the basic position, the pushbutton-switch operator control 91040 does not impede the free movement of the tracker ball 91030. The pushbutton-switch operator control 91040 can be pressed in the direction of the tube 91020 by the user 1050 pressing a finger of a hand counter to the restoring force of a spring (not illustrated), so that the projections 91040a, 91040b are pressed into the interior of the tube 91020. If the tracker ball 91030 is at one of the end setting points A or B when the pushbutton-switch operator control 91040 is activated, the force is transmitted by the user 1050 via the pushbutton-switch operator control 91040 to the tracker ball 91020 which, for its part, passes on this force to the wall of the tube lying opposite the respective projection 91040a, 91040b. An electric momentary-contact switch 91060a, 91060b which is activated by the force is provided at this point.

The captive ball gravity sensor 91010 therefore supplies, by means of the momentary-contact switches 91060a, 91060b, an output signal which indicates its position in the gravitational field only if the user 1050 applies a compressive force to the pushbutton-switch operator control 91040. The advantage of this gravity switch is principally that it does not require any measures to guard against accidentally triggered position change signals. The user 1050 activates the pushbutton-switch operator control 91040 manually when he has changed the position of the mobile device 1001 and wishes to inform the control unit (not illustrated) of this.

FIG. 92 shows a two-leaf digital mobile device 1001 according to the invention with a gravity switch 91010 from FIG. 91 with various settings in the gravitational field.

FIG. 93 shows a gravity switch 91010 according to FIG. 91 in various operating states.

FIG. 93A shows the captive ball gravity switch 91010 in an inclined position in which the tracker ball 91030 comes to rest at the setting point A.

FIG. 93B shows the captive ball gravity switch 91010 from FIG. 93A when pressure is applied by the user 1050.

FIG. 93C.4a shows the captive ball gravity switch 91010 from FIG. 93A after pressure has been applied by the user 1050. As a result of a latching device, the pushbutton-switch operator control 91040 remains depressed and the tracker ball 91030 continues to be secured.

FIG. 93C.4b shows the captive ball gravity switch 91010 from FIG. 93A after pressure has been applied by the user 1050 once more. The pushbutton-switch operator control 91040 is released and the tracker ball 91030 can move freely again. The setting point A applies for the control of the mobile device 1001 up to the next activation of the pushbutton-switch operator control 91040.

FIG. 94 shows a mechanical setting operation of a two-leaf digital mobile device 1001 according to the invention with a captive ball gravity switch 91010 according to FIG. 91, based on a left-handed configuration.

The captive ball gravity switch 91010 is arranged in the region 94010 within reach of the operator's holding hand, on a first leaf 94020 of the mobile device; see FIG. 94.2. The tracker ball is at the setting point A. After the mobile device has been “turned upside down” in FIG. 94.3, the tracker ball is still at the setting point A owing to the securing effect described in FIG. 93C.4a. Only after the pushbutton-switch operator control 91040 has been activated by the user 1050 is it possible for the tracker ball to move into the setting point B, and for the mobile device to go into the changed operating mode; see FIG. 94.5. FIG. 94.6 illustrates how the left-handed user writes with a pressure pen on the leaf 94020 which is now on the left. The information already given above in relation to FIG. 90 applies correspondingly to the switching over of the display and the orientation of operating means.

FIG. 103 shows a schematic view of a two-leaf embodiment of a digital mobile device according to the invention with a turning mechanism for a functional part.

FIG. 104 shows, in the partial FIGS. 104a to 104e, a rear view or external view of the housing for different variants of digital hand-held parts 4010a to 4010d according to the invention.

The illustrated digital hand-held parts 4010a to 4010d comprise at least one flat display unit (not illustrated) for displaying digital information and are intended to be held by the user with one hand or with both hands. In preferred embodiments, digital hand-held parts also have input means, for example input keys 4020. When necessary, digital hand-held parts can also be embodied as fully functioning computers including power source, central processor unit, memory and further peripherals. Numerous desirable applications of digital communication in general and digital hand-held parts of the type described above in particular are possible only if a digital hand-held part can be held and operated by the user with little fatigue even over a relatively long time. In this context, in particular a low weight and pleasant haptics are of considerable importance. It therefore proves expedient to configure the housings of digital hand-held parts in a particular way.

FIG. 104a shows a rear view of a two-leaf digital hand-held part 4010a with a first leaf 4030a and a second leaf 4030b, which can be folded open and shut with respect to the user in the manner of a book by means of a hinge part 4030c. The left-hand or right-hand hand-grip region (shown by hatching) is implemented on the housing back by means of a first housing back surface region 4040a, 4040b which is embodied in the form of a lip, whereas the remaining housing back surface is illustrated without hatching, and forms a second housing back surface region 4050a, 4050b. Operator control keys 4020 are arranged on the first housing back region. It proves expedient to configure the first housing back surface region 4040a, 4040b differently than the second housing back surface region 4050a, 4050b in terms of the material used. Housing back surface regions corresponding to the first housing back surface region 4040a, 4040b are designated below as “holding region”, whereas housing back surface regions corresponding to the second housing back surface region 4050a, 4050b are designated as “cover region”. Designs which differ from the lip shape are also possible; however, the lip shape shown is to be considered a preferred embodiment.

FIG. 104b shows a first variant of the housing back illustrated in FIG. 104a in which a single-leaf digital hand-held part 4010b is provided with a leaf 4030. This leaf 4030 can be protected against dust and damage by a book-cover-like cover mask 4060 which can be folded shut. The leaf 4030 also has a holding region 4040 and a cover region 4050. In contrast to FIG. 104a, FIG. 104b does not exhibit any operator control keys on the back.

FIG. 104c shows a second variant of the housing back illustrated in FIG. 104a in which a two-leaf digital hand-held part 4010c is provided with two leaves 4030a, 4030b, but without input keys 4020.

FIG. 104d shows a third variant of the housing back illustrated in FIG. 104a in which a single-leaf digital hand-held part 4010b is provided with a leaf 4030. This leaf 4030 can be protected against dirt and damage by a book-cover-like cover mask 4060 which can be folded shut. In FIG. 104d the cover mask 4060 is flexibly folded over towards the rear. The leaf 4030 also has a holding region 4040 and a cover region 4050.

FIG. 104e shows the digital hand-held part from FIG. 104c in the folded-shut state.

A significant aspect when selecting materials for the holding region and the cover region is the durability and resistance to abrasion. For example, it may be desired in terms of design to cover the surface of the cover part with natural leather. However, embodying the surface in the holding region with natural leather would have the disadvantage that the surface would relatively quickly assume a worn and used appearance. The difference between the holding region and cover region permits a different material to be selected so that, for example, the holding region can be embodied as an ageing-resistant and wear-proof metal part if the cover part is embodied in natural leather. A holding region which is embodied in a particularly durable fashion in this way protects the cover region against premature wear.

A further important aspect is the compressibility of the material used. If the cover region is made compressible, for the sake of the haptics, by using, for example, polyurethane foam, inexpedient compressibility there owing to the presence of pushbutton keys in the holding region can be avoided by using a material which is less compressible, or virtually incompressible.

In addition, the different mechanical flexibility of a material can be a relevant factor. If, for example, the digital hand-held part uses a flexible display, for example on a polymer base, it may be desirable to make its housing flexible in its entirety. In order to control and limit the flexibility of the entire housing, for instance in order to define a predetermined bending line, it may be advantageous to implement the holding region and the cover region with materials with different degrees of flexibility (rigidity). One possibility would be, for example, to manufacture the cover region from a relatively flexible material with a low degree of rigidity, while the holding region is made from a less flexible material with a relatively high degree of rigidity.

A further important criterion for the configuration of the housing of the digital hand-held part according to the invention is to determine whether the holding region and/or the cover region are configured as separately exchangeable parts. For example, an exchangeable cover region may be advantageous if, for example for reasons of fashion, it is to be made possible for the user to change the surface design. Also, an exchangeable solution may be justified owing to the abrasion which the holding region causes on the cover region, fabricated from more sensitive materials, despite the abovementioned protection.

FIG. 105 shows a schematic plan view of the lower edge or upper edge of a development of a housing from FIG. 104c, which provides an exchangeable, compressible cover region 4050a, 4050b. Here, the holding region 4040a, 4040b is embodied essentially integrally with the front part of the housing, while the cover region 4050a, 4050b is embodied in the form of separate, removable cover shells. These cover shells 4050a, 4050b are secured under the holding region 4040a, 4040b by clamping and can easily be removed and exchanged by the user by means of a sideways movement (1.) and subsequent upwards movement (2.). The cover shells 4050a, 4050b are preferably provided on the upper side and lower side with a projecting spring which engages in a corresponding groove in the housing and forms protection against the ingress of dirt and moisture. The electronics 4060 are protected, for example, by means of a sealing compound or by means of some other protective coating (not illustrated) to such an extent that they are also not damaged when the cover shell is replaced in the proper way.

FIG. 106 shows a schematic view of a housing back part 4010 with an exchangeable holding region 4040. The holding region 4040 is formed by an essentially U-shaped part which can be pushed onto the edge region (in the direction of the arrow) and also pulled off again.

FIG. 107 shows a schematic view of exchangeable components of a modular housing back part. In the upper part of the figure, cover shells 4080a to 4080d are shown which can be exchanged separately. In the lower part of the figure, combination parts 4085a to 4085d, which can be exchanged and which embody both the holding region and the cover region, are illustrated as alternatives.

FIG. 108 shows, in the partial FIGS. 108a to 108c, rear views of further variants of housings of digital hand-held parts according to the invention, specifically those which have only one leaf. FIG. 108a shows a housing back part with two holding regions 4040a, 4040b and a cover region 4050 as well as with operator controls 4020. FIG. 108b shows another housing back part with two holding regions 4040a, 4040b and a cover region 4050, but without operator controls. FIG. 108c shows a further housing back part with a holding region 4040 and a cover region 4050 without operator controls.

FIG. 109 is a schematic view of the process of changing specific back parts on modular housing backs. FIG. 109a shows the insertion of a cover shell 4050 in a downward direction from above, into the basic housing to which the holding regions 4040a, 4040b are permanently connected. In one development, the cover shell 4050 can have flat cut-outs 4050g which permit the holding regions 4040a, 4040b to engage. This procedure is particularly suitable for hand-held parts of the type illustrated in FIG. 108b. FIG. 109b shows, as an alternative, the insertion of a cover shell 4050 in the sideways direction into the basic housing to which a single holding region 4040 is permanently connected. In one development, the cover shell 4050 can have a flat cut-out 4050g which permits the holding region 4040 to engage. This procedure is particularly suitable for hand-held parts of the type illustrated in FIG. 108c. FIG. 109c shows, as an alternative, a cover shell 4050 which is permanently connected to the basic device and onto which two holding region parts 4040a, 4040b which each form a holding region can be fitted in a suitable way, for example by bonding, latching connections, screws etc. This procedure is particularly suitable for hand-held parts of the type illustrated in FIGS. 108a, 108b.

FIG. 110 shows, in the partial FIGS. 110a and 110b, schematic views of different function zones of a modular housing of a single-leaf or two-leaf digital hand-held part according to the invention.

FIG. 111 shows, in the partial FIGS. 111a to 111c, various aspects of a developed, modular housing of a digital hand-held part according to the invention.

FIG. 111a shows a plan view of the housing back of a completely assembled, two-leaf digital hand-held part according to the invention with a first leaf part 4030a and a second leaf part 4030b. On the side facing the user, each of the leaves can have a planar display (not illustrated); in one preferred variant, each of the two leaves has a display (not illustrated). The leaf parts 4030a, 4030b can be folded open and shut with respect to the user in the manner of a book by means of a hinge device 4030c. A housing back part which is associated with the basic housing is designated by the reference symbols 4090a, 4090b. In each case a removable book back part 4095a, 4095b can be plugged in under the housing back part 4090a, 4090b and attached. FIG. 111b shows a state in which both book back parts 4095a, 4095b are extended laterally. Each book back part 4095a, 4095b has, in the example illustrated, one hand-grip part 4097a or 4097b, respectively, which can include operator controls 4020. FIG. 111c shows a state in which the hand-grip part 4097a is extended laterally out of the book back part 4095a. Of course, the electrical connection of operator controls 4020 is made disconnectable by means of suitable plug-in connector devices 4099.

It is apparent that the degree of modularity of the housing design according to FIGS. 111a to 111c is variable. If necessary, the possibility of removing a book back part separately can also be dispensed with, as can the possibility of removing a hand-grip part separately.

FIG. 112 shows an illustration of a mobile device 1001 according to the invention with a modular hand-grip part 112010 inserted at the side/at the back.

FIG. 113 shows an illustration of a modular hand-grip part 112010 from FIG. 112. The modular hand-grip part 112010 has suitable electrical and mechanical plug-in and engagement devices (not illustrated in more detail) in order to bring about an electrical and mechanical connection to the host device. The modular hand-grip part 112010 can be fitted not only into the electronic mobile device 1001 but also, for example, onto personal digital assistants (PDAs), web tablets or e-book reading devices. The modular hand-grip part 112010 corresponds to the technical teaching illustrated in FIGS. 103 to 111c. However, it is embodied as a standalone device which can be attached to other devices, for example by bonding with adhesive from a tube or adhesive film or by means of mechanical clamping devices, in order to be able to make the functionality of a hand-grip part at the side or at the back also available to devices which are not equipped with one at the factory. The data connection between the modular hand-grip part and the host device can also be made, for example, in a wire-free fashion by means of Bluetooth or IrDA or else by means of a cable connection, for example to a serial interface of the host device.

FIG. 114 shows the modular hand-grip part 112010 from FIG. 112 when it is fitted onto the back of a host device 114010. FIG. 114a illustrates, for example, attachment from the side by means of plugging, bonding, etc. FIG. 114b illustrates plugging on from above, for example in the manner of a tongue and groove system. FIG. 115 shows, in the partial FIGS. 115a to 115c, a data processing device according to the invention with a wearable computer 1010.

The wearable computer 1010 has a wearable computer housing 1015 which is embodied so as to be flat, with rounded edges and slightly concavely arched so that it can easily be carried on the body, for example with a belt 1017. Other shapes of the housing 1015 are also possible if the computer can easily be carried on the body. In particular, forms which enable the wearable computer 1010 to be sewn into or inserted into items of clothing are possible.

The wearable computer 1010 which is illustrated by way of example has a display 1020 as well as operator controls 1030a, 1030b and 1030c which are embodied, for example, as momentary-contact switches. An LED 1040 can also be provided as status display.

At a suitable point, the wearable computer 1010 which is illustrated by way of example has a receptacle device (not illustrated) for a card module 1050.

FIG. 115b shows the securing of the wearable computer 1010 to a belt 1017 by means of a securing loop which is attached in a suitable way to the housing 1015. FIG. 115b also shows a protection against dirt and sprayed water, by means of a protective cap 1070 which is fitted from above onto the housing 1015 of the wearable computer 1010. Furthermore, FIG. 115b shows a two-leaf hand-held part 1080 in the manner of a digital book which can be folded open and shut in the manner of a book by means of a hinge device 1081 and is connected to the wearable computer 1010 by means of a cable 1082, and which is held in the hand by the user 1084. In one preferred embodiment, the two-leaf hand-held part 1080 can be provided with two displays 1086a, 1086b which each essentially form the inner sides of the two leaves. The hand-held part 1080 can be made particularly simple, thin and lightweight by virtue of the fact that essential parts of the electronics are transposed into the wearable computer 1010 which is carried on the body.

FIG. 115c shows a user 1084 who is carrying the wearable computer 1010 on a shoulder belt 1017 and at the same time is holding the hand-held part 1080 in his hand in a way which is suitable for operation and reading, the right hand activating operator controls arranged on the back.

FIG. 116 shows, in the partial FIGS. 116a to 116c, variants of the data processing device illustrated in FIG. 115 as a one-piece embodiment with a display, the hand-held parts from FIGS. 116a and 116b being able to be embodied both with and without their own power supply (for example storage battery or dry battery).

FIG. 116a to FIG. 116c show a wearable computer 1010 which interacts with a single-leaf hand-held part 1080a, different and combinable operator control possibilities being specified.

FIG. 116a symbolically shows operator controls 1090 which are arranged on the back of the hand-held part 1080a and which can be embodied, for example, in the form of three pushbutton keys 1090a, 1090b and 1090c. Here, the keys 1090a, 1090b, 1090c are arranged in the region within reach of a holding hand 1084a of a user 1084. In one particularly preferred embodiment, the keys can be operated individually, for example in order to trigger a “scroll upwards” function by means of key 1090a, in order to trigger a “scroll downwards” function by means of key 1090c, and in order to trigger a menu selection function by means of key 1090b. In the particularly preferred embodiment, the keys 1090a, 1090b and 1090c can also be operated together, or in combination with other input means, for example a touch-sensitive screen (not illustrated) or a voice input device with a microphone, in order to trigger further functions, for example by means of simultaneous operation of two or three keys. The embodiment which is shown by way of example also shows a cable connection which supplies the hand-held part with power and which permits bidirectional data communication. It is left open as to whether the hand-held part has its own storage battery or dry battery or the like. In such a case, if appropriate, the power source can be charged indirectly via the wearable computer.

FIG. 116b shows a variant which permits, in addition to the cable 1082, a wire-free data connection between the wearable computer 1010 and the hand-held part 1080a. This wire-free data connection may be made in particular by means of a radio-frequency radio link, for example according to the “Bluetooth” standard, or by means of an infrared connection, for example according to the IrDA standard. For this purpose, the wearable computer 1010 has a transceiver device 1095a at a suitable point. The hand-held part 1080a also has, at a suitable point, a transceiver device 1095b which is selected so as to match the transceiver device 1095a of the wearable computer 1010. Data communication between the hand-held part and/or the wearable computer and remote or external equipment or devices, for example, the Internet, other personal computers, printers etc., is also possible via a cableless LAN (Local Area Network) or WAN (Wide Area Network), while the communication between the hand-held part and wearable computer is carried out via cable 1082.

FIG. 116b shows the operator control of the hand-held part 1080 by means of a pressure pen 1094 which is made to move on a pressure-sensitive area 1087 by a hand 1084a of a user 1084.

FIG. 116c shows a refinement of the data processing device which is illustrated in FIGS. 116a and/or 116b and in which the cable 1082 has been dispensed with. While it is possible to provide the hand-held part 1080 or 1080a with power from a power source (not illustrated), for example a storage battery or a dry battery, which is arranged in the wearable computer 1010 in the embodiment variants in FIGS. 115 and 116a to 26b which are provided with a cable, the embodiment or type of use illustrated in FIG. 116c requires a separate power supply of the hand-held part 1080a, for example by means of a storage battery arranged in the hand-held part 1080a, which storage battery is preferably provided in the handle part, for reasons of centre of gravity and cumbersomeness.

FIG. 116c shows the operator control of the hand-held part 1080a by means of a finger 1084b of a hand 1084a of a user 1084 on a pressure-sensitive area 1087.

FIGS. 116d and 116e show further variants of the embodiments illustrated in FIGS. 116a to 116c, but with a two-leaf hand-held part 1080, the storage battery or the dry battery in FIG. 116e being preferably accommodated in the region of the rotational joint (hinge) for reasons of centre of gravity and cumbersomeness.

FIG. 117 shows, in the partial FIGS. 117a to 117c, a further variant of a data processing device according to the invention. Unless specified otherwise, the references indicated here correspond to the references used in FIGS. 115 and 116.

In particular, FIG. 117 shows an application of the data processing device in which the hand-held part 1080 is set up in the manner of a notebook, i.e. a first leaf part 1086b rests on a level surface, for example the surface of a table, while a second leaf part 1086b is positioned perpendicularly. The individual embodiment examples can be combined as desired (not illustrated) in terms of the operator control and the corresponding embodiment in a different design.

In FIG. 117a, the inwardly pointing surface of the first leaf part 1086b is pressure-sensitive, and the user 1084 moves a pressure pen 1094 on it with his hand and in this way makes a data input.

In FIG. 117b, the inwardly pointing surface of the first leaf part 1086b is provided with the functionality of an input keypad, and the user 1084 activates a data input with his hand 1084a. The embodiment of the keypad as a virtual keypad, which is operated by means of a sensitive input area, or as a real keypad with keys to be activated mechanically, is left open.

In FIG. 117c, the inwardly pointing surface of the first leaf part 1086b is equipped with the functionality of a touch pad, and the user 1084 activates a data input with a finger 1084b of his hand 1084a. In the example, a cursor is illustrated, which is shown on the display area and which indicates the relative position of the finger movement on the second leaf part (leaf of a book) which is embodied as a touch pad.

FIG. 118 shows a view of a first variant of a data processing system according to the invention with a wearable computer 1010 and a hand-held part 1080, which are connected to one another via a cable 1082 (FIG. 118a) or in a wire-free fashion (FIG. 118b). This first variant constitutes a particularly cost-effective solution in which the hand-held part 1080 can be used only together with the wearable computer 1010. In the variant shown in FIG. 118a, the cable 1082 not only permits data to be exchanged between the hand-held part 1080 and the wearable computer 1010; power can also be supplied to the hand-held part 1080 via the cable 1082 from a power source, for example a storage battery, arranged in the wearable computer 1010. As a result, the hand-held part 1080 can be made particularly low in weight. On the other hand, when the wearable computer 1010 is carried on the body, the weight of the necessary power source does not necessarily adversely affect the operating comfort. If the cable 1082 is avoided, it is necessary, as shown in FIG. 118b, to provide a wire-free data connection between the hand-held part 1080 and the wearable computer 1010. It is also necessary to provide a power source (not illustrated) in the hand-held part 1080.

FIG. 119 shows a highly schematic block circuit diagram of the first variant (illustrated in FIG. 118) of a data processing system according to the invention. In particular, the central system bus (EASI), the central processor unit (CPU) and the memory (ROM/RAM) are arranged in the wearable computer 1010. The hand-held part 1080 has, in particular, at least one, in two-leaf designs preferably also two or more displays and input means, for example momentary-contact keys or pressure-sensitive or touch-sensitive areas (touch screen, slide pad etc.). In the variant illustrated in FIG. 118b, a power source 2001 is optionally provided in the hand-held part 1080. The electronic devices of the hand-held part 1080 and of the wearable computer 1010 are each provided with a coupling interface 2020a and 2020b which is suitably constructed and connected to the other circuit components in such a way that the wearable computer 1010 can be operated by means of the devices provided in the hand-held part 1080. This includes also in particular the fact that data can be displayed on one or more displays of the hand-held part 1080 under the control of the central processor unit (CPU) of the wearable computer 1010. In certain embodiments, the hand-held part 1080 and the wearable computer 1010 can contain further modules, in particular

a) at least one interface device 2030 for card modules, for example according to the PCMCIA standard;

b) at least one interface device 2040 for magnetic cards;

c) at least one interface device for Flash ROM modules;

d) at least one interface device for wire-free data communication, for example according to the Bluetooth standard (radio) or according to the IrDA standard (infrared data transmission);

e) at least one interface device for microphone and loudspeaker (sound card);

f) at least one interface card for removable storage media such as CD-ROMs, diskettes etc.; or

g) at least one hard disk drive.

The labels given in FIG. 119 on the modules illustrated in schematic form give indications of their type and/or purpose. In certain embodiments, it is also possible to connect a plurality of identical or different hand-held parts to the wearable computer.

FIG. 120 shows a view of a second variant of a data processing system according to the invention with a wearable computer 1010 and a hand-held part 1080, it also being possible to use the hand-held part 1080 independently (FIG. 120a) or to connect it in a wire-free fashion and/or with a cable 1082 to a wearable computer 1010 (FIG. 120b). In contrast to the first variant illustrated in FIG. 118, in the variant illustrated in FIG. 120 the hand-held part 1080 and the wearable computer 1010 can in principle be used independently of one another as they are both embodied as completely functional computers. FIG. 120a shows in schematic form a use of the hand-held part 1080 as an autonomous digital book. FIG. 120b shows a coupled system composed of a hand-held part 1080 and wearable computer 1010. The additional data processing capacity of the wearable computer 1010 now makes it possible to convert the hand-held part 1080 into a high-performance notebook computer without it being necessary to provide the required computer capacity in the hand-held part 1080 from the outset. It is therefore possible to provide a hand-held part 1080 which can be used autonomously, but is nevertheless cost-effective, said hand-held part 1080 being for example an “eBook” for reading information in the form of books, periodicals, newspapers and documents and/or an Internet tablet for “surfing” on the Internet and/or a PDA (Personal Digital Assistant) for reading and writing notes, for running an appointments diary etc., which, when necessary, can be upgraded to form a high-performance overall system by coupling it to the wearable computer 1010. For example, the hand-held part contains just a browser or a different operating system from that of the wearable computer. The operating system can be switched over as a result of the coupling, automatically after the coupling or in response to an input, and/or it supplements or expands the active operating system on the hand-held part.

FIG. 121 shows a highly schematic block circuit diagram of the second variant (illustrated in FIG. 119) of a data processing system according to the invention. In principle, reference is made to the statements above relating to FIG. 119. However, in the illustration in FIG. 121 both the hand-held part 1080 and wearable computer 1010 each have a separate central processor unit (CPU) as well as memory (RAM/ROM) and system bus (EASI).

The labels given in FIG. 121 on the modules which are illustrated in schematic form provide information on the type and/or purpose.

FIG. 122 shows a view of a third variant of a data processing system according to the invention with a wearable expansion device 1010a and a hand-held part 1080, the hand-held part 1080 being also capable of being used alone. In contrast to the system illustrated in FIG. 120, unlike the wearable computer 1010 there, the wearable expansion device 1010a is not a standalone computer but rather contains only additional peripherals and/or power sources 2050. The peripherals provided in the wearable expansion device may include in particular:

a) disk drives/adapters 2060 for exchangeable media such as CD-ROMs, diskettes, card modules;

b) devices for wire-free data transmission, in particular GSM and/or Bluetooth subsystems.

The peripheral components which can be used in the wearable expansion device may each be permanently installed in it or else be capable of being attached to it in a modular fashion in the manner of a component as part of an upgrade or retrofit.

FIG. 123 shows a highly schematic block circuit diagram of the third variant illustrated in FIG. 122 of a data processing system according to the invention. In principle, reference is made to the statements above relating to FIGS. 119 and 121. In contrast, in the illustration in FIG. 123 only the hand-held part 1080, but not the wearable expansion device 1010a, has a separate central processor unit (CPU) as well as memory (RAM/ROM) and system bus (EASI).

The labels which are given in FIG. 123 on the modules which are illustrated in schematic form provide information on the type and/or purpose.

FIG. 124 shows a perspective view of a digital mobile device according to the invention with a display part and operating part and a separate attachment.

FIG. 125 shows a perspective view of the attachment from FIG. 124 with a carrying bag and belt loop for use as a “wearable” device.

FIG. 126 shows a perspective view of the attachment and of the operator control part and display part from FIG. 125.

FIG. 127 shows a digital mobile device in a different embodiment as a wearable computer 127010, which can in particular be used as a multimedia player including Digital Rights Management System (DRMS). The mobile device 127010 may have a PCMCIA slot 127020 which can be used in particular for holding a smart card, for example for distribution and payment systems. It is then also possible to equip the mobile device 127010 with a mobile phone functionality, for example WAP, SMS, GSM, GRPS, UMTS. In addition, it is advantageous to provide customary functions of a personal digital assistant (PDA) such as appointment planning, notes etc. These functions can, if appropriate, be used individually or in combination. Further functionalities are also possible.

The reference symbol refers to a display and operator control unit 127030. The display and operator control unit has a display 127040 which is used to display texts and graphics including videos of the applications running on the mobile device 127010. The connection between the mobile device 127010 and the display and operator control unit 127030 can also be made by means of a cable (not illustrated), but it is preferable to have a cableless data communications link, for example by means of radio waves using, for example, the Bluetooth standard or by means of infrared data transmission using, for example, the IrDA standard. The display and operator control unit 127030 can advantageously also be provided with an audio subsystem, for example an earpiece/microphone combination 127050. For purely hearing purposes, it is also possible to use, for example, a HiFi headset. In a different variant (not illustrated), the microphone can also be integrated into the display and operator control unit 127030.

The display and operator control unit 127030 is preferably dimensioned in such a way that it can be comfortably held in the hand. If the display and operator control unit 127030 is embodied with a touch screen, the user can easily carry out input operations with the thumb of the hand which is holding the unit. Alternatively, it is also possible to provide operator control with an input pen (not illustrated).

In one development, the microphone/earpiece set 127050 has a switching device 127060 with which, for example, music playback can be switched off and an incoming telephone call can be fed in. After the end of the telephone call, renewed activation can cause the music playback to be fed in again.

The display and operator control unit 127030 can be equipped with its own processor. For this reason, in this variant, the playback software (“Player”) can run directly on the display and operator control unit 127030. As a result, it is in particular possible for copyrighted data formats to be resolved only in the display and operator control unit 127030 and fed to the earpiece. The data stream between the mobile device 127010 and display and operator control unit 127030 can be encrypted, for example, by means of the SSL protocol. With such a configuration, the playback decoder (not illustrated) with the digital rights management system can be provided in the mobile device 127010 without a risk of unauthorized copying.

The mobile device 127010 can interact with other devices such as an e-book reader, PDA, web tablet, PC or beamer via an LAN data connection. The mobile device can interact with the Internet via a WAN connection, for example over an analogue telephone line, ISDN line or DSL.

FIG. 127B shows a side view of the mobile device 127010. For pleasant carrying comfort when the mobile device is attached to a trouser belt (not illustrated), the housing has an ergonomic shape which has a depression 127070 on the side facing the belt. For reasons of cumbersomeness, storage batteries (not illustrated) are preferably arranged in the lower region of the housing. An embodiment in which the housing can turn by means of a coupling part (not illustrated) somewhat in relation to the belt so that it can always be oriented in the direction of gravity is particularly advantageous.

In a further developed embodiment, customary peripherals, for example printers etc., can be connected to the mobile device 127010.

FIG. 128 shows the display and operator control unit 127040 from FIG. 127. In a particularly preferred further development, the display and operator control unit 127040 has on each of the upper and lower end sides 128010a, 128010b a plug-in and engagement device (not illustrated) by means of which a cover module 128020 can be pushed onto the display and operator control unit 127040, secured and, if appropriate, electrical contact can also be made with it. In one specific embodiment, the cover module 128020 is equipped with a telephone keypad, has a viewing window for the display of the display and operator control unit 127040 and can have an earpiece and microphone (not illustrated)—if the microphone is not contained in the display and operator control unit 127040. The cover module 128020 can be embodied with a wide range of, possibly fashionable, shapes and colours. The purpose is

a) that the user can make a telephone call in the same accustomed way as with a conventional mobile telephone, and

b) that a device which is originally configured as a playback device can subsequently easily be upgraded to form a mobile telephone.

The cover module 128020 can, depending on the left-handedness or right-handedness of the user, be plugged onto the display and operator control unit 127040 from above or below. The image on the display of the display and operator control unit 127040 is automatically appropriately oriented so that texts and images can always be read.

In a simplified embodiment, this feature can also be omitted. The position and number of the plug-in and engagement connections can vary according to the individual case.

The plug-in connection by means of the possibility of coupling with internal securing means in the same way as, for example, in vehicles (not illustrated) is particularly advantageous, the operator control and the sound input and output being carried out via the same interface as that of the cover module.

The advantage of the separate display and operator control unit 127040 is in particular the compact and very easily produced design. In mobile radio applications, the GSM or UMTS transmission antenna can be kept away from parts of the body such as the head which are considered to be particularly sensitive by attaching it to the mobile device 127010 which can, if appropriate, be positioned away from the body, for example on a table.

FIG. 129 shows the possibility of using the display and operator control unit 127040 from FIG. 127 for different devices and applications. The display and operator control unit 127040 can always be kept ready for use on the person or in the vicinity of the person and interact with numerous other electronic devices, for example house monitoring means, games consoles, television set, fixed line telephone, set top box, video recorder, multimedia player, mobile telephone or PDA, within the distance which can be spanned using Bluetooth, for example. Furthermore, FIG. 129 shows a fixed version 129010 of the streamer. The difference from the mobile device 127010 is that, for example, relatively large hard disk memory systems can readily be integrated. Furthermore, with the fixed version 129010 a fixed line connection possibility and a satellite communication connection possibility are provided, whereas with the mobile device preferably GSM, UMTS or a fixed line is used. In the fixed variant 129010, an external audio output is provided as it is advantageous to disconnect the image and sound from one another by means of a digital rights management system. A further advantage of the display and operator control unit 127040 is that it is possible both to perform operator control on different devices and to receive audio channels without having to pass via the external output of the fixed device to which loudspeaker systems are customarily connected (“remote control with headset”).

A wide variety of applications, for example house monitoring, games consoles, television set, fixed line telephone, set top box, video recorder, multimedia player, mobile telephone or PDA, can also run on the fixed station 129010.

The reference 129020 refers to the PCMCIA module which, in one embodiment, constitutes a digital rights management system (DRMS) with decoder function and can easily be connected and disconnected between the fixed station 129010 and the mobile device 127010. In particular the functionalities 129030 can be supported by the DRMS.

FIG. 130 shows a schematic perspective view of a detachable two-leaf mobile device according to the invention with a coupling mechanism in the hinge and a coupling lock which is to be inserted, using the example of a storage battery.

1. Universal digital mobile device for executing programs, comprising
a) a display device for displaying text data and/or image data, and
b) an input device with a pressure-sensitive or proximity-sensitive input area,
c) the pressure-sensitive or proximity-sensitive input area having one functional zone or a plurality of functional zones depending on the execution of at least one program.

2. Mobile device according to claim 1, characterized in that under the control of the program it is possible to set up at least one functional zone which has a keyboard functionality.

3. Mobile device according to claim 1, characterized in that under the control of the program it is possible to set up at least one functional zone which has a functionality of a touch-sensitive slide pad sliding surface with which information displayed on the display device can be actuated when an object held against the sliding surface slides.

4. Mobile device according to claim 1, characterized in that under the control of the program it is possible to set up at least one functional zone which has a functionality of a touch-sensitive pen pad sliding surface with which the sliding path of the pen is sensed when a pen which is pressed against the sliding surface is made to slide under the application of pressure, in order to detect written characters or written character-like symbols.

5. Mobile device according to one of claims 1 to 4, characterized in that the pressure-sensitive or proximity-sensitive input area is homogeneous in terms of the surface with respect to all the settable functionalities in relation to the non-overlapping distribution under the control of the program.

6. Mobile device according to one of claims 1 to 5, characterized in that the pressure-sensitive or proximity-sensitive input area and the display device are embodied jointly as a pressure-sensitive or proximity-sensitive screen.

7. Universal digital mobile device, comprising:
a) a housing part, and
b) an input device,
c) the input device having a board-like shape with a first interaction surface forming an upper side and with a second interaction surface forming a lower side,
d) the input device being arranged in the housing part in such a way that either the first interaction surface or the second interaction surface is accessible from the outside, the respective non-accessible interaction surface being protected in the interior of the housing part.

8. Mobile device according to claim 7, characterized in that at least one interaction surfaces is pressure-sensitive or proximity-sensitive.

9. Mobile device according to claim 7 or 8, characterized in that at least one of the interaction surfaces has a keyboard.

10. Mobile device according to one of claims 7 to 9, characterized in that the input device is movably secured in the housing part by means of a reversing mechanism.

11. Universal digital mobile device for executing programs, comprising
a) a housing part, and
b) a gravity sensor which is permanently connected to the housing part and generates a gravity directional signal which depends on the direction of gravity relative to the housing part,
c) the execution of the program depending on the gravity directional signal.

12. Mobile device according to claim 11, characterized by a display device for displaying text data and/or image data.

13. Mobile device according to claim 12, characterized in that the displaying of the text data and image data by the display device depends on the gravity directional signal.

14. Mobile device according to claim 13, characterized in that the orientation of the displaying of the text data and image data by the display device depends on the gravity directional signal.

15. Mobile device according to claim 14, characterized in that the displaying of the text data and image data is upright with respect to the direction of the force of gravity.

16. Mobile device according to claim 11 or 12, characterized by an input device with an input area.

17. Mobile device according to claim 16, characterized in that the arrangement of input functionalities on the input area of the input device depends on the gravity directional signal.

18. Mobile device according to one of claims 11 to 17, characterized
a) in that the housing part has:
aa) a first leaf part and
bb) a second leaf part,
cc) which can be folded open and closed in the manner of a book by means of a hinge part.

19. Mobile device according to claim 18, characterized in that the first leaf part shows the display device and the second leaf part has the input device.

20. Mobile device according to claim 19, characterized in that a first mobile device operating mode is assumed if the gravity directional signal indicates that the first leaf part is in the upright position, the side of the first leaf part which faces the hinge part pointing downward in the direction of the force of gravity.

21. Mobile device according to claim 20, characterized in that a text processing application can be operated in the first mobile device operating mode, the display device and the input device being used in the transverse format, and the input device constituting a keyboard.

22. Mobile device according to claim 19, characterized in that a second mobile device operating mode is assumed if the gravity directional signal indicates that the first leaf part and/or the second leaf part is/are located in the upright position, a side of the first leaf part which is oriented perpendicularly with respect to the hinge part and/or of the leaf part pointing downward in the direction of the force of gravity.

23. Mobile device according to one of claims 11 to 22, characterized by a configurations device for presetting the left-handedness or right-handedness of a user, the execution of the program depending on the left-handedness or right-handedness which is set.

24. Universal digital mobile device having
a) a first leaf part and
b) a second leaf part,
c) which can be folded open and closed in the manner of a book by means of a hinge part,
d) at least one of the two leaf parts having a leaf base part and a removable leaf back part.

25. Universal digital mobile device according to claim 24, characterized in that the removable leaf back part has a removable hand-grip part.

26. Universal digital mobile device, having
a) a first leaf part, and
b) a second leaf part,
c) which can be folded open and closed by means of a hinge part,
d) at least one of the two leaf parts having a leaf base part and a removable hand-grip part.

27. Mobile device according to claim 25 or 26, characterized in that the hand-grip part contains at least one operator control.

28. Mobile device according to claim 27, characterized in that the hand-grip part has three operator control keys which are oriented toward the back.

29. Universal digital mobile device, having
a) a housing part, and
b) a hand-grip part which is arranged in the region within reach of the operator's holding hand on the housing part,
c) the hand-grip part serving as an attachment means for at least one back part.

30. Universal digital mobile device, having
a) a housing part, and
b) a hand-grip part which is arranged in the region within reach of the operator's holding hand on the housing part,
c) the hand-grip part serving as grip protection and for stabilizing at least one back part.

31. Mobile device according to one of claims 29 and 30, characterized in that the hand-grip part has at least one operator control.

32. Mobile device according to claim 31, characterized in that the at least one operator control is selected from a group comprising momentary-contact switch, slide pad, multiple rockers and tracker ball.

33. Mobile device according to one of claims 29 to 32, characterized in that the hand-grip part can be removed from the housing part.

34. Universal digital mobile device, comprising
a) a hand-held part
aa) having at least one display device,
ab) having operating means for inputting information and manipulating displayed information, and
ac) having at least a first interface for exchanging data, and
b) an accessory part
ba) having a control unit,
bb) having a memory,
bc) having a power supply unit, and
bd) having at least one second interface for exchanging data,
c) the first interface and the second interface being capable of being coupled, and
d) the accessory part being able to receive data from the operating means and output data via the display device.
